(19) United States
(12) Patent Application Publication
(10) Pub. No.: US 2024/0124349 A1
(43) Pub. Date: Apr. 18, 2024

(54) 3D FORMING OF LITHIUM SILICATE GLASS CERAMICS WITH ALKALI-EARTH METAL CONTAINING RESIDUAL GLASS PHASE

(71) Applicant: CORNING INCORPORATED, CORNING, NY (US)

(72) Inventors: Qiang Fu, Painted Post, NY (US); Mathieu Gerard Jacques Hubert, Corning, NY (US); Michael Morgan Oliver, Hammondsport, NY (US); Pascale Oram, Painted Post, NY (US); John Robert Saltzer, JR., Beaver Dams, NY (US)

(21) Appl. No.: 18/376,470

(22) Filed: Oct. 4, 2023

Related U.S. Application Data
(60) Provisional application No. 63/416,229, filed on Oct. 14, 2022.

(51) Int. Cl. C03C 10/00; C03B 11/12; C03B 32/02; C03C 21/00

(52) U.S. Cl. CPC C03C 10/0027; C03B 11/125; C03B 32/02; C03C 10/0054; C03C 21/002; C03C 2204/00

(57) ABSTRACT

Glass and glass ceramic compositions having at least a lithium disilicate crystalline phase, a petalite crystalline phase, and a residual glass phase along with methods of making the glass and glass ceramic compositions are described. The compositions are compatible with conventional rolling and float processes, are transparent or translucent, and have high mechanical strength and fracture resistance. Additionally, processes of 3D forming glass ceramic preforms having the glass ceramic composition discussed to produce glass ceramic articles are described. Further, the compositions are able to be chemically tempered to even higher strength glass ceramics that are useful as large substrates in multiple applications.

This application claims the benefit of priority under 35 U.S.C. § 119 of U.S. Provisional Application Ser. No. 63/416,229 filed on Oct. 14, 2022, the content of which is relied upon and incorporated herein by reference in its entirety.

### BACKGROUND

### Field

The present specification generally relates to glass ceramic articles, and particularly to methods of 3D forming glass ceramics to produce the glass ceramic articles.

### Technical Background

There is a demand for high strength glass for portable electronic devices. Several materials are currently being utilized on the market such as glass, zirconia, plastic, metal, and glass ceramics.

Glass ceramics have certain advantages over other materials, but it can be difficult to form a glass ceramic into various shapes having the properties required for a high strength portable device. Accordingly, a need exists for glass ceramic articles have improved properties and methods for making the glass ceramic articles.

### SUMMARY

A first aspect of the present disclosure may be directed to a method of forming a glass ceramic article, the method comprising three dimensional (3D) forming a glass ceramic pre-form to produce the glass ceramic article having a lithium disilicate crystalline phase, a petalite crystalline phase, and a residual glass phase. Prior to 3D forming, the glass ceramic pre-form comprises the lithium disilicate crystalline phase, the petalite crystalline phase, and the residual glass phase. After 3D forming, the glass ceramic article comprises a concentration of the residual glass phase greater than a concentration of the residual glass phase in the glass ceramic pre-form.

A second aspect of the present disclosure may include the first aspect, wherein, prior to 3D forming, a concentration of the residual glass phase in the glass ceramic pre-form is from 10 wt. % to 50 wt. %.

A third aspect of the present disclosure may include either one of the first or second aspects, wherein the glass ceramic article has a residual glass phase of from 15 wt. % to 50 wt. % after 3D forming.

A fourth aspect of the present disclosure may include any one of the first through third aspects, wherein the glass ceramic article has a residual glass phase of from 20 wt. % to 50 wt. % after 3D forming.

A fifth aspect of the present disclosure may include any one of the first through fourth aspects, wherein the concentration of the residual glass phase in the glass ceramic article is at least 5% greater than the concentration of the residual glass phase in the glass ceramic pre-form.

A sixth aspect of the present disclosure may include any one of the first through fifth aspects, wherein, prior to 3D forming, the glass ceramic pre-form comprises a combined concentration of lithium disilicate crystalline phase and petalite crystalline phase of from 50 wt. % to 90 wt. %.

A seventh aspect of the present disclosure may include any one of the first through sixth aspects, wherein the glass ceramic article is clear and transparent.

An eighth aspect of the present disclosure may include any one of the first through seventh aspects, wherein the glass ceramic article comprises Na₂O, K₂O, or both.

A ninth aspect of the present disclosure may include the eighth aspect, wherein a molar concentration of Na₂O and K₂O in the glass ceramic article is greater than or equal to 0.5 mol % to 9 mol %.

A tenth aspect of the present disclosure may include either one of the eighth or ninth aspects, wherein the glass ceramic article has a molar ratio [Na₂O+K₂O]/[Al₂O₃] of from 0.1 to 5.

An eleventh aspect of the present disclosure may include any one of the eighth through tenth aspects, wherein the glass ceramic article has a molar ratio [Na₂O+K₂O]/[ZrO₂] of from 0.3 to 5.

A twelfth aspect of the present disclosure may include any one of the first through eleventh aspects, wherein the glass ceramic article comprises one or more metal oxides selected from the group consisting of ZnO, MgO, CaO, BaO, SrO, and combinations of these.

A thirteenth aspect of the present disclosure may include the twelfth aspect, wherein the glass ceramic article has a molar ratio [MgO+CaO+BaO+SrO+ZnO]/[Al₂O₃] of from 0.05 to 5.

A fourteenth aspect of the present disclosure may include either one of the twelfth or thirteenth aspects, wherein the glass ceramic article has a molar ratio [MgO+CaO+BaO+SrO+ZnO]/[ZrO₂] of from 0.1 to 5.

A fifteenth aspect of the present disclosure may include any one of the first through fourteenth aspects, wherein the glass ceramic article comprises B₂O₃.

A sixteenth aspect of the present disclosure may include the fifteenth aspect, wherein the glass ceramic article comprises from 0 mol % to 10 mol % B₂O₃.

A seventeenth aspect of the present disclosure may include any one of the first through sixteenth aspects, wherein a composition of the glass ceramic article comprises SiO₂, Al₂O₃, Li₂O, P₂O₅, and ZrO₂.

An eighteenth aspect of the present disclosure may include the seventeenth aspect, wherein the composition of the glass ceramic article comprises from 55 mol % to 80 mol % SiO₂; from 1 mol % to 15 mol % Al₂O₃; from 10 mol % to 40 mol % Li₂O; from 0.2 mol % to 4 mol % P₂O₅; and from 0.1 mol % to 10 mol % ZrO₂.

A nineteenth aspect of the present disclosure may include either one of the seventeenth or eighteenth aspects, wherein the composition of the glass ceramic article comprises from 68 mol % to 71 mol % SiO₂, from 3 mol % to 5 mol % Al₂O₃, from 18 mol % to 25 mol % Li₂O, from 0.6 mol % to 1 mol % P₂O₅, and from 1.5 mol % to 3 mol % ZrO₂.

A twentieth aspect of the present disclosure may include any one of the seventeenth through nineteenth aspects, wherein the composition of the glass ceramic article comprises from 68.2 mol % to 70.4 mol % SiO₂, from 3.5 mol % to 4.5 mol % Al₂O₃, from 20 mol % to 23 mol % Li₂O, from 0.8 mol % to 1 mol % P₂O₅, and from 1.6 mol % to 3 mol % ZrO₂.

A twenty-first aspect of the present disclosure may include any one of the seventeenth through twentieth aspects, wherein the composition of the glass ceramic article further comprises from 0 mol % to 5 mol % Na₂O, from 0 mol % to 4 mol % K₂O, or both.

A twenty-second aspect of the present disclosure may include the twenty-first aspect, wherein the composition of the glass ceramic article comprises from 0.5 mol % to 2 mol % Na₂O, from 0.5 mol % to 1.2 mol % K₂O, or combinations of these.

A twenty-third aspect of the present disclosure may include any one of the seventeenth through twenty-second aspects, wherein the composition of the glass ceramic article comprises less than 0.5 mol % of Na₂O and K₂O, and further comprises: one or more of the following: from 0 mol % to 8 mol % ZnO; from 0 mol % to 8 mol % MgO; from 0 mol % to 8 mol % CaO; from 0 mol % to 8 mol % SrO; or from 0 mol % to 8 mol % BaO, wherein the total concentration of ZnO, MgO, CaO, SrO, and BaO is greater than or equal to 0.5 mol %.

A twenty-fourth aspect of the present disclosure may include any one of the seventeenth through twenty-third aspects, wherein the composition of the glass ceramic article further comprises one or more of Fe₂O₃, SnO₂, HfO₂, TiO₂, or combinations of these.

A twenty-fifth aspect of the present disclosure may include any one of the first through twenty-fourth aspects, wherein the glass ceramic preform is ceramed prior to 3D forming the glass ceramic preform to produce the glass ceramic article.

A twenty-sixth aspect of the present disclosure may include any one of the first through twenty-fifth aspects, wherein a total concentration of crystalline phases in the glass ceramic preform prior to 3D forming is a maximum total concentration of crystalline phases of a composition of the glass ceramic preform.

A twenty-seventh aspect of the present disclosure may include any one of the first through twenty-sixth aspects, further comprising preparing the glass ceramic preform prior to 3D forming the glass ceramic preform to produce the glass ceramic article.

A twenty-eighth aspect of the present disclosure may include the twenty-seventh aspect, wherein preparing the glass ceramic preform comprises ceraming a precursor glass to produce the glass ceramic preform comprising the lithium disilicate crystalline phase, the petalite crystalline phase, and the residual glass phase, wherein a concentration of the residual glass phase in the glass ceramic preform is from 10 wt. % to 50 wt. %.

A twenty-ninth aspect of the present disclosure may include the twenty-eighth aspect, wherein the ceraming the precursor glass to produce the glass ceramic preform comprises: heating the precursor glass to a nucleation temperature of from 500° C. to 650° C.; maintaining the precursor glass at the nucleation temperature for a first time period of from 1 min to 600 min; increasing the temperature of the precursor glass to a crystallization temperature of from 680° C. to 800° C.; and maintaining the precursor glass at the crystallization temperature for a second time of from 1 sec to 600 min to produce the glass ceramic preform.

A thirtieth aspect of the present disclosure may include the twenty-ninth aspect, further comprising cooling the glass ceramic preform from the first temperature to room temperature.

A thirty-first aspect of the present disclosure may include any one of the twenty-seventh through thirtieth aspects, wherein, after the ceramming the precursor glass to produce the glass ceramic preform, the glass ceramic preform has a total concentration of crystal phases that is within 50% of a total concentration of crystal phases in the glass ceramic article after 3D forming.

A thirty-second aspect of the present disclosure may include any one of the first through thirty-first aspects, wherein a three-dimensional shape of the glass ceramic article is different from a shape of the glass ceramic preform.

A thirty-third aspect of the present disclosure may include any one of the first through thirty-second aspects, wherein the 3D forming the glass ceramic preform comprises thermo-mechanical shaping.

A thirty-fourth aspect of the present disclosure may include any one of the first through thirty-third aspects, wherein 3D forming the glass ceramic preform comprises: heating the glass ceramic preform to a forming temperature; after heating, pressing the glass ceramic preform into a mold for a time period to produce the glass ceramic article; and cooling the glass ceramic article.

A thirty-fifth aspect of the present disclosure may include they thirty-fourth aspect, wherein the forming temperature is from 650° C. to 850° C.

A thirty-sixth aspect of the present disclosure may include either one of the thirty-fourth or thirty-fifth aspects, comprising pressing the glass ceramic pre-form into the mold at a pressing pressure of from 0.001 MPa to 0.9 MPa.

A thirty-seventh aspect of the present disclosure may include any one of the thirty-fourth through thirty-sixth aspects, wherein the mold is a graphite mold.

A thirty-eighth aspect of the present disclosure may include any one of the thirty-fourth through thirty-seventh aspects, wherein heating and pressing the glass ceramic preform increases a concentration of the residual glass phase in the glass ceramic article compared to the glass ceramic preform.

A thirty-ninth aspect of the present disclosure may include any one of the first through thirty-eighth aspects, wherein the glass ceramic article wherein the glass ceramic article comprises a haze measured at 0.8 mm thickness of less than 0.20.

A fortieth aspect of the present disclosure may include any one of the first through thirty-ninth aspects, wherein a total volume change of the glass ceramic article during forming is less than 1% of the glass ceramic preform before the 3D forming.

A forty-first aspect of the present disclosure may include any one of the first through fortieth aspects, wherein the method does not include any active method steps, after the 3D forming, that are intended to further increase the crystallinity of the glass ceramic article.

A forty-second aspect of the present disclosure may include any one of the first through forty-first aspects, further comprising strengthening the glass ceramic article after the 3D forming to produce a strengthened glass ceramic article having a compressive stress layer extending from a first surface of the glass ceramic article to a depth of compression.

A forty-third aspect of the present disclosure may include the forty-second aspect, wherein the strengthened glass ceramic article has a compressive stress of the compressive stress layer of greater than or equal to 200 MPa.

A forty-fourth aspect of the present disclosure may include either one of the forty-second or forty-third aspects, wherein the depth of compression of the strengthened glass article is from 0*t to 0.3*t, where t is thickness of the strengthened glass ceramic article.

A forty-fifth aspect of the present disclosure may include any one of the forty-second through forty-fourth aspects, wherein the strengthened glass ceramic article has a depth of compression of greater than or equal to 10% of a thickness of the strengthened glass ceramic article, a central tension of greater than or equal to 40 MPa, or both.

A forty-sixth aspect of the present disclosure may include any one of the forty-second through forty-fifth aspects, wherein strengthening the glass ceramic article comprises ion-exchanging the glass ceramic article to produce the strengthened glass ceramic article.

A forty-seventh aspect of the present disclosure may include the forty-sixth aspect, wherein ion-exchanging the glass ceramic article increases a weight per unit volume of the glass ceramic article by greater than or equal to 0.05%.

A forty-eighth aspect of the present disclosure may be directed to a glass ceramic article comprising a lithium disilicate crystalline phase, a petalite crystalline phase, and a residual glass phase, the glass ceramic article prepared by a process comprising 3D forming a glass ceramic preform to produce the glass ceramic article, wherein prior to the 3D forming, the glass ceramic preform comprises the lithium disilicate crystalline phase, the petalite crystalline phase, and the residual glass phase and, after the 3D forming, the glass ceramic article comprises a concentration of the residual glass phase greater than a concentration of the residual glass phase in the glass ceramic preform.

A forty-ninth aspect of the present disclosure may include the forty-eighth aspect, wherein the 3D forming the glass ceramic preform to produce the glass ceramic article comprises thermo-mechanical shaping.

A fiftieth aspect of the present disclosure may include the forty-ninth aspect, wherein the 3D forming of the glass ceramic preform produces the glass ceramic article, wherein the concentration of the residual glass phase in the glass ceramic article is at least 5% greater than the concentration of the residual glass phase in the glass ceramic preform.

A fifty-first aspect of the present disclosure may include any one of the forty-eighth through fiftieth aspects, wherein the 3D forming the glass ceramic preform comprises: heating the glass ceramic preform to a forming temperature; after heating, pressing the glass ceramic preform into a mold for a time period to produce the glass ceramic article; and cooling the glass ceramic article.

A fifty-second aspect of the present disclosure may include the fifty-first aspect, wherein the forming temperature is from 650° C. to 850° C. and a pressing pressure during pressing is from 0.001 MPa to 0.9 MPa.

A fifty-third aspect of the present disclosure may include any one of the forty-eighth through fifty-second aspects, wherein the glass ceramic article exhibits shrinkage less than 1% of the total volume of the glass ceramic preform during the 3D forming.

A fifty-fourth aspect of the present disclosure may include any one of the forty-eighth through fifty-third aspects, further comprising strengthening the glass ceramic article after the 3D forming to produce a strengthened glass ceramic article having a compressive stress layer extending from a first surface of the glass ceramic article to a depth of compression.

A fifty-fifth aspect of the present disclosure may include the fifty-fourth aspect, wherein the strengthened glass ceramic article has a compressive stress of the compressive stress layer of greater than or equal to 200 MPa.

A fifty-sixth aspect of the present disclosure may include either one of the fifty-fourth or fifty-fifth aspects, wherein the depth of compression of the strengthened glass ceramic article is from 0*t to 0.3*t, where t is thickness of the strengthened glass ceramic article.

A fifty-seventh aspect of the present disclosure may include any one of the fifty-fourth through fifty-sixth aspects, wherein the strengthened glass ceramic article has a depth of compression of greater than or equal to 10% of a thickness of the strengthened glass ceramic article, a central tension of greater than or equal to 40 MPa, or both.

A fifty-eighth aspect of the present disclosure may include any one of the fifty-fourth through fifty-seventh aspects, wherein strengthening the glass ceramic article comprises ion-exchanging the glass ceramic article to produce the strengthened glass ceramic article.

A fifty-ninth aspect of the present disclosure may include the fifty-eighth aspect, wherein ion-exchanging the glass ceramic article increases a weight per unit volume of the glass ceramic article by greater than or equal to 0.05%.

A sixtieth aspect of the present disclosure may include any one of the forty-eighth through fifty-ninth aspects, wherein the glass ceramic article has an index of refraction of from 1.5 to 1.6 for light having wavelength of 589.3 nm.

A sixty-first aspect of the present disclosure may include any one of the forty-eighth through sixtieth aspects, wherein the glass ceramic article comprises a haze measured at 0.8 mm thickness of less than 0.20.

A sixty-second aspect of the present disclosure may include any one of the forty-eighth through sixty-first aspects, wherein the glass ceramic article comprises an optical transmission of electromagnetic radiation wavelengths from 450 nm to 800 nm measured at 0.8 mm thickness of greater than 85%.

A sixty-third aspect of the present disclosure may include any one of the forty-eight through sixty-second aspects, comprising an electronic device comprising a transparent surface, the transparent surface comprising the glass ceramic article of any one of the forty-eighth through sixty-second aspects.

A sixty-fourth aspect of the present disclosure may include the sixty-third aspect, wherein the glass ceramic article has a thickness of from 0.3 mm to 1 mm.

A sixty-fifth aspect of the present disclosure may include either one of the sixty-third or sixty-fourth aspects, wherein the electronic device is a consumer electronic device.

A sixty-sixth aspect of the present disclosure may include a glass ceramic article comprising a lithium disilicate crystalline phase, a petalite crystalline phase, and a residual glass phase, wherein a concentration of the residual glass phase is from 15 wt. % to 50 wt. % and the glass ceramic article has one or more of the following: a molar ratio [Na₂O+K₂O]/[Al₂O₃] of from 0.1 to 5; a molar ratio [Na₂O+K₂O]/[ZrO₂] of from 0.3 to 5; a molar ratio [MGO+CaO+BaO+SrO+ZnO]/[Al₂O₃] of from 0.05 to 5; a molar ratio [MgO+CaO+BaO+SrO+ZnO]/[ZrO₂] of from 0.1 to 5; or combinations thereof.

A sixty-seventh aspect of the present disclosure may include the sixty-sixth aspect, wherein concentrations of the lithium disilicate crystalline phase and the petalite crystalline phase are greater than any other crystalline phase in the glass ceramic article.

A sixty-eighth aspect of the present disclosure may include either one of the sixty-sixth or sixty-seventh aspects, wherein the glass ceramic article has a concentration of the residual glass phase of from 20 wt. % to 50 wt. %.

A sixty-ninth aspect of the present disclosure may include any one of the sixty-sixth through sixty-eighth aspects, wherein, prior to 3D forming, a glass ceramic preform comprises a combined concentration of lithium disilicate crystalline phase and petalite crystalline phase of from 50 wt. % to 90 wt. %.

A seventieth aspect of the present disclosure may include any one of the sixty-sixth through sixty-ninth aspects, wherein the glass ceramic article is clear and transparent.

A seventy-first aspect of the present disclosure may include any one of the sixty-sixth through seventieth aspects, wherein the glass ceramic article comprises Na₂O, K₂O, or both.

A seventy-second aspect of the present disclosure may include the seventy-first aspect, wherein a molar concentration of Na₂O and K₂O in the glass ceramic article is greater than or equal to 0.5 mol % to 9 mol %.

A seventy-third aspect of the present disclosure may include either one of the seventy-first or seventy-second aspects, wherein the glass ceramic article has a molar ratio [Na₂O+K₂O]/[Al₂O₃] of from 0.1 to 5.

A seventy-fourth aspect of the present disclosure may include any one of the seventy-first through seventy-third aspects, wherein the glass ceramic article has a molar ratio [Na₂O+K₂O]/[ZrO₂] of from 0.3 to 5.

A seventy-fifth aspect of the present disclosure may include any one of the sixty-sixth through seventy-fourth aspects, wherein the glass ceramic article comprises one or more metal oxides selected from the group consisting of ZnO, MgO, CaO, BaO, SrO, and combinations of these.

A seventy-sixth aspect of the present disclosure may include the seventy-fifth aspect, wherein the glass ceramic article has a molar ratio [MgO+CaO+BaO+SrO+ZnO]/[Al₂O₃] of from 0.05 to 5.

A seventy-seventh aspect of the present disclosure may include either one of the seventy-fifth or seventy-sixth aspects, wherein the glass ceramic article has a molar ratio [Mg+CaO+BaO+SrO+ZnO]/[ZrO₂] of from 0.1 to 5.

A seventy-eighth aspect of the present disclosure may include any one of the sixty-sixth through seventy-seventh aspects, wherein the glass ceramic article comprises B₂O₃.

A seventy-ninth aspect of the present disclosure may include the seventy-eighth aspect, wherein the glass ceramic article comprises from greater than 0 mol % to 10 mol % B₂O₃.

An eightieth aspect of the present disclosure may include any one of the sixty-sixth through seventy-ninth aspects, wherein a composition of the glass ceramic article comprises SiO₂, Al₂O₃, Li₂O, P₂O₅, and ZrO₂.

An eighty-first aspect of the present disclosure may include the eightieth aspect, wherein the composition of the glass ceramic article comprises from 55 mol % to 80 mol % SiO₂; from 1 mol % to 15 mol % Al₂O₃; from 10 mol % to 40 mol % Li₂O; from 0.2 mol % to 4 mol % P₂O₅; and from 0.1 mol % to 10 mol % ZrO₂.

An eighty-second aspect of the present disclosure may include either one of the eightieth or eighty-first aspects, wherein the composition of the glass ceramic article comprises from 68 mol % to 71 mol % SiO₂, from 3 mol % to 5 mol % Al₂O₃, from 18 mol % to 25 mol % Li₂O, from 0.6 mol % to 1 mol % P₂O₅, and from 1.5 mol % to 3 mol % ZrO₂.

An eighty-third aspect of the present disclosure may include any one of the eightieth through eighty-second aspects, wherein the composition of the glass ceramic article comprises from 68.2 mol % to 70.4 mol % SiO₂, from 3.5 mol % to 4.5 mol % Al₂O₃, from 20 mol % to 23 mol % Li₂O, from 0.8 mol % to 1 mol % P₂O₅, and from 1.6 mol % to 3 mol % ZrO₂.

An eighty-fourth aspect of the present disclosure may include any one of the eightieth through eighty-third aspects, wherein the composition of the glass ceramic article further comprises from 0 mol % to 5 mol % Na₂O, from 0 mol % to 4 mol % K₂O, or both.

An eighty-fifth aspect of the present disclosure may include the eighty-fourth aspect, wherein the composition of the glass ceramic article comprises from 0.5 mol % to 2 mol % Na₂O, from 0.5 mol % to 1.2 mol % K₂O, or combinations of these.

An eighty-sixth aspect of the present disclosure may include either one of the eighty-fourth or eighty-fifth aspects, wherein the composition of the glass ceramic article comprises less than 0.5 mol % of Na₂O and K₂O, and further comprises one or more of the following: from 0 mol % to 8 mol % ZnO; from 0 mol % to 8 mol % MgO; from 0 mol % to 8 mol % CaO; from 0 mol % to 8 mol % SrO; or from 0 mol % to 8 mol % BaO, wherein the total concentration of ZnO, MgO, CaO, SrO, and BaO is greater than or equal to 0.5 mol %.

An eighty-seventh aspect of the present disclosure may include any one of the eightieth through eighty-sixth aspects, wherein the composition of the glass ceramic article further comprises one or more of Fe₂O₃, SnO₂, HfO₂, TiO₂, or combinations of these.

An eighty-eighth aspect of the present disclosure may include any one of the sixty-sixth through eighty-seventh aspects, wherein a composition of the glass ceramic article comprises, consists of, or consists essentially of: from 55 mol % to 80 mol % SiO₂; from 1 mol % to 15 mol % Al₂O₃; from 10 mol % to 40 mol % Li₂O; from 0.2 mol % to 4 mol % P₂O₅; from 0 mol % to 10 mol % B₂O₃; from 0.1 mol % to 10 mol % ZrO₂; from 0 mol % to 5 mol % Na₂O; from 0 mol % to 4 mol % K₂O; from 0 mol % to 8 mol % MgO; from 0 mol % to 8 mol % CaO; from 0 mol % to 8 mol % SrO; from 0 mol % to 8 mol % BaO; from 0 mol % to 8 mol % ZnO; from 0 mol % to 0.5 mol % Fe₂O₃; from 0 mol % to 0.5 mol % HfO₂; from 0 mol % to 0.5 mol % SnO₂; and from 0 mol % to 2 mol % TiO₂.

An eighty-ninth aspect of the present disclosure may include the eighty-eighth aspect, wherein a composition of the glass ceramic article comprises from 68 mol % to 71 mol % SiO₂; from 3 mol % to 5 mol % Al₂O₃; from 18 mol % to 25 mol % Li₂O; from 0.6 mol % to 1 mol % P₂O₅; from 1.5 mol % to 3 mol % ZrO₂; from 0.5 mol % to 2 mol % Na₂O; from 0.5 mol % to 2 mol % K₂O; from 0 mol % to 0.1 mol % CaO; from 0 mol % to 0.1 mol % Fe₂O₃; from 0 mol % to 0.1 mol % HfO₂; from 0 mol % to 0.0.5 mol % SnO₂; and from 0 mol % to 2 mol % TiO₂.

A ninetieth aspect of the present disclosure may include any one of the sixty-sixth through eighty-ninth aspects, wherein the glass ceramic article is a component of an electronic device.

A ninety-first aspect of the present disclosure may include the ninetieth aspect, wherein the glass ceramic article is a transparent cover plate for an electronic device.

A ninety-second aspect of the present disclosure may include any one of the sixty-sixth through ninety-first aspects, wherein the glass ceramic article has a Young's modulus of from 90 GPa to 110 GPa.

A ninety-third aspect of the present disclosure may include any one of the sixty-sixth through ninety-second aspects, wherein the glass ceramic article has a shear modulus of from 35 GPa to 50 GPa.

A ninety-fourth aspect of the present disclosure may include any one of the sixty-sixth through ninety-third aspects, wherein the glass ceramic article has a Poisson's ratio of from 0.19 to 0.24.

A ninety-fifth aspect of the present disclosure may include any one of the sixty-sixth through ninety-fourth aspects, wherein the glass ceramic article has a fracture toughness of from 1.0 MPa/m^{0.5} to 2.0 MPa/m^{0.5}.

A ninety-sixth aspect of the present disclosure may include any one of the sixty-sixth through ninety-fifth aspects, wherein the glass ceramic article has a stress optical coefficient (SOC) of from 2.60 nm/mm/MPa to 2.75 nm/mm/MPa.

A ninety-seventh aspect of the present disclosure may include any one of the sixty-sixth through ninety-sixth aspects, wherein the glass ceramic article has an index of refraction of from 1.5 to 1.6 for light having wavelength of 589.3 nm.

A ninety-eighth aspect of the present disclosure may include any one of the sixty-sixth through ninety-seventh aspects, wherein the glass ceramic article is strengthened and has a compressive stress of greater than or equal to 200 MPa.

A ninety-ninth aspect of the present disclosure may include any one of the sixty-sixth through ninety-eighth aspects, wherein the glass ceramic article is strengthened and has a central tension of greater than or equal to 30 MPa over a thickness range of from 0.5 mm to 0.6 mm.

A one hundredth aspect of the present disclosure may include any one of the sixty-sixth through ninety-ninth aspects, wherein the glass ceramic article is strengthened and has a depth of compression of greater than or equal to 10% of the thickness of the glass ceramic article or greater than or equal to 80 microns.

A one hundred first aspect of the present disclosure may include any one of the sixty-sixth through one hundredth aspects, wherein the glass ceramic article is strengthened and has a depth of compression of from 0*t to 0.3*t, where t is thickness of the glass ceramic article.

A one hundred second aspect of the present disclosure may include any one of the sixty-sixth through one hundred first aspects, wherein the glass ceramic article has a stress of less than 30 nm of retardation per mm of glass ceramic article thickness.

A one hundred third aspect of the present disclosure may include any one of the sixty-sixth through one hundred second aspects, wherein the glass ceramic article comprises a stress of less than 25 nm of retardation per mm of glass ceramic article thickness.

A one hundred fourth aspect of the present disclosure may include any one of the sixty-sixth through one hundred third aspects, wherein the glass ceramic article a haze in units of percent (%) of less than 0.0994t+0.12, where t is the thickness of the glass ceramic article in mm;

A one hundred fifth aspect of the present disclosure may include any one of the sixty-sixth through one hundred fourth aspects, wherein the glass ceramic article has an optical transmission in units of percent (%) of greater than 0.91×10(2−0.03t) of electromagnetic radiation having wavelengths from 450 nm to 800 nm, where t is the thickness of the glass ceramic article in mm.

A one hundred sixth aspect of the present disclosure may include any one of the sixty-sixth through one hundred fifth aspects, wherein the glass ceramic article comprises a haze measured at 0.8 mm thickness of less than 0.20.

A one hundred seventh aspect of the present disclosure may include any one of the sixty-sixth through one hundred sixth aspects, wherein the glass ceramic article comprises an optical transmission of electromagnetic radiation wavelengths from 450 nm to 800 nm measured at 0.8 mm thickness of greater than 85%.

A one hundred eighth aspect of the present disclosure may include any one of the sixty-sixth through one hundred seventh aspects, wherein the glass ceramic article has a thickness from 0.3 mm and 1 mm.

A one hundred ninth aspect of the present disclosure may include any one of the sixty-sixth through one hundred eighth aspects, wherein the glass ceramic article is a components of an electronic device.

A one hundred tenth aspect of the present disclosure may include the one hundred ninth aspect, wherein the glass ceramic article is a clear and transparent cover plate for an electronic device.

A one hundred eleventh aspect of the present disclosure may include any one of the sixty-sixth through one hundred tenth aspects, comprising an electronic device comprising a transparent surface, the transparent surface comprising the glass ceramic article of any one of the sixty-sixth through one hundred tenth aspects.

A one hundred twelfth aspect of the present disclosure may include the one hundred eleventh aspect, wherein the glass ceramic article has a thickness of from 0.3 mm to 1 mm.

A one hundred thirteenth aspect of the present disclosure may include either one of the one hundred eleventh or one hundred twelfth aspects, wherein the electronic device is a consumer electronic device.

A one hundred fourteenth aspect of the present disclosure may include a glass ceramic article comprising a lithium disilicate crystalline phase, a petalite crystalline phase, and a residual glass phase, wherein a concentration of the residual glass phase is from 15 wt. % to 50 wt. %. The glass ceramic article has a Young's modulus of from 90 GPa to 110 GPa, a shear modulus of from 35 GPa to 50 GPa, and a fracture toughness of from 1.0 MPa/m^{0.5} to 2.0 MPa/m^{0.5}.

A one hundred fifteenth aspect of the present disclosure may include the one hundred fourteenth aspect, wherein the glass ceramic article has a Poisson's ratio of from 0.19 to 0.24.

A one hundred sixteenth aspect of the present disclosure may include either one of the one hundred fourteenth or one hundred fifteenth aspects, wherein the glass ceramic article has a stress optical coefficient (SOC) of from 2.60 nm/mm/MPa to 2.75 nm/mm/MPa.

A one hundred seventeenth aspect of the present disclosure may include any one of the one hundred fourteenth through one hundred sixteenth aspects, wherein the glass ceramic article has an index of refraction of from 1.5 to 1.6 for light having wavelength of 589.3 nm.

A one hundred eighteenth aspect of the present disclosure may include any one of the one hundred fourteenth through one hundred seventeenth aspects, wherein the glass ceramic article is strengthened and has a compressive stress of greater than or equal to 200 MPa.

A one hundred nineteenth aspect of the present disclosure may include any one of the one hundred fourteenth through one hundred eighteenth aspects, wherein the glass ceramic article is strengthened and has a central tension of greater than or equal to 30 MPa over a thickness range of from 0.5 mm to 0.6 mm.

A one hundred twentieth aspect of the present disclosure may include any one of the one hundred fourteenth through one hundred nineteenth aspects, wherein the glass ceramic article is strengthened and has a depth of compression of greater than or equal to 10% of the thickness of the glass ceramic article or greater than or equal to 80 microns.

A one hundred twenty-first aspect of the present disclosure may include any one of the one hundred fourteenth aspects, wherein the glass ceramic article has a molar ratio [Na₂O+K₂O]/[Al₂O₃] of from 0.1 to 5.

A one hundred twenty-second aspect of the present disclosure may include any one of the one hundred fourteenth through one hundred twenty-first aspects, wherein the glass ceramic article has a molar ratio [Na₂O+K₂O]/[ZrO₂] of from 0.3 to 5.

A one hundred twenty-third aspect of the present disclosure may include any one of the one hundred fourteenth through one hundred twenty-second aspects, wherein the glass ceramic article has a molar ratio [MgO+CaO+BaO+SrO+ZnO]/[Al₂O₃] of from 0.05 to 5.

A one hundred twenty-fourth aspect of the present disclosure may include any one of the one hundred fourteenth through one hundred twenty-third aspects, wherein the glass ceramic article has a molar ratio [MGO+CaO+BaO+SrO+ZnO]/[ZrO₂] of from 0.1 to 5.

A one hundred twenty-fifth aspect of the present disclosure may include any one of the one hundred fourteenth through one hundred twenty-fourth aspects, wherein the glass ceramic article is strengthened and has a depth of compression of from 0*t to 0.3*t, where t is thickness of the glass ceramic article.

A one hundred twenty-sixth aspect of the present disclosure may include any one of the one hundred fourteenth through one hundred twenty-fifth aspects, wherein the glass ceramic article has a stress of less than 30 nm of retardation per mm of glass ceramic article thickness.

A one hundred twenty-seventh aspect of the present disclosure may include any one of the one hundred fourteenth through one hundred twenty-sixth aspects, wherein the glass ceramic article comprises a stress of less than 25 nm of retardation per mm of glass ceramic article thickness.

A one hundred twenty-eighth aspect of the present disclosure may include any one of the one hundred fourteenth through one hundred twenty-seventh aspects, wherein the glass ceramic article a haze in units of percent (%) of less than 0.0994t+0.12, where t is the thickness of the glass ceramic article in mm.

A one hundred twenty-ninth aspect of the present disclosure may include any one of the one hundred fourteenth through one hundred twenty-eighth aspects, wherein the glass ceramic article has an optical transmission in units of percent (%) of greater than 0.91×10(2−0.03t) of electromagnetic radiation having wavelengths from 450 nm to 800 nm, where t is the thickness of the glass ceramic article in mm.

A one hundred thirtieth aspect of the present disclosure may include any one of the one hundred fourteenth through one hundred twenty-ninth aspects, wherein the glass ceramic article comprises a haze measured at 0.8 mm thickness of less than 0.20.

A one hundred thirty-first aspect of the present disclosure may include any one of the one hundred fourteenth through one hundred thirtieth aspects, wherein the glass ceramic article comprises an optical transmission of electromagnetic radiation wavelengths from 450 nm to 800 nm measured at 0.8 mm thickness of greater than 85%.

A one hundred thirty-second aspect of the present disclosure may include any one of the one hundred fourteenth through one hundred thirty-first aspects, wherein the glass ceramic article has a thickness from 0.3 mm and 1 mm.

A one hundred thirty-third aspect of the present disclosure may include any one of the one hundred fourteenth through one hundred thirty-second aspects, wherein the glass ceramic article comprises a component of an electronic device.

A one hundred thirty-fourth aspect of the present disclosure may include any one of the one hundred fourteenth through one hundred thirty-third aspects, wherein the glass ceramic article is a transparent cover plate for an electronic device.

A one hundred thirty-fifth aspect of the present disclosure may include any one of the one hundred fourteenth through one hundred thirty-fourth aspects, comprising an electronic device comprising a transparent surface, the transparent surface comprising the glass ceramic article of any one of the one hundred fourteenth through one hundred thirty-fourth aspects.

A one hundred thirty-sixth aspect of the present disclosure may include the one hundred thirty-fifth aspect, wherein the glass ceramic article has a thickness of from 0.3 mm to 1 mm.

A one hundred thirty-seventh aspect of the present disclosure may either one of the one hundred thirty-fifth or one hundred thirty sixth aspects, wherein the electronic device is a consumer electronic device.

A one hundred thirty-eighth aspect of the present disclosure may include a glass ceramic article comprising a first surface, a second surface opposing the first surface, a lithium disilicate crystalline phase, a petalite crystalline phase, a residual glass phase, a compressive stress layer extending from the first surface to a depth of compression (DOC), wherein a compressive stress of the compressive stress layer is greater than or equal to 200 MPa, the DOC is greater than or equal to 10% of a thickness of the glass ceramic article, and a concentration of the residual glass phase is from 15 wt. % to 50 wt. %.

A one hundred thirty-ninth aspect of the present disclosure may include the one hundred thirty-eighth aspect, wherein the glass ceramic article has a Young's modulus of from 90 GPa to 110 GPa.

A one hundred fortieth aspect of the present disclosure may include either one of the one hundred thirty-eighth or one hundred thirty-ninth aspects, wherein the glass ceramic article has a shear modulus of from 35 GPa to 50 GPa.

A one hundred forty-first aspect of the present disclosure may include any one of the one hundred thirty-eighth through one hundred fortieth aspects, wherein the glass ceramic article has a Poisson's ratio of from 0.19 to 0.24.

A one hundred forty-second aspect of the present disclosure may include any one of the one hundred thirty-eighth through one hundred forty-first aspects, wherein the glass ceramic article has a fracture toughness of from 1.0 MPa/m^{0.5} to 2.0 MPa/m^{0.5}, from 1.1 MPa/m^{0.5} to 1.3 MPa/m^{0.5}, or from 1.12 MPa/m^{0.5} to 1.22 MPa/m^{0.5}.

A one hundred forty-third aspect of the present disclosure may include any one of the one hundred thirty-eighth through one hundred forty-second aspects, wherein the glass ceramic article has a stress optical coefficient (SOC) of from 2.60 nm/mm/MPa to 2.75 nm/mm/MPa.

A one hundred forty-fourth aspect of the present disclosure may include any one of the one hundred thirty-eighth through one hundred forty-third aspects, wherein the glass ceramic article has an index of refraction of from 1.5 to 1.6 for light having wavelength of 589.3 nm.

A one hundred forty-fifth aspect of the present disclosure may include any one of the one hundred thirty-eighth through one hundred forty-fourth aspects, wherein the glass ceramic article has a thickness of from 0.3 mm to 1.0 mm.

A one hundred forty-sixth aspect of the present disclosure may include any one of the one hundred thirty-eighth through one hundred forty-fifth aspects, wherein the glass ceramic article has a central tension of greater than or equal to 30 MPa.

A one hundred forty-seventh aspect of the present disclosure may include any one of the one hundred thirty-eighth through one hundred forty-sixth aspects, wherein the glass ceramic article has one or more of the following: a molar ratio [Na₂O+K₂O]/[Al₂O₃] of from 0.1 to 5; a molar ratio [Na₂O+K₂O]/[ZrO₂] of from 0.3 to 5; a molar ratio [MgO+CaO+BaO+SrO+ZnO]/[Al₂O₃] of from 0.05 to 5; a molar ratio [MgO+CaO+BaO+SrO+ZnO]/[ZrO₂] of from 0.1 to 5; or combinations thereof.

A one hundred forty-eighth aspect of the present disclosure may include any one of the one hundred thirty-eighth through one hundred forty-seventh aspects, wherein the glass ceramic article comprises a component of an electronic device.

A one hundred forty-ninth aspect of the present disclosure may include the one hundred forty-eighth aspect, wherein the glass ceramic article is a transparent cover plate for an electronic device.

A one hundred fiftieth aspect of the present disclosure may include any one of the one hundred thirty-eighth through one hundred forty-ninth aspects, comprising an electronic device comprising a transparent surface, the transparent surface comprising the glass ceramic article of any one of the one hundred thirty-eighth through one hundred forty-ninth aspects.

A one hundred fifty-first aspect of the present disclosure may include the one hundred fiftieth aspect, wherein the glass ceramic article has a thickness of from 0.3 mm to 1 mm.

A one hundred fifty-second aspect of the present disclosure may include any one of the one hundred fiftieth through one hundred fifty-first aspects, wherein the electronic device is a consumer electronic device.

A one hundred fifty-third aspect of the present disclosure may include a glass ceramic article comprising a lithium disilicate crystalline phase, a petalite crystalline phase, and a residual glass phase, wherein a concentration of the residual glass phase is from 15 wt. % to 50 wt. % based on the total weight of the glass ceramic article, the glass ceramic article has a thickness of from 0.3 mm to 1.0 mm, and the glass ceramic article comprises a component of an electronic device.

A one hundred fifty-fourth aspect of the present disclosure may include the one hundred fifty-third aspect, wherein the glass ceramic article comprises at least one concave surface.

A one hundred fifty-fifth aspect of the present disclosure may include any one of the one hundred fifty-third through one hundred fifty-fourth aspects, wherein an outer surface of the glass ceramic article comprises a flat rectangular outer surface and a convex border region circumscribing the flat rectangular outer surface.

A one hundred fifty-sixth aspect of the present disclosure may include the one hundred fifty-fifth aspect, wherein the convex border region has a width of 10 mm.

A one hundred fifty-seventh aspect of the present disclosure may include any one of the one hundred fifty-third through one hundred fifty-sixth aspects, wherein the glass ceramic article has a rectangular shape in top view with four rounded corners.

A one hundred fifty-eighth aspect of the present disclosure may include any one of the one hundred fifty-sixth through one hundred fifty-seventh aspects, wherein each of the rounded corners is congruent with an arc of a circle having radius of 20 mm.

A one hundred fifty-ninth aspect of the present disclosure may include any one of the one hundred fifty-third through one hundred fifty-eighth aspects, wherein the glass ceramic article has a length of from 100 mm to 200 mm and a width of from 50 mm to 100 mm.

A one hundred sixtieth aspect of the present disclosure may include any one of the one hundred fifty-third through one hundred fifty-ninth aspects, wherein the glass ceramic article is a transparent cover plate for an electronic device.

A one hundred sixty-first aspect of the present disclosure may include any one of the one hundred fifty-third through one hundred sixtieth aspects, comprising an electronic device comprising a transparent surface, the transparent surface comprising the glass ceramic article of any one of the one hundred fifty-third through one hundred sixtieth aspect.

A one hundred sixty-second aspect of the present disclosure may include the one hundred sixty-first aspect, wherein the glass ceramic article has a thickness of from 0.3 mm to 1 mm.

A one hundred sixty-third aspect of the present disclosure may include any one of the one hundred sixty first through one hundred sixty-second aspects, wherein the electronic device is a consumer electronic device.

These and other aspects, advantages, and salient features will become apparent from the following detailed description, the accompanying drawings, and the appended claims.

### BRIEF DESCRIPTION OF THE DRAWINGS

FIG. 1 schematically depicts a glass stack, according to embodiments disclosed and described herein;

FIG. 2 schematically depicts a cross-sectional side view of a strengthened glass-ceramic article, according to embodiments disclosed and described herein;

FIG. 3 graphically depicts percent haze (y-axis) as a function of thickness (x-axis) for glass ceramic sheets, according to embodiments disclosed and described herein;

FIG. 4A Schematically depicts a top plan view of an electronic device incorporating any glass ceramic article disclosed herein, according to embodiments disclosed and described herein;

FIG. 4B schematically depicts a perspective view of the electronic device of FIG. 4A, according to embodiments disclosed and described herein;

FIG. 5 graphically depicts a beam bending viscosity report for compositions of Examples 8, 9, and 10 and the compositions of Comparative Examples 11 and 12, according to embodiments disclosed and described herein;

FIG. 6 schematically depicts a top plan view of a flat glass ceramic preform, according to embodiments disclosed and described herein;

FIG. 7A schematically depicts a top plan view of a glass ceramic article prepared through 3D forming the glat glass ceramic preform of FIG. 6, according to embodiments disclosed and described herein;

FIG. 7B schematically depicts a side cross-sectional view of the glass ceramic article of FIG. 7A taken along reference line 7B-7B in FIG. 7A, according to embodiments disclosed and described herein;

FIG. 8A is a photograph of the glass ceramic article of Comparative Example 15 showing staining following nucleation and then simultaneous 3D forming and ceramming, according to one or more embodiments shown and described herein;

FIG. 8B is a photograph of the glass ceramic article of Example 14 showing the staining following ceramming and then subsequent 3D forming, according to one or more embodiments shown and described herein;

FIG. 9A is a photograph of the shadows produced by passing the xenon light through the glass ceramic article of Comparative Example 15; according to one or more embodiments shown and described herein;

FIG. 9B is a photograph of the shadows produced by passing the xenon light through the glass ceramic article of Example 14, according to one or more embodiments shown and described herein;

FIG. 10 graphically depicts a qualitative assessment of post-3D-forming finishing of the glass ceramic articles of Examples 14 and Comparative Example 15 in comparison to post-3D-forming finishing of a glass article subjected to 3D forming without nucleation or ceraming, according to one or more embodiments shown and described herein; and

FIG. 11 graphically depicts a concentration of residual glass phase after 3D forming (left y-axis) and mol % of non-lithium alkali metal oxides and alkaline earth metal oxides in the glass compositions (right y-axis) for the glass ceramic articles of Examples 13 and 14 and Comparative Examples 16 and 17, according to one or more embodiments shown and described herein.

### DETAILED DESCRIPTION

Reference will now be made in detail to embodiments of glass ceramic articles, glass and/or glass ceramic compositions for producing the glass ceramic articles, and methods for ceramming and 3D forming or shaping the glass ceramic articles, various embodiments of which will be described herein with specific reference to the accompanying drawings. Whenever possible, the same reference numerals will be used throughout the drawings to refer to the same or like parts. In the following detailed description, numerous specific details may be set forth in order to provide a thorough understanding of embodiments described herein. However, it will be clear to one skilled in the art when embodiments may be practiced without some or all of these specific details. In other instances, well-known features or processes may not be described in detail so as not to unnecessarily obscure the disclosure. In addition, like or identical reference numerals may be used to identify common or similar elements. Moreover, unless otherwise defined, all technical and scientific terms used herein have the same meaning as commonly understood by one of ordinary skill in the art to which this disclosure belongs. In case of conflict, the present specification, including the definitions herein, will control.

### Definitions and Measurement Techniques

Although other methods and materials can be used in the practice or testing of the embodiments, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. More specifically, the example composition ranges given herein are considered part of the specification and further, are considered to provide example numerical range endpoints, equivalent in all respects to their specific inclusion in the text, and all combinations are specifically contemplated and disclosed. Further, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the disclosure be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

As a result of the raw materials and/or equipment used to produce the glass or glass ceramic composition of the present disclosure, certain impurities or components that are not intentionally added, can be present in the final glass or glass ceramic composition. Such materials are present in the glass or glass ceramic composition in minor amounts and are referred to herein as “tramp materials.”

As used herein, a glass or glass ceramic composition having 0 wt % of a compound is defined as meaning that the compound, molecule, or element was not purposefully added to the composition, but the composition may still comprise the compound, typically in tramp or trace amounts. Similarly, “iron-free,” “sodium-free,” “lithium-free,” “zirconium-free,” “alkali earth metal-free,” “heavy metal-free” or the like are defined to mean that the compound, molecule, or element was not purposefully added to the composition, but the composition may still comprise iron, sodium, lithium, zirconium, alkali earth metals, or heavy metals, etc., but in approximately tramp or trace amounts.

As used herein, the term “glass ceramic” refers to solids prepared by controlled crystallization of a precursor glass and have one or more crystalline phases and a residual glass phase.

As used herein, “depth of compression” or “DOC” refers to the depth of a compressive stress (CS) layer and is the depth at which the stress within a glass ceramic article changes from compressive stress to tensile stress and has a stress value of zero. According to the convention normally used in the art, compressive stress (CS) is expressed as a negative (<0) stress and tensile stress is expressed as a positive (>0) stress. Throughout this description, however, and unless otherwise noted, CS is expressed as a positive or absolute value—that is, as recited herein, CS=|CS|.

The DOC, midpoint central tension (CT), and maximum CT values are measured using a scattered light polariscope (SCALP) model number SCALP-05 available from GlasStress Ltd., located in Tallinn, Estonia. The angle of the laser of the SCALP-05 instrument during measurement was 79.3 degrees.

The surface CS is measured by a surface stress meter (FSM) using a commercially-available instrument, such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the entire contents of which are incorporated herein by reference.

The CS in the remainder of the CS region is measured by the refracted near-field (RNF) method described in U.S. Pat. No. 8,854,623, entitled “Systems and Methods for Measuring a Profile Characteristic of a Glass Sample”, the entire contents of which are hereby incorporated herein by reference. The RNF measurement is force balanced and calibrated to the maximum CT value provided by a SCALP measurement. In particular, the RNF method includes placing the glass article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

The DOC, midpoint central tension (CT), and maximum CT values are measured using a scattered light polariscope (SCALP) model number SCALP-05 available from GlasStress Ltd., located in Tallinn, Estonia. The angle of the laser of the SCALP-05 instrument during measurement was 79.3 degrees. SOC of the glass ceramic was set to 2.654, and the index of refraction (RI) was set to 1.531. The values of SOC and RI can change depending on the composition of the glass ceramic. The values above of the parameters above (SOC=2.654 and RI=1.531) are representative of the compositions disclosed herein.

The stress profile may be measured with a combination of RNF for the inner CS, SCALP for the CT region, and the method used for measuring the surface CS.

Stored tensile energy in (J/m²) is calculated using the following Equation (1):

stored tensile energy (J/m²)=[(1−v)/E]∫(σ²)(dt) (1).

In Equation (1), v is Poisson's ratio, E is the Young's modulus, σ is the stress, t is the thickness, and the integration is calculated across the thickness of the tensile region only.

The values for the Poisson's ratio recited in this disclosure refer to values as measured by a resonant ultrasonic spectroscopy technique of the general type, which is set forth in ASTM E2001-13.

The crystalline phase assemblage (before ion exchange) and weight percentage of the crystalline phases and residual glass phase is determined based on x-ray diffraction (XRD) using a Rietveld analysis. The XRD specta were obtained using a D8 ENDEAVOR™ XRD machine available from Bruker and equipped with Cu radiation and a LynxEye detector. The Rietveld analysis based on the XRD spectra were performed using the TOPAS™ version 6 analysis software from Bruker.

The following procedure, referred to herein as “the Fragment Test,” is used for determining the number of fragments the glass-ceramic article breaks into upon fracture. An ion-exchanged glass ceramic article have dimensions of 50 mm by 50 mm by 0.8 mm is placed on a steel surface. A stylus with a tungsten carbide tip (available from Fisher Scientific Industries, under the trademark TOSCO® and manufacturer identifying number #13-378, with a 60 degree coni-spherical tip), having a weight of 40 g is connected to a clamp on a gear driven mechanism that moves the stylus up and down. The tip of the stylus is placed in contact with the glass-ceramic article and then the gear mechanism is incrementally turned until the glass-ceramic article breaks. Then the number of fragments is counted.

Fracture toughness is measured following the Chevron Notch Short Bar (CNSB) ASTM E 1304-97 method. The samples measured are prepared from a thick patty of glass of the desired composition and cerammed with the ceramming cycle of interest (“COR” in the example presented) in a box furnace. The fracture toughness value (Kic) was measured by the chevron notched short bar (CNSB) method disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988), except that Y*m is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992).

The Young's modulus values recited in this disclosure refer to a value as measured by a resonant ultrasonic spectroscopy technique of the general type, which is set forth in ASTM E2001-13.

The shear modulus values recited in this disclosure refer to values as measured by a resonant ultrasonic spectroscopy technique of the general type, which is set forth in ASTM E2001-13.

The index of refraction measurements were performed on the Metricon Model 2010 Prism Coupler at 589.3 nanometers.

Haze of a glass-ceramic article is measured using a haze meter, such as the BYK Gardner Haze-Gard I, such as following ASTM D1003 or ASTM D1044. The specific test method will be indicated in conjunction with reporting the results.

The transmittance, as utilized herein refers to total transmittance, and is measured with a Perkin Elmer Lambda 950 UV/VIS/NIR spectrophotometer with a 150 mm integrating sphere. The samples were mounted at the sphere's entrance port, allowing for collection of wide angle scattered light. The total transmittance data was collected with the reference Spectralon reflectance disc over the sphere's exit port. The percent of total transmittance (% T) was calculated relative to an open beam baseline measurement.

Stress, which is measured as the retardance of the glass-ceramics after ceramming, is measured by the GFP1400 instrument sold by Stress Photonics Inc. of Madison, Wis. (GFP=Grey Field Polarizer). Similar measurements may be made with other systems, such as commercially available systems (systems sold by Axometrics, Inc.) or custom-made systems. The stress is typically measured on the full sheets after ceramming. The measurement area corresponds to an area ˜5 mm inbound from the dimensions of the full sheet (full sheets have dimensions ˜245×641 (+/−10 mm) in the given examples). Alternatively, the stress can be measured on parts cut from the full sheets after ceramming. The parting agent remaining on the surface of the sheets may lead to higher stress values reported. This parting agent can be removed (brushing or washing the surface) prior to measurements.

Optical transmission is measured in the 250-1000 nm wavelength range on optically polished samples with plane parallel faces using a Perkin Elmer Lambda 950 spectrophotometer, with data interval of 2 nm. The transmission is measured on the glass ceramic article itself without any coatings or other applications.

X-ray diffraction (XRD) is measured using a Bruker D4 ENDEAVOR™ XRD machine equipped with Cu radiation and a LynxEye detector. The Rietveld analysis is done using Bruker's Topas software package.

Raman data is measured using DXR2 SmartRaman instrument from Thermo Fisher.

Heat capacity is measured according to standard test method ASTM E1461 at room temperature.

Density is measured in accordance with standard test method ASTM C20.

Thermal conductivity is measured according to standard test method ASTM E1461 at room temperature.

The optical retardation may be measured according to standard test method ASTM F218-13.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Directional terms as used herein—for example up, down, right, left, front, back, top, bottom, vertical, horizontal—are made only with reference to the figures as drawn and are not intended to imply absolute orientation unless otherwise expressly stated.

As used herein, the terms “warp” and “flatness”—and any variations thereof—are used interchangeably and have the same meaning.

Any ranges used herein include all ranges and subranges and any values there between unless explicitly stated otherwise.

Overview of Glass Ceramic Articles

Glass ceramic articles have attributes that can be tailored for use as cover substrates and/or housings for mobile electronic devices. For example, without being bound by theory, glass-ceramic articles with high fracture toughness and/or high Young's modulus can provide resistance to crack penetration and drop performance. When such glass ceramic articles are chemically strengthened, for example through ion exchange, the resistance to crack penetration and drop performance can be further enhanced. And the high fracture toughness and/or Young's modulus can also increase the amount of stored tensile energy and maximum central tension that can be imparted to the glass ceramic article through chemical tempering while maintaining desirable fragmentation of the glass ceramic article upon fracture. As another example, the optical characteristics of the glass ceramic articles, such as transparency and haze, can be tailored through adjusting the heating and/or ceramming schedule used to turn a glass article into a glass ceramic article as well as through chemical strengthening, such as through ion exchange, to design or control the properties of the glass-ceramic article.

The glass ceramic articles of the present disclosure comprise glass ceramics that are clear and transparent or translucent lithium-containing aluminosilicate glass ceramic compositions that include petalite and lithium silicates as the primary crystal phases, as well as a residual glass phase. The lithium silicate crystal phases may be lithium disilicate or lithium metasilicate. In embodiments, the lithium silicate crystal phase may be lithium disilicate. Improved properties of the glass ceramic compositions disclosed herein include: 1) lithium silicates, such as lithium disilicates, are retained as a major crystal phase, providing inherently high mechanical strength and fracture toughness to the glass-ceramic; and 3) petalite is a second major crystal phase and has a fine grain size, which contributes to the transparency or translucency of the glass-ceramic, and also can be ion-exchanged for additional mechanical strength.

Glass and glass ceramics can be formed into three-dimensional glass ceramic articles using various methods. 3D forming of glass ceramics to produce glass ceramic articles typically includes a two-step 3D forming process. This two-step 3D forming process includes a first step in which a glass composition is nucleated only. Nucleating refers to heating the glass composition to a nucleating temperature, at which nucleating crystal phases, such as lithium phosphate crystal phases, are formed. The nucleating crystal phases may then act to seed crystallization of the primary crystalline phases during subsequent forming or post-forming ceramming of the glass. The nucleated glass composition is cooled. In the second step, after cooling, the nucleated glass composition is 3D formed into the desired 3D shape by heating the nucleated glass composition and pressing the nucleated glass composition into a mold. Ceramming the glass to produce the majority of the crystalline phases in the glass ceramic is completed in the second step during the 3D forming and simultaneously with pressing the glass into the mold. In these existing 3D forming processes, the crystallization is completed in the pressing mold where the majority of the crystalline phase formed simultaneous with the 3D forming. In another forming process, the 3D forming can include a “pre-nucleation” step, following by the 3D forming process, and then followed by post-3D-forming ceramming to complete development of the primary crystalline phases. In this type of process, the crystallization of the material, i.e. the formation of the majority of the crystalline phase assemblage found in the final product, occurs during the 3D forming process and after the 3D forming process.

However, ceramming the glass composition to produce the glass ceramic material during 3D forming of the glass ceramic article can result in significant surface defects, shrinkage, and other quality defects, which can increase the degree of post-forming finishing required to meet quality specifications.

General Overview of the Compositions and Methods for 3D Forming

The present disclosure solves these problems with the existing 3D forming processes by disclosing glass ceramic compositions that enable thermal 3D forming of the glass ceramic after ceramming the glass ceramic to produce the glass ceramic articles. The present disclosure is further directed to methods that include 3D forming a cerammed glass ceramic preform to produce the glass ceramic articles. In the methods disclosed herein, the glass ceramics can be 3D formed after ceramming a precursor glass to make the transparent glass ceramic preform (i.e., 3D formed after a material with a high amount of crystalline phase was produced using a standard ceram process). After ceramming and before 3D forming, the glass ceramic preform may have a total concentration of crystal phases of from 50 wt. % to 90 wt. % based on the total weight of the glass ceramic preform.

These method of 3D forming to produce glass ceramic articles are enabled by the glass ceramic compositions that have a concentration of non-lithium alkali metal oxides (e.g., Na₂O, K₂O, or both) of greater than or equal to 0.5 mol %, a molar ratio of the non-lithium alkali metal oxides to alumina of greater than or equal to 0.1 (i.e., [Na₂O+K₂O]/[Al₂O₃]≥0.1), a molar ratio of the non-lithium alkali metal oxides to zirconia of greater than or equal to 0.3 (i.e., [Na₂O+K₂O]/[ZrO₂]≥0.3), or combinations of thereof. In embodiments, additionally or alternatively, the glass ceramic compositions may have a concentration of RO of greater than or equal to 0.5 mol %, a molar ratio of RO to alumina of greater than or equal to 0.05 (i.e., [RO]/[Al₂O₃]≥0.05), a high molar ratio of RO to zirconia of greater than or equal to 0.1 (i.e., [RO]/[Al₂O₃]≥0.1), or combinations of thereof, where RO is equal to the total of ZnO, MgO, CaO, BaO, and SrO.

The glass ceramic articles disclosed herein may be produced by first producing a precursor glass having the compositions disclosed herein through conventional melting and glass forming procedures of glass manufacturing. After cool down, the glass material may be subjected to a secondary heat treatment (i.e., ceramming process) consisting of nucleation and crystal growth steps that are required to grow in the crystalline phases of interest to produce a glass ceramic preform. As previously discussed, the glass ceramics disclosed herein contain greater concentrations of non-lithium alkali and alkaline earth elements, including Na₂O, K₂O, and/or CaO (>0.5 mol %). In these transparent glass ceramics, these constituents do not enter the crystalline phases grown during the ceramming process, and instead remain in a residual glass phase. Greater amounts of these non-lithium alkali oxides and/or alkaline earth oxides contribute to an increase in the residual glass phase in the glass ceramics after the ceram process. In addition, the greater concentrations of these constituents in the residual glass phase contribute to lower viscosity of the cerammed material during three-dimensional (3D) thermal forming in the temperature range of the process.

The glass ceramic compositions and processes of producing glass ceramic articles therefrom by 3D forming the glass ceramic preform after the ceram process may provide improved 3D shaping of the glass ceramic, while maintaining high optical transmission of the 3D formed glass ceramic articles. The cerammed glass ceramics may be thermally formed into various three-dimensional shapes while maintaining the cerammed qualities (e.g., mechanical strength, fracture toughness, transparency/translucency, etc.) and improving surface quality and chemical strengthening attributes of the glass ceramic articles. A high amount of non-Li₂O alkali and/or alkaline earth elements in the residual glass phase, after ceram and before 3D forming, may lead to lower viscosity of the residual glass phase and may enable the 3D forming after full ceram of the glass ceramic to produce the majority of the crystalline phases. The process for 3D forming the cerammed glass ceramics may enable a scaleable process for forming glass ceramic enclosures with improved materials utilization, and lower cost compared to processes the comprise pre-nucleating the glass and then 3D forming and simultaneously ceramming the glass to produce the crystalline phases or to processes that comprise ceramming and then machining the glass ceramic to produce the 3D shape from a thick piece of the glass ceramic. The glass ceramics disclosed herein contain a high concentration of crystalline phase(s) after the standard ceram process but can still be 3D shaped due to the amount of non-lithium alkali (Na₂O+K₂O) and/or alkaline earth (e.g. CaO) they contain, which remain in the residual glass phase around the crystals and provide the dual effects of increasing the amount of residual glass phase and decreasing the viscosity of the residual glass phase, which can enable the 3D forming even for a highly crystalline material, while maintaining high transparency, low haze, and good ion-exchange performance.

The glass ceramic articles produced from the compositions and processes disclosed herein possess high optical transparency and high mechanical performance, which may improve the performance of the glass ceramic articles for use as cover glass for hand held electronic devices. Three-dimensional shaping expands this typical two-dimensional space. The possibility to 3D shape a highly crystalline glass ceramic material after a full ceram cycle may enable production of three-dimensional shapes with improved surface defects, thereby reducing the downstream polishing required to meet quality specifications. The optical transparency of the highly crystalline glass ceramic (>50% by weight) may be developed through the presence of crystals that are smaller than the wavelength of light (e.g., <150 nanometers (nm)) and by matching of the index of refraction of the crystal phases present and the residual glass phase. The index match results in low scattering in the composite material, and thus lower haze and higher transmission. The low haze of the glass ceramic articles disclosed herein may enable the glass ceramic articles to be used for cover glass applications, where low haze and high transparency are a requirement.

The glass ceramic compositions disclosed herein may further result in an increase in the concentration of residual glass phase after the 3D forming compared to the cerammed glass ceramic preform prior to 3D shaping. The concentration and composition of the residual glass phase may also improve the ion-exchange process for strengthening the glass ceramic articles post-forming. Particularly, increasing the concentration of the residual glass phase during 3D forming can lead to increased ion diffusion rate of ion-exchange ions into the surface of the glass ceramic articles, which can increase the compression stress (CS) in the resulting compression layer and increase the corresponding central tension (CT). The diffusivity of ions into the surface of the glass ceramic articles may be impacted by the amount of residual glass phase and/or size of the crystalline phase islands, as well as the amount of alkali in the residual glass phase. Other benefits or advantages of the glass ceramic compositions and processes disclosed herein may become apparent to those of ordinary skill in the art by practicing the subject matter disclosed herein.

As previously discussed, the methods of the present disclosure for making glass ceramic articles may include 3D forming a glass ceramic preform that has been cerammed to produce the primary crystalline phases expected to be present in the final glass ceramic article. In embodiments, the methods may include shaping a glass ceramic pre-form to produce the glass ceramic article having a lithium disilicate crystalline phase, a petalite crystalline phase, and a residual glass phase. Prior to 3D forming, the glass ceramic pre-form comprises the lithium disilicate crystalline phase, the petalite crystalline phase, and the residual glass phase. After 3D forming, the glass ceramic article comprises a concentration of the residual glass phase equal or greater than a concentration of the residual glass phase in the glass ceramic pre-form. In embodiments, prior to 3D forming, a concentration of a residual glass phase in the glass ceramic pre-form may be from 10 wt. % to 50 wt. %, with the remainder being crystalline phases, such as the lithium disilicate crystalline phase, the petalite crystalline phase, or both. In embodiments, the processes of the present disclosure may further include preparing a glass comprising a glass composition and then ceramming the glass to produce a glass ceramic. The glass ceramic or the glass prior to ceramming may be divided into a plurality of glass ceramic preforms or glass per-forms. The glass ceramic pre-forms, after ceramming, may then be subjected to 3D forming to produce the glass ceramic articles.

Compositions in Weight Percent

The glass ceramic pre-form and glass ceramic articles may be made from any glass composition suitable for forming glass-ceramic articles, although it should be understood that the glass composition of the glass sheets can impact the mechanical and optical properties of the glass-ceramic article. In embodiments, the glass composition is selected such that the resultant glass-ceramic article has primary crystalling phases that include a petalite crystalline phase and a lithium silicate crystalline phases, and wherein the petalite crystalline phase and the lithium silicate crystalline phase have greater weight percentages than other crystalline phases present in the glass ceramic article. In particular, the composition of the glass from which the glass ceramic articles are prepared includes silica (SiO₂), alumina (AL₂O₃), lithium oxide (LiO₂), phosphorous pentoxide (P₂O₅), and zirconia (ZrO₂) The SiO₂, Al₂O₃, LiO₂, and P₂O₅ may be the primary constituents forming the lithium silicate crystalline phases, petalite crystalline phases, or both of the glass ceramics during ceramming. By way of example and not limitation, in embodiments, the glass ceramic pre-form and glass ceramic articles may be formed from a glass comprising a glass composition that includes from about 55 wt % to about 80 wt % SiO₂, from about 0 wt % to about 20 wt % Al₂O₃, from about 5 wt % to about 20 wt % Li₂O, from about 0 wt % to about 6 wt % P₂O₅, and from about 0.2 wt % to about 15 wt % ZrO₂.

The compositions of the glass from which the glass ceramic articles are prepared further includes one or more non-lithium alkali metal oxides (e.g., Na₂O and/or K₂O), alkaline metal oxides (e.g., MgO, CaO, BaO, SrO), transition metal oxides (e.g., ZnO), or combinations of thereof. In particular, the compositions of the glass from which the glass ceramic articles are prepared may include one or more of Na₂O, K₂O, ZnO, CaO, MgO, BaO, SrO, B₂O₅, or combinations thereof. The non-lithium alkali metal oxides, alkaline oxides, ZnO, or combinations thereof may increase the concentration of the residual glass phase in the glass ceramics to facilitate 3D thermal forming after ceramming, according to the methods disclosed herein. In embodiments, the glass composition can include other constituents to modify one or more properties of the glass, glass ceramic pre-form, or glass ceramic article, or to facilitate processing of the glass.

SiO₂, an oxide involved in the formation of glass, can function to stabilize the networking structure of glasses and glass-ceramics. In various glass compositions, the concentration of SiO₂ should be sufficiently high in order to form petalite crystal phases when the glass is heat treated during ceramming to convert the glass to the glass ceramic. The amount of SiO₂ may be limited to control the melting temperature of the glass, since the melting temperatures of pure SiO₂ and glasses with high-SiO₂ concentration are undesirably high. In embodiments, the glass or glass ceramic composition may comprise from about 55 wt % to about 80 wt % SiO₂ Based on the total weight of the glass or glass ceramic composition. In embodiments, the glass or glass-ceramic composition may comprise from about 69 wt % to about 80 wt % SiO₂ In some embodiments, the glass or glass-ceramic composition can comprise from about 55 wt % to about 80 wt %, about 55 wt % to about 77 wt %, about 55 wt % to about 75 wt %, about 55 wt % to about 73 wt %, about 60 wt % to about 80 wt %, about 60 wt % to about 77 wt %, about 60 wt % to about 75 wt %, about 60 wt % to about 73 wt %, about 68 wt % to about 80 wt %, about 68 wt % to about 77 wt %, about 68 wt % to about 75 wt %, about 68 wt % to about 73 wt %, about 69 wt % to about 80 wt %, about 69 wt % to about 77 wt %, about 69 wt % to about 75 wt %, about 69 wt % to about 73 wt %, about 70 wt % to about 80 wt %, about 70 wt % to about 77 wt %, about 70 wt % to about 75 wt %, about 70 wt % to about 73 wt %, about 73 wt % to about 80 wt %, about 73 wt % to about 77 wt %, about 73 wt % to about 75 wt %, about 75 wt % to about 80 wt %, about 75 wt % to about 77 wt %, or about 77 wt % to about 80 wt % SiO₂ based on the total weight of the glass or glass ceramic composition.

Al₂O₃ may also provide stabilization to the network and also provides improved mechanical properties and chemical durability. If the amount of Al₂O₃ is too high, however, the fraction of lithium silicate crystals may be decreased, possibly to the extent that an interlocking structure cannot be formed. The amount of Al₂O₃ may be modified to control viscosity. Further, if the amount of Al₂O₃ is too high, the viscosity of the melt is also generally increased. In embodiments, the glass or glass-ceramic composition can comprise from about 0 wt % (i.e., zero wt %) to about 20 wt % Al₂O₃ based on the total weight of the glass or glass ceramic composition In embodiments, the glass or glass-ceramic composition can comprise from about 6 wt % to about 9 wt Al₂O₃. In embodiments, the glass or glass-ceramic composition can comprise from about 2 wt % to about 20 wt %, about 2 wt % to about 18 wt %, about 2 wt % to about 15 wt %, about 2 wt % to about 12 wt %, about 2 wt % to about 10 wt %, about 2 wt % to about 9 wt %, about 2 wt % to about 8 wt %, about 2 wt % to about 5 wt %, about 5 wt % to about 20 wt %, about 5 wt % to about 18 wt %, about 5 wt % to about 15 wt %, about 5 wt % to about 12 wt %, about 5 wt % to about 10 wt %, about 5 wt % to about 9 wt %, about 5 wt % to about 8 wt %, 6 wt % to about 20 wt %, about 6 wt % to about 18 wt %, about 6 wt % to about 15 wt %, about 6 wt % to about 12 wt %, about 6 wt % to about 10 wt %, about 6 wt % to about 9 wt %, 8 wt % to about 20 wt %, about 8 wt % to about 18 wt %, about 8 wt % to about 15 wt %, about 8 wt % to about 12 wt %, about 8 wt % to about 10 wt %, 10 wt % to about 20 wt %, about 10 wt % to about 18 wt %, about 10 wt % to about 15 wt %, about 10 wt % to about 12 wt %, about 12 wt % to about 20 wt %, about 12 wt % to about 18 wt %, or about 12 wt % to about 15 wt % Al₂O₃ based on the total weight of the glass or glass ceramic composition

In the glass ceramics disclosed herein, Li₂O aids in forming both petalite and lithium silicate crystal phases. In fact, to obtain petalite and lithium disilicate as the predominant crystal phases, the glass or glass ceramic compositions may have at least about 5 wt % Li₂O, or at least about 7 wt % Li₂O, based on the total weight of the glass or glass ceramic composition. Additionally, it has been found that when the concentration of Li₂O gets too high (greater than about 20 wt %), the composition can become very fluid. Accordingly, in embodiments, the glass or glass ceramic composition can comprise from about 5 wt % to about 20 wt % Li₂O, based on the total weight of the glass or glass ceramic composition. In embodiments, the glass or glass-ceramic composition can comprise from about 10 wt % to about 20 wt % Li₂O, based on the total weight of the glass or glass ceramic composition. In embodiments, the glass or glass-ceramic composition can comprise from about 5 wt % to about 20 wt %, about 5 wt % to about 18 wt %, about 5 wt % to about 16 wt %, about 5 wt % to about 14 wt %, about 5 wt % to about 12 wt %, about 5 wt % to about 10 wt %, about 5 wt % to about 8 wt %, about 7 wt % to about 20 wt %, about 7 wt % to about 18 wt %, about 7 wt % to about 16 wt %, about 7 wt % to about 14 wt %, about 7 wt % to about 12 wt %, about 7 wt % to about 10 wt %, about 8 wt % to about 20 wt %, about 8 wt % to about 18 wt %, about 8 wt % to about 16 wt %, about 8 wt % to about 14 wt %, about 8 wt % to about 12 wt %, about 10 wt % to about 20 wt %, about 10 wt % to about 18 wt %, about 10 wt % to about 16 wt %, about 10 wt % to about 14 wt %, about 10 wt % to about 12 wt %, about 12 wt % to about 20 wt %, about 12 wt % to about 18 wt %, about 12 wt % to about 16 wt %, about 12 wt % to about 14 wt %, about 16 wt % to about 20 wt %, about 16 wt % to about 18 wt %, or about 18 wt % to about 20 wt % Li₂O.

The glass and glass-ceramic compositions disclosed herein can include P₂O₅. P₂O₅ can function as a nucleating agent to produce bulk nucleation. If the concentration of P₂O₅ is too low, the precursor glass does crystallize, but only at higher temperatures (due to a lower viscosity) and from the surface inward, yielding a weak and often deformed body. However, if the concentration of P₂O₅ is too high, the devitrification, upon cooling during the formation of the glass sheets, can be difficult to control. In embodiments, the glass and/or glass ceramic compositions disclosed herein can include from greater than 0 wt % to about 6 wt % P₂O₅, based on the total weight of the glass or glass ceramic composition. In embodiments, the glass and/or glass ceramic compositions disclosed herein may comprise from about 2 wt % to about 5 wt % P₂O₅. In embodiments, the glass and/or glass ceramic compositions disclosed herein can comprise from about 1.5 wt % to about 4.75 wt % P₂O₅. In some embodiments, the glass or glass-ceramic composition can include from 0 wt % to about 6 wt %, 0 wt % to about 5.5 wt %, 0 wt % to 5 wt %, 0 wt % to about 4.5 wt %, 0 wt % to about 4 wt %, 0 wt % to about 3.5 wt %, 0 wt % to about 3 wt %, 0 wt % to about 2.5 wt %, 0 wt % to about 2 wt %, 0 wt % to about 1.5 wt %, 0 wt % to about 1 wt %, >0 wt % to about 6 wt %, >0 wt % to about 5.5 wt %, >0 wt % to 5 wt %, >0 wt % to about 4.5 wt %, >0 wt % to about 4 wt %, >0 wt % to about 3.5 wt %, >0 wt % to about 3 wt %, >0 wt % to about >2.5 wt %, 0 wt % to about 2 wt %, >0 wt % to about 1.5 wt %, >0 wt % to about 1 wt %, about 0.5 wt % to about 6 wt %, about 0.5 wt % to about 5.5 wt %, about 0.5 wt % to 5 wt %, about 0.5 wt % to about 4.5 wt %, about 0.5 wt % to about 4 wt %, about 0.5 wt % to about 3.5 wt %, about 0.5 wt % to about 3 wt %, about 0.5 wt % to about 2.5 wt %, about 0.5 wt % to about 2 wt %, about 0.5 wt % to about 1.5 wt %, about 0.5 wt % to about 1 wt %, about 1 wt % to about 6 wt %, about 1 wt % to about 5.5 wt %, about 1 wt % to about 5 wt %, about 1 wt % to about 4.5 wt %, about 1 wt % to about 4 wt %, about 1 wt % to about 3.5 wt %, about 1 wt % to about 3 wt %, about 1 wt % to about 2.5 wt %, about 1 wt % to about 2 wt %, about 1 wt % to about 1.5 wt %, about 1.5 wt % to about 6 wt %, about 1.5 wt % to about 5.5 wt, about 1.5 wt % to 5 wt %, about 1.5 wt % to about 4.5 wt %, about 1.5 wt % to about 4 wt %, about 1.5 wt % to about 3.5 wt %, about 1.5 wt % to about 3 wt %, about 1.5 wt % to about 2.5 wt %, about 1.5 wt % to about 2 wt %, about 2 wt % to about 6 wt %, about 2 wt % to about 5.5 wt %, about 2 wt % to 5 wt %, about 2 wt % to about 4.5 wt %, about 2 wt % to about 4 wt %, about 2 wt % to about 3.5 wt %, about 2 wt % to about 3 wt %, about 2 wt % to about 2.5 wt %, about 2.5 wt % to about 6 wt %, about 2.5 wt % to about 5.5 wt %, about 2.5 wt % to 5 wt %, about 2.5 wt % to about 4.5 wt %, about 2.5 wt % to about 4 wt %, about 2.5 wt % to about 3.5 wt %, about 2.5 wt % to about 3 wt %, about 3 wt % to about 6 wt %, about 3 wt % to about 5.5 wt %, about 3 wt % to 5 wt %, about 3 wt % to about 4.5 wt %, about 3 wt % to about 4 wt %, about 3 wt % to about 3.5 wt %, about 3.5 wt % to about 6 wt %, about 3.5 wt % to about 5.5 wt %, about 3.5 wt % to 5 wt %, about 3.5 wt % to about 4.5 wt %, about 3.5 wt % to about 4 wt %, about 4 wt % to about 6 wt %, about 4 wt % to about 5.5 wt %, about 4 wt % to 5 wt %, about 4 wt % to about 4.5 wt %, about 4.5 wt % to about 6 wt %, about 4.5 wt % to about 5.5 wt %, about 4.5 wt % to about 5 wt %, about 5 wt % to about 6 wt %, about 5 wt % to about 5.5 wt %, or about 5.5 wt % to about 6 wt % P₂O₅, based on the total weight of the glass or glass ceramic composition.

In glass and glass-ceramic compositions, it is generally found that ZrO₂ can improve the stability of Li₂O-Al₂O₃—SiO₂—P₂O₅ glass by significantly reducing glass devitrification during forming and lowering liquidus temperature. At concentrations above 8 wt %, ZrSiO₄ can form a primary liquidus phase at a high temperature, which significantly lowers liquidus viscosity. Transparent glasses can be formed when the glass contains over 2 wt % ZrO₂. The addition of ZrO₂ can also help decrease the petalite grain size, which aids in the formation of a transparent glass-ceramic. In embodiments, the glass or glass-ceramic composition can comprise from about 0.2 wt % to about 15 wt % ZrO₂, based on the total weight of the glass and/or glass ceramic. In embodiments, the glass or glass-ceramic composition can include from about 2 wt % to about 6 wt % ZrO₂, based on the total weight of the glass and/or glass ceramic. In embodiments, the glass or glass-ceramic composition can comprise from about 0.2 wt % to about 15 wt %, about 0.2 wt % to about 12 wt %, about 0.2 wt % to about 10 wt %, about 0.2 wt % to about 8 wt %, about 0.2 wt % to about 6 wt %, about 0.2 wt % to about 4 wt %, about 0.5 wt % to about 15 wt %, about 0.5 wt % to about 12 wt %, about 0.5 wt % to about 10 wt %, about 0.5 wt % to about 8 wt %, about 0.5 wt % to about 6 wt %, about 0.5 wt % to about 4 wt %, about 1 wt % to about 15 wt %, about 1 wt % to about 12 wt %, about 1 wt % to about 10 wt %, about 1 wt % to about 8 wt %, about 1 wt % to about 6 wt %, about 1 wt % to about 4 wt %, about 2 wt % to about 15 wt %, about 2 wt % to about 12 wt %, about 2 wt % to about 10 wt %, about 2 wt % to about 8 wt %, about 2 wt % to about 6 wt %, about 2 wt % to about 4 wt %, about 3 wt % to about 15 wt %, about 3 wt % to about 12 wt %, about 3 wt % to about 10 wt %, about 3 wt % to about 8 wt %, about 3 wt % to about 6 wt %, about 3 wt % to about 4 wt %, about 4 wt % to about 15 wt %, about 4 wt % to about 12 wt %, about 4 wt % to about 10 wt %, about 4 wt % to about 8 wt %, about 4 wt % to about 6 wt %, about 8 wt % to about 15 wt %, about 8 wt % to about 12 wt %, about 8 wt % to about 10 wt %, about 10 wt % to about 15 wt %, about 10 wt % to about 12 wt %, or about 12 wt % to about 15 wt % ZrO₂, based on the total weight of the glass and/or glass ceramic.

As previously discussed, the glass and glass ceramics disclosed can include non-lithium alkali metal oxides, such as Na₂O, K₂O, or both. As noted above, Li₂O is generally useful for forming various glass-ceramics, but the other non-lithium alkali oxides (e.g., Na₂O, K₂O, or both) tend to decrease glass-ceramic formation and instead form a residual glass phase in the glass-ceramic. These non-lithium alkali metal oxides, as well as ZrO₂, are not incorporated the crystalline phases lithium disilicate (Li₂O₅Si₂) or petalite (LiAlSi₄O₁₀) during ceramming and, thus, remain in the residual glassy phase after the ceram process. Na₂O and K₂O are well known in glass chemistry as “fluxes”, which refer to constituents that reduce the viscosity of glass, such as the residual glass phase. In contrast, alumina (Al₂O₃) and zirconia (ZrO₂) tend to increase the viscosity of glass, such as the residual glass phase. Therefore, after ceramming, as Na₂O, K₂O, and ZrO₂ do not enter the crystalline phases in the glass-ceramics. Part of the Al₂O₃ may also remain in the residual glassy phase. Increasing the concentration of non-lithium alkali metal oxides (i.e., [Na₂O+K₂O]) in the glass ceramic composition, increasing the molar ratio of the non-lithium alkali metal oxides to Al₂O₃, increasing the molar ratio of the non-lithium alkali metal oxides to ZrO₂, or combinations of these can reduce the viscosity of the residual glass phase in the glass ceramic. In addition, increased amounts of [Na₂O+K₂O] and ZrO₂ can increase the concentration of the residual glass phase in the transparent glass-ceramics disclosed herein. Increasing the concentration of the residual glass phase, reducing the viscosity of the residual glass phase, or both in the glass ceramic can enable thermal 3D forming of the glass ceramic after ceramming, as previously discussed herein.

The composition of the residual glass phase may be tailored to control viscosity during crystallization and/or during 3D forming, minimizing deformation or undesirable thermal expansion, or control microstructure properties. In embodiments, the glass or glass ceramic composition can comprise from about 0 wt % to about 10 wt % non-lithium alkali metal oxides based on the total weight of the glass and/or glass ceramic. In embodiments, the glass or glass ceramic composition can comprise from about 1 wt % to about 5 wt % Na₂O, K₂O, or both based on the total weight of the glass and/or glass ceramic. In embodiments, the glass or glass ceramic composition can comprise from 0 wt. % to about 10 wt %, about 0 wt % to about 7 wt %, about 0 wt % to about 5 wt %, 0 wt % to about 4 wt %, 0 wt % to about 3 wt %, 0 wt % to about 2 wt %, 0 wt % to about 1 wt %, greater than 0 wt % to about 10 wt %, greater than 0 wt % to about 7 wt %, greater than 0 wt % to about 5 wt %, greater than 0 wt % to about 4 wt %, greater than 0 wt % to about 3 wt %, greater than 0 wt % to about 2 wt %, greater than 0 wt % to about 1 wt %, about 0.5 wt % to about 10 wt %, about 0.5 wt % to about 7 wt %, about 0.5 wt % to about 5 wt %, about 0.5 wt % to about 4 wt %, about 0.5 wt % to about 3, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt % non-lithium alkali metal oxides, such as Na₂O, K₂O, or combinations thereof, based on the total weight of the glass and/or glass ceramic.

In embodiments, the glass and/or glass ceramic may comprise Na₂O. The glass and/or glass ceramic may comprise from 0 wt. % to about 10 wt %, about 0 wt % to about 7 wt %, about 0 wt % to about 5 wt %, 0 wt % to about 4 wt %, 0 wt % to about 3 wt %, 0 wt % to about 2 wt %, 0 wt % to about 1 wt %, about 0.5 wt % to about 10 wt %, about 0.5 wt % to about 7 wt %, about 0.5 wt % to about 5 wt %, about 0.5 wt % to about 4 wt %, about 0.5 wt % to about 3, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt % Na₂O based on the total weight of the glass and/or glass ceramic.

In embodiments, the glass and/or glass ceramic may comprise K₂O. The glass and/or glass ceramic may comprise from 0 wt. % to about 10 wt %, about 0 wt % to about 7 wt %, about 0 wt % to about 5 wt %, 0 wt % to about 4 wt %, 0 wt % to about 3 wt %, 0 wt % to about 2 wt %, 0 wt % to about 1 wt %, about 0.5 wt % to about 10 wt %, about 0.5 wt % to about 7 wt %, about 0.5 wt % to about 5 wt %, about 0.5 wt % to about 4 wt %, about 0.5 wt % to about 3, about 0.5 wt % to about 2 wt %, about 0.5 wt % to about 1 wt %, about 1 wt % to about 5 wt %, about 1 wt % to about 4 wt %, about 1 wt % to about 3 wt %, about 1 wt % to about 2 wt %, about 2 wt % to about 5 wt %, about 2 wt % to about 4 wt %, about 2 wt % to about 3 wt %, about 3 wt % to about 5 wt %, about 3 wt % to about 4 wt %, or about 4 wt % to about 5 wt % Na₂O based on the total weight of the glass and/or glass ceramic.

In addition to non-lithium alkali metal oxides, alkaline earth metal oxides and some transition metal oxides can also be included in the glass and glass ceramic compositions and may partition into the residual glass phase Alkaline earth metal oxides can include CaO, MgO, SrO, BaO, or combinations of these. Transition metal oxides that can be incorporated into the glass and/or glass ceramics disclosed herein can include zinc oxide (ZnO). As used herein, the term “RO” refers to one or more of ZnO, CaO, MgO, SrO, BaO, or combinations thereof. ZnO, CaO, MgO, SrO, BaO, or combinations of these can be added to the glass ceramic composition to increase the concentration or the residual glass phase, reduce the viscosity of the residual glass phase, or combination of these. The concentration of residual glass phase can be increased, the viscosity of the residual glass phase can be reduced, or both by increasing the concentration of RO (i.e., ZnO, CaO, MgO, BaO, SrO, or combinations of these), increasing a molar ratio of RO to Al₂O₃ (i.e., [RO]/[Al₂O₃]), increasing a molar ratio of RO to ZrO₂ (i.e., [RO]/[ZrO₂]), or combinations of these. Increasing the concentration of the residual glass phase and/or reducing the viscosity of the residual glass phase through modifying the amount of RO in the glass ceramic composition can enable the 3D forming of the glass ceramics, after ceramming, to produce the glass ceramic articles disclosed herein. In embodiments, the glass and/or glass ceramic composition can comprise ZnO and one or more alkaline earth metal oxide selected from the group consisting of CaO, MgO, BaO, SrO, and combinations thereof.

In embodiments, the glass and/or glass ceramic compositions can include ZnO. In embodiments, the glass or glass ceramic composition can comprise from 0 wt % to about 10 wt % ZnO, based on the total weight of the glass or glass ceramic. In embodiments, the glass or glass ceramic composition can comprise from 0 wt % to about 10 wt %, 0 wt % to about 9 wt %, 0 wt % to about 8 wt %, 0 wt % to about 7 wt %, 0 wt % to about 6 wt %, 0 wt % to about 5 wt %, 0 wt % to about 4 wt %, 0 wt % to about 3 wt %, 0 wt % to about 2 wt %, 0 wt % to about 1 wt %, about 1 wt % to about 10 wt %, about 1 wt % to about 9 wt %, about 1 wt % to about 8 wt %, about 1 wt % to about 7 wt %, about 1 wt % to about 6 wt %, about 1 wt % to about 5 wt %, about 1 wt % to about 4 wt %, about 1 wt % to about 3 wt %, about 1 wt % to about 2 wt %, about 2 wt % to about 10 wt %, about 2 wt % to about 9 wt %, about 2 wt % to about 8 wt %, about 2 wt % to about 7 wt %, about 2 wt % to about 6 wt %, about 2 wt % to about 5 wt %, about 2 wt % to about 4 wt %, about 2 wt % to about 3 wt %, about 3 wt % to about 10 wt %, about 3 wt % to about 9 wt %, about 3 wt % to about 8 wt %, about 3 wt % to about 7 wt %, about 3 wt % to about 6 wt %, about 3 wt % to about 5 wt %, about 3 wt % to about 4 wt %, about 4 wt % to about 10 wt %, about 4 wt % to about 9 wt %, about 4 wt % to about 8 wt %, about 4 wt % to about 7 wt %, about 4 wt % to about 6 wt %, about 4 wt % to about 5 wt %, about 5 wt % to about 10 wt %, about 5 wt % to about 9 wt %, about 5 wt % to about 8 wt %, about 5 wt % to about 7 wt %, about 5 wt % to about 6 wt %, about 6 wt % to about 10 wt %, about 6 wt % to about 9 wt %, about 6 wt % to about 8 wt %, about 6 wt % to about 7 wt %, about 7 wt % to about 10 wt %, about 7 wt % to about 9 wt %, about 7 wt % to about 8 wt %, about 8 wt % to about 10 wt %, about 8 wt % to about 9 wt %, or about 9 wt % to about 10 wt % ZnO, based on the total weight of the glass and/or glass ceramic.

In embodiments, the glass or glass-ceramic composition can comprise from 0 wt % to about 8 wt % MgO, based on the total weight of the glass and/or glass composition. In embodiments, the glass or glass-ceramic composition can comprise from 0 wt % to about 7 wt %, 0 wt % to about 6 wt %, 0 wt % to about 5 wt %, 0 wt % to about 4 wt %, 0 wt % to about 3 wt %, 0 wt % to about 2 wt %, 0 wt % to about 1 wt %, 0 wt % to about 0.5 wt %, about 0.01 wt % to about 8 wt %, about 0.01 wt % to about 6 wt %, about 0.01 wt % to about 4 wt %, about 0.01 wt % to about 3 wt %, about 0.01 wt % to about 2 wt %, about 0.01 wt % to about 1 wt %, about 0.1 wt % to about 8 wt %, about 0.1 wt % to about 6 wt %, about 0.1 wt % to about 4 wt %, about 0.1 wt % to about 2 wt %, about 0.1 wt % to about 1 wt %, about 1 wt % to about 8 wt %, about 1 wt % to about 6 wt %, about 1 wt % to about 4 wt %, about 1 wt % to about 2 wt %, about 2 wt % to about 8 wt %, about 2 wt % to about 6 wt %, about 2 wt % to about 4 wt %, about 4 wt % to about 8 wt %, about 4 wt % to about 6 wt %, or about 6 wt % to about 8 wt % MgO based on the total weight of the glass and/or glass ceramic.

In embodiments, the glass or glass-ceramic composition can comprise from 0 wt % to about 8 wt % CaO, based on the total weight of the glass and/or glass composition. In embodiments, the glass or glass-ceramic composition can comprise from 0 wt % to about 7 wt %, 0 wt % to about 6 wt %, 0 wt % to about 5 wt %, 0 wt % to about 4 wt %, 0 wt % to about 3 wt %, 0 wt % to about 2 wt %, 0 wt % to about 1 wt %, 0 wt % to about 0.5 wt %, about 0.01 wt % to about 8 wt %, about 0.01 wt % to about 6 wt %, about 0.01 wt % to about 4 wt %, about 0.01 wt % to about 3 wt %, about 0.01 wt % to about 2 wt %, about 0.01 wt % to about 1 wt %, about 0.1 wt % to about 8 wt %, about 0.1 wt % to about 6 wt %, about 0.1 wt % to about 4 wt %, about 0.1 wt % to about 2 wt %, about 0.1 wt % to about 1 wt %, about 1 wt % to about 8 wt %, about 1 wt % to about 6 wt %, about 1 wt % to about 4 wt %, about 1 wt % to about 2 wt %, about 2 wt % to about 8 wt %, about 2 wt % to about 6 wt %, about 2 wt % to about 4 wt %, about 4 wt % to about 8 wt %, about 4 wt % to about 6 wt %, or about 6 wt % to about 8 wt % CaO, based on the total weight of the glass and/or glass ceramic.

In embodiments, the glass or glass-ceramic composition can comprise from 0 wt % to about 8 wt % SrO, based on the total weight of the glass and/or glass composition. In embodiments, the glass or glass-ceramic composition can comprise from 0 wt % to about 7 wt %, 0 wt % to about 6 wt %, 0 wt % to about 5 wt %, 0 wt % to about 4 wt %, 0 wt % to about 3 wt %, 0 wt % to about 2 wt %, 0 wt % to about 1 wt %, 0 wt % to about 0.5 wt %, about 0.01 wt % to about 8 wt %, about 0.01 wt % to about 6 wt %, about 0.01 wt % to about 4 wt %, about 0.01 wt % to about 3 wt %, about 0.01 wt % to about 2 wt %, about 0.01 wt % to about 1 wt %, about 0.1 wt % to about 8 wt %, about 0.1 wt % to about 6 wt %, about 0.1 wt % to about 4 wt %, about 0.1 wt % to about 2 wt %, about 0.1 wt % to about 1 wt %, about 1 wt % to about 8 wt %, about 1 wt % to about 6 wt %, about 1 wt % to about 4 wt %, about 1 wt % to about 2 wt %, about 2 wt % to about 8 wt %, about 2 wt % to about 6 wt %, about 2 wt % to about 4 wt %, about 4 wt % to about 8 wt %, about 4 wt % to about 6 wt %, or about 6 wt % to about 8 wt % SrO based on the total weight of the glass and/or glass ceramic.

In embodiments, the glass or glass-ceramic composition can comprise from 0 wt % to about 8 wt % BaO, based on the total weight of the glass and/or glass composition. In embodiments, the glass or glass-ceramic composition can comprise from 0 wt % to about 7 wt %, 0 wt % to about 6 wt %, 0 wt % to about 5 wt %, 0 wt % to about 4 wt %, 0 wt % to about 3 wt %, 0 wt % to about 2 wt %, 0 wt % to about 1 wt %, 0 wt % to about 0.5 wt %, about 0.01 wt % to about 8 wt %, about 0.01 wt % to about 6 wt %, about 0.01 wt % to about 4 wt %, about 0.01 wt % to about 3 wt %, about 0.01 wt % to about 2 wt %, about 0.01 wt % to about 1 wt %, about 0.1 wt % to about 8 wt %, about 0.1 wt % to about 6 wt %, about 0.1 wt % to about 4 wt %, about 0.1 wt % to about 2 wt %, about 0.1 wt % to about 1 wt %, about 1 wt % to about 8 wt %, about 1 wt % to about 6 wt %, about 1 wt % to about 4 wt %, about 1 wt % to about 2 wt %, about 2 wt % to about 8 wt %, about 2 wt % to about 6 wt %, about 2 wt % to about 4 wt %, about 4 wt % to about 8 wt %, about 4 wt % to about 6 wt %, or about 6 wt % to about 8 wt % BaO based on the total weight of the glass and/or glass ceramic.

In embodiments, the glass or glass ceramic compositions can include boron. In embodiments, the glass and/or glass ceramic compositions can include B₂O₃. B₂O₃ may reduce a melt temperature of the residual glass phase of the glass ceramic. B₂O₃ may also be added to reduce the viscosity of the residual glass phase. In embodiments, the glass or glass ceramic composition may comprise from 0 wt % to about 10 wt % or from 0 wt % to about 2 wt % B₂O₃, based on the total weight of the glass and/or glass ceramic composition. In embodiments, the glass or glass ceramic composition may comprise from 0 wt % to about 9 wt %, 0 wt % to about 8 wt %, 0 wt % to about 7 wt %, 0 wt % to about 6 wt %, 0 wt % to about 5 wt %, 0 wt % to about 4 wt %, 0 wt % to about 3 wt %, 0 wt % to about 2 wt %, 0 wt % to about 1 wt %, >0 wt % to about 10 wt %, >0 wt % to about 9 wt %, >0 wt % to about 8 wt %, >0 wt % to about 7 wt %, >0 wt % to about 6 wt %, >0 wt % to about 5 wt %, >0 wt % to about 4 wt %, >0 wt % to about 3 wt %, >0 wt % to about 2 wt %, >0 wt % to about 1 wt %, about 1 wt % to about 10 wt %, about 1 wt % to about 8 wt %, about 1 wt % to about 6 wt %, about 1 wt % to about 5 wt %, about 1 wt % to about 4 wt %, about 1 wt % to about 2 wt %, about 2 wt % to about 10 wt %, about 2 wt % to about 8 wt %, about 2 wt % to about 6 wt %, about 2 wt % to about 4 wt %, about 3 wt % to about 10 wt %, about 3 wt % to about 8 wt %, about 3 wt % to about 6 wt %, about 3 wt % to about 4 wt %, about 4 wt % to about 5 wt %, about 5 wt % to about 8 wt %, about 5 wt % to about 7.5 wt %, about 5 wt % to about 6 wt %, or about 5 wt % to about 5.5 wt % B₂O₃, based on the total weight of the glass and/or glass ceramic.

In embodiments, the glass or glass ceramic compositions may further include one or more constituents, such as, by way of example and not limitation, TiO₂, CeO₂, HfO₂, Fe₂O₃, SnO₂, or combinations of these. Additionally or alternatively, antimicrobial components may be added to the glass or glass ceramic composition. Antimicrobial components that may be added to the glass or glass ceramic may include, but are not limited to, Ag, AgO, Cu, CuO, Cu₂O, and the like. In some embodiments, the glass or glass ceramic composition may further include a chemical fining agent. Such fining agents include, but are not limited to, SnO₂, As₂O₃, Sb₂O₃, F, Cl, and Br. Additional details on other additives or constituents of the glass and/or glass ceramic compositions suitable for use in various embodiments may be found in, for example, U.S. Patent Application Publication No. 2016/0102010 entitled “High Strength Glass-Ceramics Having Petalite and Lithium Silicate Structures,” filed Oct. 8, 2015, which is incorporated by reference herein in its entirety.

In embodiments, the glass and/or glass ceramic compositions may include one or more of Fe₂O₃, SnO₂, HfO₂, TiO₂, or combinations of these. In embodiments, the glasses and/or glass ceramics disclosed herein can comprise from 0 to about 0.5 wt % SnO₂, based on the total weight of the glass and/or glass ceramic. In embodiments, the glass or glass ceramic composition can comprise from 0 to about 1 wt %, 0 to about 0.5 wt %, 0 to about 0.4 wt %, 0 to about 0.3 wt %, 0 to about 0.2 wt %, 0 to about 0.1 wt %, about 0.05 wt % to about 1 wt %, about 0.05 wt % to about 0.5 wt %, about 0.05 wt % to about 0.4 wt %, about 0.05 wt % to about 0.3 wt %, about 0.05 wt % to about 0.2 wt %, about 0.05 wt % to about 0.1 wt %, about 0.1 wt % to about 1 wt %, about 0.1 wt % to about 0.5 wt %, about 0.1 wt % to about 0.4 wt %, about 0.1 wt % to about 0.3 wt %, about 0.1 wt % to about 0.2 wt %, about 0.3 wt % to about 1 wt %, about 0.3 to about 0.5 wt %, about 0.3 to about 0.4 wt %, about 0.4 wt % to 1 wt %, or about 0.5 to about 1 wt % SnO₂, based on the total weight of the glass or glass ceramic. In embodiments, the glass or glass ceramic composition can comprise from 0 to about 3 wt %, 0 to about 2 wt %, 0 to about 1 wt %, 0 to about 0.5 wt %, 0 to about 0.1 wt %, about 0.05 wt % to about 3 wt %, about 0.05 wt % to about 2 wt %, about 0.05 wt % to about 1 wt %, about 0.05 wt % to about 0.5 wt %, about 0.05 wt % to about 0.1 wt %, about 0.1 wt % to about 3 wt %, about 0.1 wt % to about 2 wt %, about 0.1 wt % to about 1 wt %, about 0.1 wt % to about 0.5 wt %, about 0.5 wt % to about 3 wt %, about 0.5 wt % to about 2 wt %, about 0.5 wt % to about 1 wt %, about 1 wt % to about 3 wt %, about 1 wt % to about 2 wt %, or about 2 wt % to about 3 wt % HfO₂, based on the total weight of the glass or glass ceramic. In embodiments, the glass or glass ceramic composition can comprise from 0 to about 3 wt %, 0 to about 2 wt %, 0 to about 1 wt %, 0 to about 0.5 wt %, 0 to about 0.1 wt %, about 0.05 wt % to about 3 wt %, about 0.05 wt % to about 2 wt %, about 0.05 wt % to about 1 wt %, about 0.05 wt % to about 0.5 wt %, about 0.05 wt % to about 0.1 wt %, about 0.1 wt % to about 3 wt %, about 0.1 wt % to about 2 wt %, about 0.1 wt % to about 1 wt %, about 0.1 wt % to about 0.5 wt %, about 0.5 wt % to about 3 wt %, about 0.5 wt % to about 2 wt %, about 0.5 wt % to about 1 wt %, about 1 wt % to about 3 wt %, about 1 wt % to about 2 wt %, or about 2 wt % to about 3 wt % Fe₂O₃, based on the total weight of the glass or glass ceramic. In embodiments, the glasses or glass ceramics disclosed herein can comprise from 0 to about 5 wt % TiO₂, based on the total weight of the glass or glass ceramic. In embodiments, the glass or glass ceramic composition can comprise from 0 to about 5 wt %, 0 to about 4 wt %, 0 to about 3 wt %, 0 to about 2 wt %, 0 to about 1 wt %, about 1 to about 5 wt %, about 1 to about 4 wt %, about 1 to about 3 wt %, about 1 to about 2 wt %, about 2 to about 5 wt %, about 2 to about 4 wt %, about 2 to about 3 wt %, about 3 to about 5 wt %, about 3 to about 4 wt %, or about 4 to about 5 wt % TiO₂, based on the total weight of the glass or glass ceramic composition.

Compositions in Mole Percent

In embodiments, the glass or glass ceramic compositions may be expressed in mole percent (mol %) rather than wt % as described above. As previously discussed, the glass or glass ceramic compositions may include SiO₂, Al₂O₃, LiO₂, ZrO₂, and P₂O₅. Additionally, the glass or glass ceramic compositions may include one or more non-lithium alkali metal oxides (e.g., Na₂O, K₂O, or both), one or more alkaline earth metal oxides (e.g., CaO, MgO, SrO, BaO, or combinations of these), one or more transition metal oxides (e.g., ZnO), or combinations thereof.

In embodiments, the glass or glass ceramic compositions comprise from about 55 mol % to about 80 mol % SiO₂, based on the total moles of the glass or glass ceramic composition. In embodiments, the glass or glass ceramic compositions may comprise from about 55 mol % to about 72 mol %, about 55 mol % to about 71 mol %, about 55 mol % to about 70 mol %, about 60 mol % to about 80 mol %, about 60 mol % to about 72 mol %, about 60 mol % to about 71 mol %, about 60 mol % to about 70 mol %, about 65 mol % to about 80 mol %, about 65 mol % to about 72 mol %, about 65 mol % to about 71 mol %, about 65 mol % to about 70 mol %, about 68 mol % to about 80 mol %, about 68 mol % to about 72 mol %, about 68 mol % to about 71 mol %, about 68 mol % to 70 mol %, about 70 mol % to about 80 mol %, about 70 mol % to about 72 mol %, or about 71 mol % to about 80 mol % SiO₂ based on the total moles of the glass or glass ceramic composition. In embodiments, the glass or glass ceramic composition may comprise from 68.2 mol % to about 70.4 mol % SiO₂ base don the total moles of the glass or glass ceramic compositions.

In embodiments, the glass or glass ceramic compositions may comprise from about 0 to about 15 mol % Al₂O₃, based on the total moles of the glass or glass ceramic compositions. In embodiments, glass or glass ceramic compositions may comprise from 0 mol % to about 6 mol %, 0 mol % to about 5 mol %, 0 mol % to about 4.5 mol %, from greater than 0 mol % to about 15 mol %, from greater than 0 mol % to about 6 mol %, from greater than 0 mol % to about 5 mol %, from greater than 0 mol % to about 4.5 mol %, from about 0.01 mol % to about 15 mol %, from about 0.01 mol % to about 6 mol %, from about 0.01 mol % to about 5 mol %, from about 0.01 mol % to about 4.5 mol %, from about 1 mol % to about 15 mol %, from about 1 mol % to about 6 mol %, from about 1 mol % to about 5 mol %, from about 1 mol % to about 4.5 mol %, from about 3 mol % to about 15 mol %, from about 3 mol % to about 6 mol %, from about 3 mol % to about 5 mol %, from about 3 mol % to about 4.5 mol %, from about 3.5 mol % to about 15 mol %, from about 3.5 mol % to about 6 mol %, from about 3.5 mol % to about 5 mol %, from about 3.5 mol % to about 4.5 mol %, from about 4.5 mol % to about 15 mol %, from about 4.5 mol % to about 6 mol %, from about 4.5 mol % to about 5 mol %, from about 5 mol % to about 15 mol %, or from about 5 mol % to about 6 mol % Al₂O₃, based on the total moles of the glass or glass ceramic compostions.

In embodiments, the glass or glass ceramic composition may comprise from about 10 to about 40 mol % Li₂O, based on the total moles of the glass or glass ceramic compositions. In embodiments, the glass or glass ceramic composition may comprise from about 10 mol % to about 32 mol %, from about 10 mol % to about 27 mol %, from about 10 mol % to about 25 mol %, from about 10 mol % to about 23 mol %, from about 18 mol % to about 40 mol %, from about 18 mol % to about 32 mol %, from about 18 mol % to about 27 mol %, from about 18 mol % to about 25 mol %, from about 18 mol % to about 23 mol %, from about 20 mol % to about 40 mol %, from about 20 mol % to about 32 mol %, from about 20 mol % to about 27 mol %, from about 20 mol % to about 25 mol %, from about 20 mol % to about 23 mol %, from about 23 mol % to about 40 mol %, from about 23 mol % to about 32 mol %, from about 23 mol % to about 27 mol %, from about 23 mol % to about 25 mol %, from about 25 mol % to about 40 mol %, from about 25 mol % to about 32 mol %, from about 25 mol % to about 27 mol %, from about 27 mol % to about 40 mol %, from about 27 mol % to about 32 mol %, or from about 32 mol % to about 40 mol % Li₂O, based on the total moles of the glass or glass ceramic compositions.

The glass and glass-ceramic compositions can include P₂O₅. P₂O₅ can function as a nucleating agent to produce bulk nucleation. If the concentration of P₂O₅ is too low, the precursor glass does crystallize, but only at higher temperatures (due to a lower viscosity) and from the surface inward, yielding a weak and often deformed body; however, if the concentration of P₂O₅ is too high, the devitrification, upon cooling during precursor glass forming, can be difficult to control. In embodiments, the glass or glass ceramic compositions disclose herein can include from about 0.2 mol % to about 4.0 mol % P₂O₅, based on the total moles of the glass or glass ceramic compositions. In embodiments, the glass or glass ceramic compositions may comprise from about 0.2 mol % to about 2.2 mol %, from about 0.2 mol % to about 1.0 mol %, from about 0.6 mol % to about 4 mol %, from about 0.6 mol % to about 2.2 mol %, from about 0.6 mol % to about 1.0 mol %, from about 0.7 mol % to about 4 mol %, from about 0.7 mol % to about 2.2 mol %, from about 0.7 mol % to about 1.0 mol %, from about 0.8 mol % to about 4 mol %, from about 0.8 mol % to about 2.2 mol %, from about 0.8 mol % to about 1.0 mol %, from about 1.0 mol % to about 4 mol %, from about 1.0 mol % to about 2.2 mol %, or from about 2.2 mol % to about 4 mol % P₂O₅, based on the total moles of the glass or glass ceramic compositions.

In the glass and glass-ceramics disclosed herein, it is generally found that ZrO₂ can improve the stability of Li₂O—Al₂O₃—SiO₂—P₂O₅ glass by significantly reducing glass devitrification during forming and lowering liquidus temperature. The addition of ZrO₂ can also help decrease the grain size of the crystals, which aids in the formation of a transparent glass-ceramic. In embodiments, the glass or glass ceramic compositions may comprise from about 0.1 mol % to about 10 mol % ZrO₂, based on the total weight of the glass or glass ceramic compositions. In embodiments, the glass or glass ceramic composition may comprise from about 0.1 mol % to about 5 mol %, from about 0.1 mol % to 4 mol %, from about 0.1 mol % to about 3.5 mol %, from about 0.1 mol % to about 3 mol %, from about 1 mol % to about 10 mol %, from about 1 mol % to about 5 mol %, from about 1 mol % to 4 mol %, from about 1 mol % to about 3.5 mol %, from about 1 mol % to about 3 mol %, from about 1.5 mol % to about 10 mol %, from about 1.5 mol % to about 5 mol %, from about 1.5 mol % to 4 mol %, from about 1.5 mol % to about 3.5 mol %, from about 1.5 mol % to about 3 mol %, from about 1.6 mol % to about 10 mol %, from about 1.6 mol % to about 5 mol %, from about 1.6 mol % to 4 mol %, from about 1.6 mol % to about 3.5 mol %, from about 1.6 mol % to about 3 mol %, from about 1.7 mol % to about 10 mol %, from about 1.7 mol % to about 5 mol %, from about 1.7 mol % to 4 mol %, from about 1.7 mol % to about 3.5 mol %, from about 1.7 mol % to about 3 mol %, from about 2 mol % to about 10 mol %, from about 2 mol % to about 5 mol %, from about 2 mol % to 4 mol %, from about 2 mol % to about 3.5 mol %, from about 2 mol % to about 3 mol %, from about 3 mol % to about 10 mol %, from about 3 mol % to about 5 mol %, from about 3 mol % to 4 mol %, from about 3 mol % to about 3.5 mol %, from about 3.5 mol % to about 10 mol %, from about 3.5 mol % to about 5 mol %, from about 3.5 mol % to 4 mol %, from about 4 mol % to about 10 mol %, from about 4 mol % to about 5 mol %, or from about 5 mol % to 10 mol % ZrO₂, based on the total moles of the glass or glass ceramic composition.

As previously discussed, the glass and glass ceramics disclosed can include non-lithium alkali metal oxides, such as Na₂O, K₂O, or both. Non-lithium alkali oxides (e.g., Na₂O, K₂O, or both) tend to decrease glass-ceramic formation and instead form a residual glass phase in the glass-ceramic. Non-lithium alkali metal oxides, as well as ZrO₂, are not incorporated the crystalline phases lithium disilicate (Li₂O₅Si₂) or petalite (LiAlSi₄O₁₀) during ceramming and, thus, remain in the residual glassy phase after the ceram process. Na₂O and K₂O are well known in glass chemistry as “fluxes”, which refer to constituents that reduce the viscosity of glass, such as the residual glass phase. The glass or glass ceramic compositions can have a concentration of non-lithium alkali metal oxides sufficient to increase the concentration of residual glass phase in the glass ceramic, reduce a viscosity of the residual glass phase in the glass ceramic, or both. In embodiments, the glass or glass ceramic composition may have greater than or equal to 0 mol %, greater than or equal to about 0.5 mol %, or even greater than or equal to about 1.3 mol % Na₂O, K₂O, or both based on the total moles of the glass or glass ceramic composition. In embodiments, the glass or glass ceramic compostions may comprises from 0 mol % (zero mol %) to about 9 mol % total non-lithium alkali metal oxides based on the total moles of the glass or glass ceramic composition. In embodiments, the glass or glass ceramic composition may comprise from 0 mol % to about 8 mol %, from 0 mol % to about 7 mol %, from 0 mol % to about 6 mol %, from 0 mol % to about 5 mol %, from about 0.5 mol % to about 9 mol %, from about 0.5 mol % to about 8 mol %, from about 0.5 mol % to about 7 mol %, from about 0.5 mol % to about 6 mol %, from about 0.5 mol % to about 5 mol %, from about 1.3 mol % to about 9 mol %, from about 1.3 mol % to about 8 mol %, from about 1.3 mol % to about 7 mol %, from about 1.3 mol % to about 6 mol %, from about 1.3 mol % to about 5 mol %, from about 1.3 mol % to about 3 mol %, or from about 5 mol % to about 9 mol % non-lithium alkali metal oxides, based on the total moles of the glass or glass ceramic composition. In embodiments, the glass or glass ceramic compositions may comprise from 0.5 mol % to 9 mol % non-lithium alkali metal oxides based on the total moles of the glass or glass compositions, where the non-lithium alkali metal oxides comprise Na₂O, K₂O, or combinations of these.

In embodiments, the glass or glass ceramic composition may comprise Na₂O. In embodiments, the glass or glass ceramic compositions may comprise from 0 mol % to about 5 mol % Na₂O based on the total moles of the glass or glass ceramic composition. In embodiments, the glass or glass ceramic compositions may comprise from 0 mol % to about 4 mol %, from 0 mol % to about 3 mol %, from 0 mol % to about 2 mol %, from about 0.5 mol % to about 5 mol %, from about 0.5 mol % to about 4 mol %, from about 0.5 mol % to about 3 mol %, from about 0.5 mol % to about 2 mol %, from about 1 mol % to about 5 mol %, from about 1 mol % to about 4 mol %, from about 1 mol % to about 3 mol %, from about 1 mol % to about 2 mol %, from about 1.3 mol % to about 5 mol %, from about 1.3 mol % to about 4 mol %, from about 1.3 mol % to about 3 mol %, from about 1.3 mol % to about 2 mol %, from about 2 mol % to about 5 mol %, from about 2 mol % to about 4 mol %, from about 2 mol % to about 3 mol %, from about 3 mol % to about 5 mol %, from about 3 mol % to about 4 mol %, or from about 4 mol % to about 5 mol % Na₂O, based on the total moles of the glass or glass ceramic composition.

In embodiments, the glass or glass ceramic composition may comprise K₂O. In embodiments, the glass or glass ceramic compositions may comprise from 0 mol % to about 4 mol % K₂O based on the total moles of the glass or glass ceramic composition. In embodiments, the glass or glass ceramic compositions may comprise from 0 mol % to about 3 mol %, from 0 mol % to about 2 mol %, from 0 mol % to about 1.5 mol %, from 0 mol % to 1.2 mol %, from about 0.5 mol % to about 4 mol %, from about 0.5 mol % to about 3 mol %, from about 0.5 mol % to about 2 mol %, from about 0.5 mol % to about 1.5 mol %, from about 0.5 mol % to about 1.2 mol %, from about 1 mol % to about 4 mol %, from about 1 mol % to about 3 mol %, from about 1 mol % to about 2 mol %, from about 1 mol % to about 1.5 mol %, from about 1.2 mol % to about 4 mol %, from about 1.2 mol % to about 3 mol %, from about 1.2 mol % to about 2 mol %, from about 1.2 mol % to about 1.5 mol %, from about 1.5 mol % to about 4 mol %, from about 1.5 mol % to about 3 mol %, from about 1.5 mol % to about 2 mol %, from about 2 mol % to about 4 mol %, from about 2 mol % to about 3 mol %, or from about 3 mol % to about 4 mol % K₂O, based on the total moles of the glass or glass ceramic composition.

As previously discussed, addition of Na₂O and K₂O may tend to decrease the viscosity of the residual glass phase. In contrast, alumina (Al₂O₃) and zirconia (ZrO₂) tend to increase the viscosity of glass, such as the residual glass phase. After ceramming, Na₂O, K₂O, and ZrO₂ do not enter the crystalline phases in the glass-ceramics. Part of the Al₂O₃ may also remain in the residual glassy phase. Thus, increasing a molar ratio of the non-lithium alkali metal oxides to Al₂O₃, ZrO₂, or both can decrease the viscosity of the residual glass phase, which can make it easier to thermally form the glass ceramic in the 3D shape during the 3D forming step.

In embodiments, the glass or glass ceramic composition may have a molar ratio of total non-lithium alkali metal oxides ([Na₂O+K₂O]) to Al₂O₃ sufficient for the cerammed glass ceramic to be 3D formable without breaking the glass ceramic. In embodiments, the glass or glass ceramic composition may have a molar ratio of [Na₂O+K₂O]/[Al₂O₃] of greater than or equal to about 0.1, greater than or equal to about 0.3, or even greater than or equal to about 0.5. In embodiments, the glass or glass ceramic composition may have a molar ratio of [Na₂O+K₂O]/[Al₂O₃] of from about 0.1 to about 5, from about 0.1 to about 4, from about 0.1 to about 3, from about 0.1 to about 2, from about 0.1 to about 1, from about 0.3 to about 5, from about 0.3 to about 4, from about 0.3 to about 3, from about 0.3 to about 2, from about 0.3 to about 1, from about 0.5 to about 5, from about 0.5 to about 4, from about 0.5 to about 3, from about 0.5 to about 2, from about 0.5 to about 1, from about 1 to about 5, from about 1 to about 4, from about 1 to about 3, from about 1 to about 2, from about 2 to about 5, from about 2 to about 4, from about 2 to about 3, from about 3 to about 5, or from about 3 to about 4.

In embodiments, the glass or glass ceramic composition may have a molar ratio of total non-lithium alkali metal oxides ([Na₂O+K₂O]) to ZrO₂ sufficient for the cerammed glass ceramic to be 3D formable without breaking the glass ceramic. In embodiments, the glass or glass ceramic composition may have a molar ratio of [Na₂O+K₂O]/[ZrO₂] of greater than or equal to about 0.3, greater than or equal to about 0.4, greater than or equal to about 0.5, or even greater than or equal to about 0.6. In embodiments, the glass or glass ceramic composition may have a molar ratio of [Na₂O+K₂O]/[ZrO₂] of from about 0.3 to about 5, from about 0.3 to about 4, from about 0.3 to about 3, from about 0.3 to about 2, from about 0.3 to about 1, from about 0.4 to about 5, from about 0.4 to about 4, from about 0.4 to about 3, from about 0.4 to about 2, from about 0.4 to about 1, from about 0.5 to about 5, from about 0.5 to about 4, from about 0.5 to about 3, from about 0.5 to about 2, from about 0.5 to about 1, from about 0.6 to about 5, from about 0.6 to about 4, from about 0.6 to about 3, from about 0.6 to about 2, from about 0.6 to about 1, from about 1 to about 5, from about 1 to about 4, from about 1 to about 3, from about 1 to about 2, from about 2 to about 5, from about 2 to about 4, from about 2 to about 3, from about 3 to about 5, or from about 3 to about 4.

Increasing the concentration of non-lithium alkali metal oxides (i.e., [Na₂O+K₂]) in the glass ceramic composition, increasing the molar ratio of the non-lithium alkali metal oxides to Al₂O₃, increasing the molar ratio of the non-lithium alkali metal oxides to ZrO₂, or combinations of these can reduce the viscosity of the residual glass phase in the glass ceramic. In addition, increased amounts of [Na₂O+K₂O] and ZrO₂ can increase the concentration of the residual glass phase in the transparent glass-ceramics disclosed herein. Increasing the concentration of the residual glass phase, reducing the viscosity of the residual glass phase, or both in the glass ceramic can enable thermal 3D forming of the glass ceramic after ceramming, as previously discussed herein.

In addition to non-lithium alkali metal oxides, alkaline earth metal oxides and some transition metal oxides may also be included in the glass and glass ceramic compositions. When included, alkaline earth metal oxides and the transition metal oxides may partition into the residual glass phase. Alkaline earth metal oxides can include CaO, MgO, SrO, BaO, or combinations of these. Transition metal oxides that can be incorporated into the glass and/or glass ceramics disclosed herein can include zinc oxide (ZnO). As used herein, the term “RO” refers to one or more of ZnO, CaO, MgO, SrO, BaO, or combinations thereof. ZnO, CaO, MgO, SrO, BaO, or combinations thereof can be added to the glass ceramic composition to increase the concentration or the residual glass phase, reduce the viscosity of the residual glass phase, or combination of these. In embodiments, the glass or glass ceramic compositions disclosed herein may include one or more of ZnO, CaO, MgO, SrO, BaO, or combinations thereof. The ZnO, CaO, MgO, SrO, BaO, or combinations thereof may be include in addition to or as an alternative to the non-lithium alkali metal oxides. In embodiments, the total concentration of the non-lithium alkali metal oxides may not be sufficient to enable the glass ceramic to be 3D formed after ceramming, such as a total concentration of non-lithium alkali metal oxides less than about 0.5 mol %. When the total concentration of non-lithium alkali metal oxides is less than about 0.5 mol %, the concentration of RO may be increased to increase the concentration and reduce the viscosity of the residual glass phase to enable 3D forming the glass ceramic after ceramming. In embodiments, the RO may be included or the concentration increased even when the concentration of non-alkalie metal oxides is greater than 0.5 mol %.

In embodiments, the glass or glass ceramic composition may have greater than or equal to 0 mol %, greater than or equal to about 0.01 mol %, greater than or equal to about 0.1 mol %, or even greater than or equal to 0.5 mol % total RO based on the total moles of the glass or glass ceramic composition, where RO is ZnO, CaO, MgO, SrO, BaO, or combinations thereof. In embodiments, the glass or glass ceramic compostions may comprises from 0 mol % (zero mol %) to about 10 mol % total total RO based on the total moles of the glass or glass ceramic composition. In embodiments, the glass or glass ceramic composition may comprise from 0 mol % to about 10 mol %, from 0 mol % to about 8 mol %, from 0 mol % to about 6 mol %, from 0 mol % to about 5 mol %, from about 0.01 mol % to about 10 mol %, from about 0.01 mol % to about 8 mol %, from about 0.01 mol % to about 6 mol %, from about 0.01 mol % to about 5 mol %, from about 0.1 mol % to about 10 mol %, from about 0.1 mol % to about 8 mol %, from about 0.1 mol % to about 6 mol %, from about 0.1 mol % to about 5 mol %, from about 0.5 mol % to about 10 mol %, from about 0.5 mol % to about 8 mol %, from about 0.5 mol % to about 6 mol %, or from about 0.5 mol % to about 5 mol % total RO, based on the total moles of the glass or glass ceramic composition. In embodiments, the glass or glass ceramic composition may not include ZnO, MgO, CaO, SrO, BaO, or combinations of these.

In embodiments, the glass or glass ceramic composition may comprise ZnO. In embodiments, the glass or glass ceramic compositions may comprise from 0 mol % to about 8 mol % ZnO based on the total moles of the glass or glass ceramic composition. In embodiments, the glass or glass ceramic compositions may comprise from 0 mol % to about 6 mol %, from 0 mol % to about 5 mol %, from 0 mol % to about 3 mol %, from about 0.001 mol % to about 8 mol %, from about 0.001 mol % to about 6 mol %, from about 0.001 mol % to about 5 mol %, from about 0.001 mol % to about 3 mol %, from about 0.01 mol % to about 8 mol %, from about 0.01 mol % to about 6 mol %, from about 0.01 mol % to about 5 mol %, from about 0.01 mol % to about 3 mol %, from about 0.1 mol % to about 8 mol %, from about 0.1 mol % to about 6 mol %, from about 0.1 mol % to about 5 mol %, or from about 0.5 mol % to about 3 mol % ZnO, based on the total moles of the glass or glass ceramic composition.

In embodiments, the glass or glass ceramic composition may comprise MgO. In embodiments, the glass or glass ceramic compositions may comprise from 0 mol % to about 8 mol % MgO based on the total moles of the glass or glass ceramic composition. In embodiments, the glass or glass ceramic compositions may comprise from 0 mol % to about 6 mol %, from 0 mol % to about 5 mol %, from 0 mol % to about 3 mol %, from about 0.001 mol % to about 8 mol %, from about 0.001 mol % to about 6 mol %, from about 0.001 mol % to about 5 mol %, from about 0.001 mol % to about 3 mol %, from about 0.01 mol % to about 8 mol %, from about 0.01 mol % to about 6 mol %, from about 0.01 mol % to about 5 mol %, from about 0.01 mol % to about 3 mol %, from about 0.1 mol % to about 8 mol %, from about 0.1 mol % to about 6 mol %, from about 0.1 mol % to about 5 mol %, or from about 0.1 mol % to about 3 mol % MgO, based on the total moles of the glass or glass ceramic composition.

In embodiments, the glass or glass ceramic composition may comprise CaO. In embodiments, the glass or glass ceramic compositions may comprise from 0 mol % to about 8 mol % CaO based on the total moles of the glass or glass ceramic composition. In embodiments, the glass or glass ceramic compositions may comprise from 0 mol % to about 6 mol %, from 0 mol % to about 5 mol %, from 0 mol % to about 3 mol %, from about 0.001 mol % to about 8 mol %, from about 0.001 mol % to about 6 mol %, from about 0.001 mol % to about 5 mol %, from about 0.001 mol % to about 3 mol %, from about 0.01 mol % to about 8 mol %, from about 0.01 mol % to about 6 mol %, from about 0.01 mol % to about 5 mol %, from about 0.01 mol % to about 3 mol %, from about 0.1 mol % to about 8 mol %, from about 0.1 mol % to about 6 mol %, from about 0.1 mol % to about 5 mol %, or from about 0.1 mol % to about 3 mol % CaO, based on the total moles of the glass or glass ceramic composition.

In embodiments, the glass or glass ceramic composition may comprise SrO. In embodiments, the glass or glass ceramic compositions may comprise from 0 mol % to about 8 mol % SrO based on the total moles of the glass or glass ceramic composition. In embodiments, the glass or glass ceramic compositions may comprise from 0 mol % to about 6 mol %, from 0 mol % to about 5 mol %, from 0 mol % to about 3 mol %, from about 0.001 mol % to about 8 mol %, from about 0.001 mol % to about 6 mol %, from about 0.001 mol % to about 5 mol %, from about 0.001 mol % to about 3 mol %, from about 0.01 mol % to about 8 mol %, from about 0.01 mol % to about 6 mol %, from about 0.01 mol % to about 5 mol %, from about 0.01 mol % to about 3 mol %, from about 0.1 mol % to about 8 mol %, from about 0.1 mol % to about 6 mol %, from about 0.1 mol % to about 5 mol %, or from about 0.1 mol % to about 3 mol % SrO, based on the total moles of the glass or glass ceramic composition.

In embodiments, the glass or glass ceramic composition may comprise BaO. In embodiments, the glass or glass ceramic compositions may comprise from 0 mol % to about 8 mol % BaO based on the total moles of the glass or glass ceramic composition. In embodiments, the glass or glass ceramic compositions may comprise from 0 mol % to about 6 mol %, from 0 mol % to about 5 mol %, from 0 mol % to about 3 mol %, from about 0.001 mol % to about 8 mol %, from about 0.001 mol % to about 6 mol %, from about 0.001 mol % to about 5 mol %, from about 0.001 mol % to about 3 mol %, from about 0.01 mol % to about 8 mol %, from about 0.01 mol % to about 6 mol %, from about 0.01 mol % to about 5 mol %, from about 0.01 mol % to about 3 mol %, from about 0.1 mol % to about 8 mol %, from about 0.1 mol % to about 6 mol %, from about 0.1 mol % to about 5 mol %, or from about 0.1 mol % to about 3 mol % BaO, based on the total moles of the glass or glass ceramic composition.

As previously discussed, addition of ZnO and/or alkaline earth metal oxides may tend to increase the concentration of the residual glass phase, decrease the viscosity of the residual glass phase, or both. In contrast, alumina (Al₂O₃) and zirconia (ZrO₂) tend to increase the viscosity of glass, such as the residual glass phase. After ceramming, ZnO, CaO, MgO, BaO, SrO, and ZrO₂ do not enter the crystalline phases in the glass-ceramics. Part of the Al₂O₃ may also remain in the residual glass phase. Thus, increasing a molar ratio of the RO to Al₂O₃, ZrO₂, or both can decrease the viscosity of the residual glass phase, which can make it easier to thermally form the glass ceramic in the 3D shape during 3D forming.

In embodiments, the glass or glass ceramic composition may have a molar ratio of total RO ([ZnO+MgO+CaO+SrO+BaO]) to Al₂O₃ sufficient for the cerammed glass ceramic to be 3D formable without breaking the glass ceramic. In embodiments, the glass or glass ceramic composition may have a molar ratio of [ZnO+MgO+CaO+SrO+BaO]/[Al₂O₃] of greater than or equal to about 0.05, greater than or equal to about 0.1, or even greater than or equal to about 0.3. In embodiments, the glass or glass ceramic composition may have a molar ratio of [ZnO+MgO+CaO+SrO+BaO]/[Al₂O₃] of from about 0.05 to about 5, from about 0.05 to about 4, from about 0.05 to about 3, from about 0.05 to about 2, from about 0.05 to about 1, from about 0.1 to about 5, from about 0.1 to about 4, from about 0.1 to about 3, from about 0.1 to about 2, from about 0.1 to about 1, from about 0.3 to about 5, from about 0.3 to about 4, from about 0.3 to about 3, from about 0.3 to about 2, from about 0.3 to about 1, from about 1 to about 5, from about 1 to about 4, from about 1 to about 3, from about 1 to about 2, from about 2 to about 5, from about 2 to about 4, from about 2 to about 3, from about 3 to about 5, or from about 3 to about 4.

In embodiments, the glass or glass ceramic composition may have a molar ratio of total RO ([ZnO+MgO+CaO+SrO+BaO]) to ZrO₂ sufficient for the cerammed glass ceramic to be 3D formable without breaking the glass ceramic. In embodiments, the glass or glass ceramic composition may have a molar ratio of [ZnO+MgO+CaO+SrO+BaO]/[ZrO₂] of greater than or equal to about 0.1, greater than or equal to about 0.3, or even greater than or equal to about 0.5. In embodiments, the glass or glass ceramic composition may have a molar ratio of [ZnO+MgO+CaO+SrO+BaO]/[ZrO₂] of from about 0.1 to about 5, from about 0.1 to about 4, from about 0.1 to about 3, from about 0.1 to about 2, from about 0.1 to about 1, from about 0.3 to about 5, from about 0.3 to about 4, from about 0.3 to about 3, from about 0.3 to about 2, from about 0.3 to about 1, from about 0.5 to about 5, from about 0.5 to about 4, from about 0.5 to about 3, from about 0.5 to about 2, from about 0.5 to about 1, from about 1 to about 5, from about 1 to about 4, from about 1 to about 3, from about 1 to about 2, from about 2 to about 5, from about 2 to about 4, from about 2 to about 3, from about 3 to about 5, or from about 3 to about 4.

The concentration of residual glass phase can be increased, the viscosity of the residual glass phase can be reduced, or both by increasing the concentration of RO (i.e., ZnO, CaO, MgO, BaO, SrO, or combinations of these), increasing a molar ratio of RO to Al₂O₃ (i.e., [RO]/[Al₂O₃]), increasing a molar ratio of RO to ZrO₂ (i.e., [RO]/[ZrO₂]), or combinations of these. Increasing the concentration of the residual glass phase and/or reducing the viscosity of the residual glass phase through modifying the amount of RO in the glass ceramic composition can enable the 3D forming of the glass ceramics, after ceramming, to produce the glass ceramic articles disclosed herein. In embodiments, the glass and/or glass ceramic composition can comprise ZnO and one or more alkaline earth metal oxide selected from the group consisting of CaO, MgO, BaO, SrO, and combinations thereof.

In embodiments, the glass or glass ceramic compositions may include B₂O₃. The glass or glass ceramic compositions disclose herein may include from 0 mol % to about 10 mol % B₂O₃ based on the total moles of the glass or glass ceramic composition. In embodiments, the glass or glass ceramic compositions may include from 0 mol % to about 8 mol %, from 0 mol % to about 6 mol %, from 0 mol % to about 5 mol %, from 0 mol % to about 3 mol %, from about 0.01 mol % to about 10 mol %, from about 0.01 mol % to about 8 mol %, from about 0.01 mol % to about 6 mol %, from about 0.01 mol % to about 5 mol %, from about 0.01 mol % to about 3 mol %, from about 0.1 mol % to about 10 mol %, from about 0.1 mol % to about 8 mol %, from about 0.1 mol % to about 6 mol %, from about 0.1 mol % to about 5 mol %, from about 0.1 mol % to about 3 mol %, from about 1 mol % to about 10 mol %, from about 1 mol % to about 8 mol %, from about 1 mol % to about 6 mol %, from about 1 mol % to about 5 mol %, from about 1 mol % to about 3 mol %, from about 3 mol % to about 10 mol %, from about 3 mol % to about 8 mol %, from about 3 mol % to about 6 mol %, from about 3 mol % to about 5 mol %, from about 5 mol % to about 10 mol %, from about 5 mol % to about 8 mol %, or from about 6 mol % to about 10 mol % B₂O₃ based on the total moles of the glass or glass ceramic composition. In embodiments, the glass or glass compositions disclosed herein does not include B₂O₃.

In embodiments, the glasses and/or glass ceramics disclosed herein may comprise from 0 mol % to about 0.5 mol % SnO₂, based on the total moles of the glass or glass ceramic composition. In embodiments, the glass or glass-ceramic composition may comprise from 0 mol % to about 0.4 mol %, from 0 mol % to about 0.3 mol %, from 0 mol % to about 0.2 mol %, from 0 mol % to about 0.1 mol %, from about 0.05 mol % to about 0.5 mol %, from about 0.05 mol % to about 0.4 mol %, from about 0.05 mol % to about 0.3 mol %, from about 0.05 mol % to about 0.2 mol %, from about 0.05 mol % to about 0.1 mol %, from about 0.1 mol % to about 0.5 mol %, from about 0.1 mol % to about 0.4 mol %, from about 0.1 mol % to about 0.3 mol %, from about 0.1 mol % to about 0.2 mol %, from about 0.2 mol % to about 0.5 mol %, from about 0.2 mol % to about 0.4 mol %, from about 0.2 mol % to about 0.3 mol %, from about 0.3 mol % to about 0.5 mol %, from about 0.3 mol % to about 0.4 mol %, from about 0.4 mol % to about 0.5 mol %, and all ranges and subranges there between SnO₂ based on the total moles of the glass or glass ceramic composition. In embodiments, the glass or glass-ceramic composition may comprise about 0, >0, 0.05, 0.1, 0.2, 0.3, 0.4, or 0.5 mol % SnO₂.

In embodiments, the glasses and/or glass ceramics disclosed herein may comprise from 0 mol % to about 0.5 mol % HfO₂. In embodiments, the glass or glass-ceramic composition may comprise from 0 mol % to about 0.4 mol %, from 0 mol % to about 0.3 mol %, from 0 mol % to about 0.2 mol %, from 0 mol % to about 0.1 mol %, from about 0.05 mol % to about 0.5 mol %, from about 0.05 mol % to about 0.4 mol %, from about 0.05 mol % to about 0.3 mol %, from about 0.05 mol % to about 0.2 mol %, from about 0.05 mol % to about 0.1 mol %, from about 0.1 mol % to about 0.5 mol %, from about 0.1 mol % to about 0.4 mol %, from about 0.1 mol % to about 0.3 mol %, from about 0.1 mol % to about 0.2 mol %, from about 0.2 mol % to about 0.5 mol %, from about 0.2 mol % to about 0.4 mol %, from about 0.2 mol % to about 0.3 mol %, from about 0.3 mol % to about 0.5 mol %, from about 0.3 mol % to about 0.4 mol %, from about 0.4 mol % to about 0.5 mol %, and all ranges and subranges there between HfO₂ based on the total moles of the glass or glass ceramic composition. In embodiments, the glass or glass-ceramic composition may comprise about 0, >0, 0.05, 0.1, 0.2, 0.3, 0.4, or 0.5 mol % HfO₂.

In embodiments, the glasses and/or glass ceramic compositions disclosed herein may comprise from 0 mol % to about 0.5 mol % Fe₂O₃, based on the total moles of the glass or glass ceramic composition. In embodiments, the glass or glass-ceramic composition may comprise from 0 mol % to about 0.4 mol %, from 0 mol % to about 0.3 mol %, from 0 mol % to about 0.2 mol %, from 0 mol % to about 0.1 mol %, from about 0.05 mol % to about 0.5 mol %, from about 0.05 mol % to about 0.4 mol %, from about 0.05 mol % to about 0.3 mol %, from about 0.05 mol % to about 0.2 mol %, from about 0.05 mol % to about 0.1 mol %, from about 0.1 mol % to about 0.5 mol %, from about 0.1 mol % to about 0.4 mol %, from about 0.1 mol % to about 0.3 mol %, from about 0.1 mol % to about 0.2 mol %, from about 0.2 mol % to about 0.5 mol %, from about 0.2 mol % to about 0.4 mol %, from about 0.2 mol % to about 0.3 mol %, from about 0.3 mol % to about 0.5 mol %, from about 0.3 mol % to about 0.4 mol %, from about 0.4 mol % to about 0.5 mol %, and all ranges and subranges there between Fe₂O₃ based on the total moles of the glass or glass ceramic composition. When the amount of Fe₂O₃ is too high, the Fe₂O₃ can affect the color of the glass-ceramic and thereby affect the transparency of the glass-ceramic. In some embodiments, the glass and/or glass ceramic composition can comprise less than 0.5 mol %, less than 0.4 mol %, less than 0.3 mol %, less than 0.2 mol %, less than 0.1 mol %, or even less than 0.05 mol % Fe₂O₃ based on the total moles of the glass or glass ceramic composition.

In embodiments, the glasses and/or glass ceramics disclosed herein may comprise from 0 mol % to about 2 mol % TiO₂. In embodiments, the glass or glass-ceramic composition may comprise from 0 mol % to about 1.75 mol %, from 0 mol % to about 1.5 mol %, from 0 mol % to about 1 mol %, from 0 mol % to about 0.8 mol %, from about 0.05 mol % to about 2 mol %, from about 0.05 mol % to about 1.75 mol %, from about 0.05 mol % to about 1.5 mol %, from about 0.05 mol % to about 1 mol %, from about 0.05 mol % to about 0.8 mol %, from about 0.1 mol % to about 2 mol %, from about 0.1 mol % to about 1.75 mol %, from about 0.1 mol % to about 1.5 mol %, from about 0.1 mol % to about 1 mol %, from about 0.1 mol % to about 0.8 mol %, from about 0.5 mol % to about 2 mol %, from about 0.5 mol % to about 1.75 mol %, from about 0.5 mol % to about 1.5 mol %, from about 0.5 mol % to about 1 mol %, from about 0.5 mol % to about 0.8 mol %, from about 0.8 mol % to about 2 mol %, from about 0.8 mol % to about 1.75 mol %, from about 0.8 mol % to about 1.5 mol % from about 0.8 mol % to about 1 mol %, from about 1 mol % to about 2 mol %, from about 1 mol % to about 1.75 mol %, from about 1 mol % to about 1.5 mol %, from about 1.5 mol % to about 2 mol %, and all ranges and subranges there between TiO₂ based on the total moles of the glass or glass ceramic composition.

In embodiments, the glass and/or glass ceramic composition used to prepare the glass ceramic articles disclosed herein may comprise from about 55 mol % to about 80 mol % SiO₂; from about 1 mol % to about 15 mol % Al₂O₃; from about 10 mol % to about 40 mol % Li₂O; from about 0.2 mol % to about 4 mol % P₂O₅; and from about 0.1 mol % to about 10 mol % ZrO₂, based on the total moles of the glass and/or glass ceramic composition. In embodiments, the glass and/or glass ceramic composition used to prepare the glass ceramic articles disclosed herein may comprise from about 68 mol % to about 71 mol % SiO₂, from about 3 mol % to about 5 mol % Al₂O₃, from about 18 mol % to about 25 mol % Li₂O, from about 0.6 mol % to about 1 mol % P₂O₅, and from about 1.5 mol % to about 3 mol % ZrO₂, based on the total moles of the glass and/or glass ceramic composition. In embodiments, the the glass and/or glass ceramic composition used to prepare the glass ceramic articles disclosed herein may comprise from about 68.2 mol % to about 70.4 mol % SiO₂, from about 3.5 mol % to about 4.5 mol % Al₂O₃, from about 20 mol % to about 23 mol % Li₂O, from about 0.8 mol % to about 1 mol % P₂O₅, and from about 1.6 mol % to about 3 mol % ZrO₂, based on the total moles of the glass and/or glass ceramic composition. In embodiments, the glass and/or glass ceramic composition used to prepare the glass ceramic articles disclosed herein may further comprise from about 0.5 mol % to about 5 mol % Na₂O, K₂O, or both, based on the total moles of the glass and/or glass ceramic composition. In embodiments, the glass and/or glass ceramic composition used to prepare the glass ceramic articles disclosed herein may comprise from about 1 mol % to about 4 mol %, or from about 1 mol % to about 2 mol %, Na₂O, K₂O, or both, based on the total moles of the glass and/or glass ceramic composition.

In embodiments, the glass and/or glass ceramic composition used to prepare the glass ceramic articles described herein may comprise, consist of, or consist essentially of from about 55 mol % to about 80 mol % SiO₂; from about 1 mol % to about 15 mol % Al₂O₃; from about 10 mol % to about 40 mol % Li₂O; from about 0.2 mol % to about 4 mol % P₂O₅; from 0 mol % to about 10 mol % B₂O₃; from about 0.1 mol % to about 10 mol % ZrO₂; from 0 mol % to about 5 mol % Na₂O; from 0 mol % to about 4 mol % K₂O; from 0 mol % to about 8 mol % MgO; from 0 mol % to about 8 mol % CaO; from 0 mol % to about 8 mol % SrO; from 0 mol % to about 8 mol % BaO; from 0 mol % to about 8 mol % ZnO; from 0 mol % to about 0.5 mol % Fe₂O₃; from 0 mol % to about 0.5 mol % HfO₂; from 0 mol % to about 0.5 mol % SnO₂; and from 0 mol % to about 2 mol % TiO₂, based on the total moles of the glass and/or glass ceramic composition, wherein a concentration of at least one of Na₂O, K₂O, ZnO, MgO, CaO, SrO, BaO, or combinations thereof is greater than or equal to 0.5 mol %.

In embodiments, the glass and/or glass ceramic composition used to prepare the glass ceramic articles described herein may comprise, consist of, or consist essentially of from about 68 mol % to about 71 mol % SiO₂; from about 3 mol % to about 5 mol % Al₂O₃; from about 18 mol % to about 25 mol % Li₂O; from about 0.6 mol % to about 1 mol % P₂O₅; from about 1.5 mol % to about 3 mol % ZrO₂; from about 0.5 mol % to about 2 mol % Na₂O; from 0 mol % to about 2 mol % K₂O; from 0 mol % to about 1 mol % CaO; from 0 mol % to about 1 mol % ZnO, from 0 mol % to about 1 mol % MgO; from 0 mol % to about 0.1 mol % Fe₂O₃; from 0 mol % to about 0.1 mol % HfO₂; from 0 mol % to about 0.5 mol % SnO₂; and from 0 mol % to about 2 mol % TiO₂, based on the total moles of the glass and/or glass ceramic composition.

In embodiments, the glass compositions can be manufactured into sheets via processes, including but not limited to, slot draw, float, rolling, and other sheet-forming processes known to those skilled in the art. It should also be understood that the compositions disclosed herein—whether in wt % or mol %—are on an oxide basis of the precursor glass or glass ceramic compositions before the ceramming process, unless explicitly states otherwise.

Heating Process to Produce Glass Ceramic Preforms from Precursor Glass

Once the glass composition is prepared and formed into a precursor glass, the precursor glass may then be cerammed to form a glass ceramic preform having one or more crystal phases formed within the glass ceramic preform. Generally, to form the glass-ceramic, a glass stack comprising a plurality of sheets of precursor glass is heated to a temperature above its annealing point for a time sufficient to develop crystal nuclei (also referred to as “nucleation”). The heat treatment can be performed, for example, in a lehr or furnace. After being heated above its annealing point, the precursor glass is then further heated, usually at a higher temperature between the glass annealing point and the glass softening point, to develop the crystal phase (also referred to as “growth” or “crystallization”). In various embodiments, the heat treatment, or ceramming process, includes heating the glass stack comprising the precursor glass to a nucleation temperature, maintaining the nucleation temperature for a predetermined period of time, heating the glass stack comprising the precursor glass to a crystallization temperature, and maintaining the crystallization temperature for a predetermined period of time.

Referring to FIG. 1, one embodiment of a stack configuration 100 for ceramming the precursor glass to produce the glass ceramic is schematically depicted. The stack configuration 100 includes a carrier plate 102 supporting two setter plates 104, and a glass stack 106 positioned between the setter plates 104. In some embodiments, insulation layers (not shown) may be located on the top surface of the upper setter plate 104 and one the bottom surface of the lower setter plate 104. The insulation layers may be formed from any material having a low thermal conductivity and can reduce or even eliminate axial temperature gradients of the glass sheets 108 on the top and bottom of the glass stack 106.

As shown in FIG. 1, the glass stack 106 includes a plurality of glass sheets 108, each glass sheet 108 being separated from an adjacent glass sheet 108 by a parting agent layer 110. The plurality of glass sheets 108 may have a general shape or may be cut into specific preform shapes prior to ceramming. The parting agent layer 110 reduces or even eliminates the sticking of the glass sheets 108 in the glass stack 106 during the ceramming process. Although not depicted in FIG. 1, in some embodiments, the glass stack 106 may further include a parting agent layer 110 between the glass sheet 108 and the setter plate 104. In other embodiments, the setter plate 104 is made from a material that does not react with the glass sheet 108, and a parting agent layer 110 is not required to prevent interactions between the glass sheet 108 and the setter plate 104. Additional embodiments of the stack configuration 100 and features of the stack configuration directed to reducing warp and haze during ceraming can be found in U.S. Pat. No. 11,014,848, granted on May 25, 2021, and entitled “GLASS CERAMIC ARTICLES HAVING IMPROVED PROPERTIES AND METHODS FOR MAKING THE SAME,” the entire contents of which are incorporated by reference herein. Although shown in FIG. 1 as a stack comprising a plurality of glass sheets 108, the glass may also be formed into a block, cerammed, and then cut into pre-form shapes after ceramming.

The processes for making the glass ceramic articles disclosed herein includes ceramming the precursor glass to produce the glass ceramic having one or more crystal phases formed therein. The precursor glass may be a crystallizable glass composition. The ceramming may include heat treating the precursor glasses at one or more preselected temperatures for one or more preselected times to induce glass homogenization and crystallization (i.e., nucleation and growth) of one or more crystalline phases (e.g., having one or more compositions, amounts, morphologies, sizes or size distributions, etc.). In embodiments, the heat treatment may include (i) heating the precursor glasses at a rate of 0.01° C./min to 50° C./min to a nucleation temperature (Tn); (ii) maintaining the precursor glasses at the nucleation temperature for a first predetermined period of time (tN) to produce a nucleated precursor glass; (iii) heating the nucleated precursor glass at a rate in the range from about 0.01° C./min to about 50° C./min to a crystallization temperature (Tc); (iv) maintaining the nucleated crystallizable glasses at the crystallization temperature for a second predetermined period of time (tC) to produce the glass ceramic; and (v) cooling the glass ceramic. The terms “ceram” or “ceramming”, in the preceding embodiments, may be used to refer to steps (iii), (iv), and optionally (v), collectively.

In embodiments, the nucleation temperature Tn can be in a range from about 500° C. to about 650° C., such as about 500° C., about 510° C., about 520° C., about 530° C., about 540° C., about 550° C., about 560° C., about 570° C., about 580° C., about 590° C., about 600° C., about 610° C., about 620° C., about 630° C., about 640° C., or abut 650° C., and all ranges and subranges therebetween. In embodiments, the crystallization temperature Tc can be in a range from about 680° C. to 900° C., from about 680° C. to about 800° C., or from about 700° C. to about 800° C., such as about 680° C., about 690° C., about 700° C., about 710° C., about 720° C., about 730° C., about 740° C., about 750° C., about 760° C., about 770° C., about 780° C., about 790° C., or about 800° C., and all ranges and subranges therebetween.

In embodiments, the first predetermined time for maintaining the nucleation temperature can be in a range from 1 minute to 6 hours, such as but not limited to about 1 minute, about 5 minutes, about 10 minutes, about 20 minutes, about 30 minutes, about 40 minutes, about 50 minutes, about 1 hour, about 1.5 hours, about 2 hours, about 2.5 hours, about 3 hours, about 3.5 hours, about 4 hours, about 4.5 hours, about 5 hours, about 5.5 hours, or about 6 hours, and all ranges and subranges therebetween. In embodiments, the second predetermined time for maintaining the crystallization temperature can be in a range of from 1 minute to 8 hours, such as from 1 minute to 7 hours, or even 1 minute to 4 hours, and all ranges and subranges therebetween. In embodiments, the second predetermined time for maintaining the crystallization temperature can be about 1 minute, about 5 minutes, about 10 minutes, about 20 minutes, about 30 minutes, about 40 minutes, about 50 minutes, about 1 hour, about 1.5 hours, about 2 hours, about 2.5 hours, about 3 hours, about 3.5 hours, or about 4 hours, about 4.5 hours, about 5 hours, about 5.5 hours, about 6 hours, about 6.5 hours, about 7 hours, about 7.5 hours, or about 8 hours, and all ranges and subranges therebetween. In embodiments, the crystallization temperature be selected to produce a transparent glass ceramic, a translucent glass ceramic, or an opaque glass ceramic. In some embodiments, a crystallization temperature of about 750° C. or or less may produce a transparent glass ceramic. In embodiments, a crystallization temperature of greater than 750° C. may produce a translucent or opaque glass ceramic. In embodiments, the precursor glass can be heated from room temperature to a nucleation temperature of from about 560° C. to about 580° C. at a heating rate of about 5° C./min, maintained at the nucleation temperature for about 4 hours, then heated to the crystallization temperature of from about 720° C. to about 750° C. a heating rate of about 5° C./min, and maintained at the crystallization temperature for from about 1 hour to about 7 hours.

In embodiments, there may be one of more additional temperature holds between the nucleation temperature and the crystallization temperature. Thus, in some embodiments, after maintaining the precursor glass at the nucleation temperature, the nucleated precursor glass may be heated to one or more intermediate temperatures (wherein the intermediate temperatures are in a range between the nucleation temperature and the crystallization temperature) and held at the one or more intermediate temperatures for a predetermined time (for example, between 1 hour and 4 hours and all ranges and subranges there between) and then heated to the crystallization temperature.

In embodiments, once the precursor glass is heated to the nucleation temperature, the precursor glass is not maintained at the nucleation temperature but instead is continuously heated to one or more intermediate temperatures until the crystallization temperature is reached (i.e., the temperature is not maintained at any of the intermediate temperatures or the nucleation temperature). In embodiments, the heating rate from room temperature to the nucleation temperature, the heating rate from the nucleation temperature to the intermediate temperature, the heating rate from the intermediate temperature to the crystallization temperature may vary and may all be different. In embodiments where there are multiple intermediate temperatures, the heating rate between the individual intermediate temperatures may also vary. In some embodiments, the heating rates may vary and may be in a range from about 0.01° C./min to about 50° C./min, such as about 0.01° C./min, about 0.1° C./min, about 0.5° C./min, about 1° C./min, about 2° C./min, about 3° C./min, about 4° C./min, about 5° C./min, about 10° C./min, about 15° C./min, about 20° C./min, about 25° C./min, about 30° C./min, about 40°/min, about 45° C./min, about 50° C./min, and all ranges and subranges therebetween. In embodiments, the heating rate may increase from one heating rate to another heating rate. In other embodiments, the heating rate may decrease from one heating rate to another heating rate. Methods for determining ceramming cycles to control crystal growth and viscosity during the ceram process, strategies for minimizing warp of the glass ceramic during the ceram process, and systems and methods of maintaining thermal uniformity during the ceram process can be found in U.S. Pat. No. 11,014,848, which was previously incorporated by reference in the present disclosure.

In embodiments, the glass ceramic is cooled after being held at the crystallization temperature and before being 3D formed. In embodiments, the glass ceramic material may be cooled to room temperature in a single stage at a constant cooling rate, in two stages each with a different cooling rate, or in three or more stages each with a different cooling rate. In embodiments, the glass ceramic material may be cooled at a controlled rate from the crystallization temperature in order to minimize temperature gradients across the glass ceramic as well as minimize residual stress across the glass ceramic. Temperature gradients and differences in residual stress in the glass ceramic may lead to warping in the glass ceramic during cooling. Thus, controlling the cooling to control the temperature gradients and residuals stresses may also reduce warpage of the glass ceramic preforms.

In embodiments, cooling may occur in two cooling stages. In such embodiments, in the first cooling stage, the temperature of the glass ceramic cools from a maximum temperature (i.e., TC— the crystallization temperature) to an intermediate cooling temperature (T1) at a first cooling rate. In the second cooling stage, the temperature cools from the intermediate cooling temperature to about room temperature (Troom) at a second cooling rate. In embodiments, the first cooling rate is slower than the second cooling rate. The first cooling rate during the first stage is slow to minimize the temperature gradient across the glass ceramic. In embodiments, the intermediate cooling temperature, where the transition from the first cooling stage to the second cooling stage occurs, may be determined based on the temperature below which the glass ceramic behaves as an elastic material. Without being bound by theory, it is believed that the slower cooling rate of the first cooling stage is only needed to control the temperature gradients until the glass ceramic reaches the temperature below which it behaves as an elastic material. In embodiments, the intermediate cooling temperature may be in a range from 450° C. to 550° C. and all ranges and subranges therebetween. In embodiments, the intermediate cooling temperature may be less than or equal to 550° C., 540° C., 530° C., 520° C., 510° C., 500° C., 490° C., 480° C., 470° C., 460° C., or 450° C. In embodiments, the temperature drop in the first cooling stage (Tmax−T1) is less than the temperature drop in the second cooling stage (T1−TRoom). Without be bound by theory, it is believed that temperature gradients that develop in the first cooling stage have a greater effect on the residual stresses (and therefore warp) in the glass ceramic upon reaching room temperature (in the form of optical retardance) than temperature gradients that develop in the second cooling stage. Thus, in some embodiments, after controlled cooling in the first cooling stage, the glass ceramic may be allowed to cool to room temperature in an uncontrolled cooling environment.

In embodiments, the cooling cycle may have an intermediate cooling stage in between the first cooling stage and the second cooling stage for a total of three cooling stages. In such embodiments, in the first cooling stage, the temperature cools from the maximum temperature (i.e., TC—the crystallization temperature) to a first intermediate cooling temperature Ti at a first cooling rate. In the intermediate cooling stage, the temperature cools from Ti to a second intermediate cooling temperature T2 at an intermediate cooling rate. In the second cooling stage, the temperature cools from T2 to about room temperature (TRoom) at a third cooling rate. The cooling rate may increase with each successive cooling stage such that (i) the first cooling rate during the first cooling stage is less than the second cooling rate during the intermediate cooling stage and the third cooling rate during the second cooling stage and (ii) the second cooling rate during the intermediate cooling stage is less than the third cooling rate during the second cooling stage. In some embodiments, (i) the temperature drop in the first cooling stage (TC−T1) is less than the temperature drop in the intermediate cooling stage (T1−T2) and the temperature drop in the second cooling stage (T2−TRoom) and (ii) the temperature drop in the intermediate cooling stage (T1−T2) is less than the temperature drop in the second cooling stage (T2−TRoom). The intermediate cooling stages allows for a faster cooling cycle while still minimizing temperature gradients and residual stress. In some embodiments, Tmax may be from about 720° C. to about 750° C., Ti may be about 640° C., and T2 may be about 580° C.

In some embodiments, when having multiple cooling stages in the cooling cycle, the temperature gradients across the glass ceramic during the first cooling stage may be less than about 15° C., less than about 14° C., less than about 13° C., less than about 12° C., less than about 11° C., less than about 10° C., less than about 9° C., less than about 8° C., less than about 7° C., less than about 6° C., less than about 5° C., less than about 4° C., or less than about 3° C. In embodiments, the optical retardance of the glass ceramic at room temperature may be less than about 15 nm/mm of thickness, less than about 14 nm/mm of thickness, less than about 13 nm/mm of thickness, less than about 12 nm/mm of thickness, less than about 11 nm/mm of thickness, less than about 10 nm/mm of thickness, less than about 9 nm/mm of thickness, less than about 8 nm/mm of thickness, less than about 7 nm/mm of thickness, less than about 6 nm/mm of thickness, less than about 5 nm/mm of thickness, less than about 4 nm/mm of thickness, or less than about 3 nm/mm of thickness. The optical retardation may be measured according to ASTM F218-13.

Upon performing the above heat treatments to the precursor glass, the resultant glass ceramic has one or more crystalline phases and a residual glass phase. In embodiments, the glass ceramic contains lithium disilicate and petalite crystal phases. In addition to lithium disilicate and petalite, the glass ceramic may further contain one or more of the following exemplary crystalline phases as minor crystal phases: ß-spodumene solid solution, ß-quartz solid solution, lithium metasilicate, virgilite, cristobalite, lithium phosphate, baddeleyite, zirconia, and any combinations thereof. In embodiments, the glass ceramic, after ceramming, may comprise at least the disilicate crystal phase, the petalite crystal phase, and the residual glass phase. In embodiments, after ceramming and before 3D forming, the glass ceramic may comprise a combined concentration of lithium disilicate crystal phase and petalite crystal phase of greater than or equal to 50 wt. %, such as from 50 wt. % to 90 wt. %, and all ranges and subranges inbetween, based on the total weight of the glass ceramic. In embodiments, the glass ceramic may comprise a combined concentration of lithium disilicate crystal phase and petalite crystal phase of from 50 wt % to 85 wt %, from 50 wt % to 80 wt %, from 50 wt % to 75 wt %, from 50 wt % to 70 wt %, from 50 wt % to 65 wt %, from 50 wt % to 60 wt %, from 55 wt % to 90 wt %, from 55 wt % to 85 wt %, from 55 wt % to 80 wt %, from 55 wt % to 75 wt %, from 55 wt % to 70 wt %, from 55 wt % to 65 wt %, from 55 wt % to 60 wt %, from 60 wt % to 90 wt %, from 60 wt % to 85 wt %, from 60 wt % to 80 wt %, from 60 wt % to 75 wt %, from 60 wt % to 70 wt %, from 60 wt % to 65 wt %, from 65 wt % to 90 wt %, from 65 wt % to 85 wt %, from 65 wt % to 80 wt %, from 65 wt % to 75 wt %, from 65 wt % to 70 wt %, from 70 wt % to 90 wt %, from 70 wt % to 85 wt %, from 70 wt % to 80 wt %, from 70 wt % to 75 wt %, from 75 wt % to 90 wt %, from 75 wt % to 85 wt %, from 75 wt % to 80 wt %, from 80 wt % to 90 wt %, from 80 wt % to 85 wt %, or from 85 wt % to 90 wt % based on the total weight of the glass ceramic.

In embodiments, lithium disilicate may be the crystalline phase with the greatest weight percentage in the glass ceramic. Lithium disilicate, Li₂Si₂O₅, is an orthorhombic crystal based on corrugated sheets of {Si₂O₅} tetrahedral arrays. The crystals are typically tabular or lath-like in shape, with pronounced cleavage planes. Glass ceramics based on lithium disilicate offer highly desirable mechanical properties, including high body strength and fracture toughness, due to their microstructures of randomly-oriented interlocked crystals—a crystal structure that forces cracks to propagate through the material via tortuous paths around these crystals. In embodiments, the weight percentage of the lithium disilicate crystalline phase in the glass ceramic compositions, after ceramming, can be in a range from about 20 to about 60 wt %, about 20 to about 55 wt %, about 20 to about 50 wt %, about 20 to about 45 wt %, about 20 to about 40 wt %, about 20 to about 35 wt %, about 20 to about 30 wt %, about 20 to about 25 wt %, about 25 to about 60 wt %, about 25 to about 55 wt %, about 25 to about 50 wt %, about 25 to about 45 wt %, about 25 to about 40 wt %, about 25 to about 35 wt %, about 25 to about 30 wt %, about 30 to about 60 wt %, about 30 to about 55 wt %, about 30 to about 50 wt %, about 30 to about 45 wt %, about 30 to about 40 wt %, about 30 to about 35 wt %, about 35 to about 60 wt %, about 35 to about 55 wt %, about 35 to about 50 wt %, about 35 to about 45 wt %, about 35 to about 40 wt %, about 40 to about 60 wt %, about 40 to about 55 wt %, about 40 to about 50 wt %, about 40 to about 45 wt %, about 45 to about 60 wt %, about 45 to about 55 wt %, about 45 to about 50 wt %, about 50 to about 60 wt %, about 50 to about 55 wt %, or about 55 to about 60 wt %, based on the total weight of the glass ceramic. In embodiments, the glass-ceramic has 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt % lithium disilicate crystalline phase, based on the total weight of the glass ceramic.

In embodiments, petalite may be the crystalline phase with the greatest weight percentage. Petalite, LiAlSi₄O₁₀, is a monoclinic crystal possessing a three-dimensional framework structure with a layered structure having folded Si₂O₅ layers linked by Li and Al tetrahedral. The Li is in tetrahedral coordination with oxygen. The mineral petalite is a lithium source and is used as a low thermal expansion phase to improve the thermal downshock resistance of glass ceramics or ceramic parts. Moreover, glass ceramic materials based on the petalite phase can be chemically strengthened in a salt bath, during which Na⁺ (and/or K⁺) replaces Li⁺ in the petalite structure, which causes surface compression and strengthening. In embodiments, the weight percentage of the petalite crystalline phase in the glass ceramic composition, after ceramming, can be in a range from about 20 to about 70 wt %, about 20 to about 65 wt %, about 20 to about 60 wt %, about 20 to about 55 wt %, about 20 to about 50 wt %, about 20 to about 45 wt %, about 20 to about 40 wt %, about 20 to about 35 wt %, about 20 to about 30 wt %, about 20 to about 25 wt %, about 25 to about 70 wt %, about 25 to about 65 wt %, about 25 to about 60 wt %, about 25 to about 55 wt %, about 25 to about 50 wt %, about 25 to about 45 wt %, about 25 to about 40 wt %, about 25 to about 35 wt %, about 25 to about 30 wt %, about 30 to about 70 wt %, about 30 to about 65 wt %, about 30 to about 60 wt %, about 30 to about 55 wt %, about 30 to about 50 wt %, about 30 to about 45 wt %, about 30 to about 40 wt %, about 30 to about 35 wt %, about 35 to about 70 wt %, about 35 to about 65 wt %, about 35 to about 60 wt %, about 35 to about 55 wt %, about 35 to about 50 wt %, about 35 to about 45 wt %, about 35 to about 40 wt %, about 40 to about 70 wt %, about 40 to about 65 wt %, about 40 to about 60 wt %, about 40 to about 55 wt %, about 40 to about 50 wt %, about 40 to about 45 wt %, about 45 to about 70 wt %, about 45 to about 65 wt %, about 45 to about 60 wt %, about 45 to about 55 wt %, about 45 to about 50 wt %, about 50 to about 70 wt %, about 50 to about 65 wt %, about 50 to about 60 wt %, about 50 to about 55 wt %, about 55 to about 70 wt %, about 55 to about 65 wt %, about 55 to about 60 wt %, about 60 to about 70 wt %, about 60 to about 65 wt %, or about 65 to about 70 wt %, based on the total weight of the glass ceramic. In embodiments, the glass-ceramic has about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt % petalite crystalline phase, based on the total weight of the glass ceramic.

Accordingly, in embodiments, the glass ceramics, after ceramming and before 3D forming, may comprise a combined weight percentage of lithium disilicate and petalite crystalline phase that is greater than or equal to 40 wt %, such as greater than or equal to 42 wt %, greater than or equal to 44 wt %, greater than or equal to 46 wt %, greater than or equal to 48 wt %, greater than or equal to 50 wt %, greater than or equal to 52 wt %, greater than or equal to 54 wt %, greater than or equal to 56 wt %, greater than or equal to 58 wt %, greater than or equal to 60 wt %, greater than or equal to 62 wt %, greater than or equal to 64 wt %, greater than or equal to 66 wt %, greater than or equal to 68 wt %, greater than or equal to 70 wt %, greater than or equal to 72 wt %, greater than or equal to 74 wt %, greater than or equal to 76 wt %, greater than or equal to 78 wt %, greater than or equal to 80 wt %, greater than or equal to 82 wt %, greater than or equal to 84 wt %, or greater than or equal to 85 wt %, based on the total weight of the glass ceramic. In embodiments, the crystalline phases other than lithium disilicate and petalite have a total wt % in the glass ceramic preform of less than 5 wt %, less than 4 wt %, less than 3 wt %, less than 2 wt %, or less than 1 wt %, based on the total weight of the glass ceramic.

In embodiments, the glass ceramic, after the ceram process, may have a weight percentage of crystals in a range from greater than 20 wt % to 90 wt %, greater than 20 wt % to 80 wt %, greater than 20 wt % to 70 wt %, 30 wt % to 100 wt %, 30 wt % to 90 wt %, 30 wt % to 80 wt %, 30 wt % to 70 wt %, 40 wt % to 90 wt %, 40 wt % to 80 wt %, 40 wt % to 70 wt %, 50 wt % to 90 wt %, 50 wt % to 80 wt %, 50 wt % to 70 wt %, and all ranges and subranges therebetween. In embodiments, the glass ceramic, after the ceram process, may have a weight percentage of crystals in a range from greater than 50 wt % to 90 wt %. In embodiments, the inner region may have a weight percentage of crystals greater than 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, or greater than or equal to 85 wt %.

The glass ceramics, after ceramming and before 3D forming, further includes a residual glass phase. The glass ceramics, after ceramming, may have a concentration of the residual glass phase sufficient to enable the glass ceramic to be 3D forming through heating and pressing into a mold, according to the methods disclosed herein. In embodiments, the glass ceramic preform, prior to 3D forming, may have a concentration of the residual glass phase of from about 5 wt % to about 50 wt %, from about 5 wt % to about 40 wt %, from about 5 wt % to 35 wt %, from about 5 wt % to about 30 wt %, from about 5 wt % to about 25 wt %, from about 5 wt % to about 20 wt %, from about 5 wt % to about 15 wt %, from about 5 wt % to about 10 wt %, from about 10 wt % to about 50 wt %, from about 10 wt % to about 45 wt %, from about 10 wt % to about 40 wt %, from about 10 wt % to about 35 wt %, from about 10 wt % to about 30 wt %, from about 10 wt % to about 25 wt %, from about 10 wt % to about 20 wt %, from about 10 wt % to about 15 wt %, from about 15 wt % to about 50 wt %, from about 15 wt % to about 45 wt %, from about 15 wt % to about 40 wt %, from about 15 wt % to about 35 wt %, from about 15 wt % to about 30 wt %, from about 15 wt % to about 25 wt %, from about 15 wt % to about 20 wt %, from about 20 wt % to about 50 wt %, from about 20 wt % to about 45 wt %, from about 20 wt % to about 40 wt %, from about 20 wt % to about 35 wt %, from about 20 wt % to about 30 wt %, from about 20 wt % to about 25 wt %, from about 25 wt % to about 30 wt %, and all ranges and subranges there between, where the weight percentages are based on the total weight of the glass ceramic. In embodiments the concentration of the residual glass phase in the glass ceramic can be less than or equal to 50, 45, 40, 35, 30, 25, 20, 19, 18, 17, 16, 15, 14, 13, 12, 11, 10, 9, 8, 7, or 6 wt %, based on the total weight of the glass ceramic. In embodiments, the glass ceramic preform, prior to 3D forming, may have a concentration of the residual glass phase of from 10 wt % to 50 wt % based on the total weight of the glass ceramic preform.

In embodiments, the phase assemblage and heat treatment conditions during the ceram process are chosen to create a glass ceramic sheet or glass ceramic preform with suitable optical properties, such as high transparency and low haze. In some embodiments, the glass ceramic sheet or preform is transparent in that it has an average transmittance of 85% or greater, 86% or greater, 87% or greater, 88% or greater, 89% or greater, 90% or greater, 91% or greater, 92% or greater, 93% or greater (including surface reflection losses) of light over the wavelength range from 450 nm to 600 nm for a glass ceramic sheet or preform having a thickness of 1 mm. In embodiments, glass ceramic may be translucent over the wavelength range from 450 nm to 600 nm. In embodiments, a translucent glass ceramic can have an average transmittance in a range from about 20% to less than about 85% of light over the wavelength range of about 450 nm to about 800 nm for the glass ceramic sheet or preform having a thickness of 1 mm. In embodiments, the glass ceramic sheet or preform, prior to 3D forming, may have a haze at a thickness of 0.8 mm of less than 0.2, less than 0.19, less than 0.18, less than 0.17, less than 0.16, less than 0.15, less than 0.14, less than 0.13, less than 0.12, less than 0.11, or less than 0.1.

Following ceramming, the stack comprising the plurality of glass ceramic sheets may be separated into the individual glass ceramic sheets. In embodiments, the glass sheets may be cut into preform shapes prior to ceramming and then assembled into the stack comprising the pluratlity of glass sheets, thereby producing a plurality of glass ceramic preforms following the ceram process. The preform shape may be a shape of a flat piece of glass ceramic that, when 3D formed by heating and pressing the glass ceramic preform into a mold, produces a glass ceramic article of the desired shape. In embodiment, the glass sheets in the stack may have a general shape, such as square, rectangular, and the like, and the glass ceramic sheets produced from ceramming may then be cut or other divided into one or a plurality of glass ceramic preforms.

3D Forming Process

Following ceramming the precursor glass to produce the glass ceramic preform, the glass ceramic preform is then subjected to a 3D forming process to form the glass ceramic into a 2.5D or 3D shape that is different from the shape of the glass ceramic preform. 3D forming the glass ceramic preform to produce the glass ceramic articles ofthe present disclosure may include a thermo-mechanical 3D forming process in which the glass ceramic preform is heated to a 3D forming temperature and then pressing the heated glass ceramic preform into a mold to produce the glass ceramic article. The 3D forming following after formation of the crystalline phases through the ceram process is enabled by the precursor glass composition, which provides a greater concentration of the residual glass phase, a lower viscosity of the residual glass phase, or both compared to other glass ceramic that cannot be 3D formed after ceram. The 3D forming process disclosed herein, in combination with the composition of the glass ceramic, result in increasing the concentration of the residual glass phase in the glass ceramic article compared to the concentration of the residual glass phase in the glass ceramic preform. Additionally, the composition of the glass ceramic in combination with the 3D forming process may further improve ion-exchange of the glass ceramic article to produce a strengthened glass article having greater depth of compression, greater compression stress in the compression layer, and greater central tension.

The 3D forming process for shaping the glass ceramic preform into the glass ceramic article may include heating the glass ceramic preform to a forming temperature and, after heating, pressing the glass ceramic preform into a mold for a time period sufficient to produce the glass ceramic article. In embodiments, the 3D forming process may further include cooling the glass ceramic article from the 3D forming temperature back to room temperature. In embodiments, the heating, pressing, and cooling steps may be performed on a multi-station thermal forming machine comprising a plurality of heating stations, a plurality of pressing stations downstream of the heating stations, and a plurality of cooling stations downstream of the pressing stations. The glass ceramic preform may be translated through each of the processing stations in succession to heat the glass ceramic preform, press the glass ceramic preform into a mold, and the cool the glass ceramic article.

During the heating step of the 3D forming process, the glass ceramic preform may be heated a 3D temperature high enough to enable the glass ceramic preform to be pressed into a mold without breaking the glass ceramic preform. In embodiments, the glass ceramic preform may be heated to a 3D forming temperature of from about 650° C. to about 850° C., such as from about 650° C. to about 825° C., from about 650° C. to about 800° C., from about 650° C. to about 775° C., from about 650° C. to about 750° C., from about 675° C. to about 850° C., from about 675° C. to about 825° C., from about 675° C. to about 800° C., from about 675° C. to about 775° C., from about 675° C. to about 750° C., from about 700° C. to about 850° C., from about 700° C. to about 825° C., from about 700° C. to about 800° C., from about 700° C. to about 775° C., from about 700° C. to about 750° C., from about 725° C. to about 850° C., from about 725° C. to about 825° C., from about 725° C. to about 800° C., from about 725° C. to about 775° C., from about 725° C. to about 750° C., from about 750° C. to about 850° C., from about 750° C. to about 825° C., from about 750° C. to about 800° C., from about 775° C. to about 850° C., from about 775° C. to about 825° C., or from about 800° C. to about 850° C. In embodiments, the 3D forming temperature may be about 650° C., about 660° C., about 670° C., about 680° C., about 690° C., about 700° C., about 710° C., about 720° C., about 730° C., about 740° C., about 750° C., about 760° C., about 770° C., about 780° C., about 790° C., about 800° C., about 810° C., about 820° C., about 830° C., about 840° C., or about 850° C.

The pressing step may comprise pressing the glass ceramic preform into a mold at the 3D forming temperature and a 3D forming pressure. In embodiments, the mold may be a graphite mold. Molds made from other materials are contemplated. The 3D forming pressure may be sufficient to conform the glass ceramic preform to the contours of the mold. In embodiments, the 3D forming pressure may be from about 0.001 MPa to about 0.9 MPa, such as from about 0.001 MPa to about 0.8 MPa, from about 0.001 MPa to about 0.6 MPa, from about 0.001 MPa to about 0.4 MPa, from about 0.001 MPa to about 0.2 MPa, from about 0.001 MPa to about 0.1 MPa, from about 0.01 MPa to 0.9 MPa, from about 0.01 MPa to about 0.8 MPa, from about 0.01 MPa to about 0.6 MPa, from about 0.01 MPa to about 0.4 MPa, from about 0.01 MPa to about 0.2 MPa, from about 0.01 MPa to about 0.1 MPa, from about 0.1 MPa to about 0.9 MPa, from about 0.1 MPa to about 0.8 MPa, from about 0.1 MPa to about 0.6 MPa, from about 0.1 MPa to about 0.4 MPa, from about 0.1 MPa to about 0.2 MPa, from about 0.2 MPa to about 0.9 MPa, from about 0.2 MPa to about 0.8 MPa, from about 0.2 MPa to about 0.6 MPa, from about 0.2 MPa to about 0.4 MPa, from about 0.4 MPa to about 0.9 MPa, from about 0.4 MPa to about 0.8 MPa, from about 0.4 MPa to about 0.6 MPa, from about 0.6 MPa to about 0.9 MPa, from about 0.6 MPa to about 0.8 MPa, or from about 0.8 MPa to about 0.9 MPa.

Following pressing the glass ceramic to produce the glass ceramic article, the glass ceramic article may be cooled back to room temperature. In embodiments, the glass ceramic article may be cooled to room temperature in a single stage at a constant cooling rate, or over multiple stages each with a different cooling rate. In embodiments, the glass ceramic article may be cooled at a controlled rate from the 3D forming temperature back to room temperature in order to minimize temperature gradients across the glass ceramic article as well as minimize residual stress across the glass ceramic article.

The compositions and processes disclosed herein of 3D forming the glass ceramic preforms after ceraming can maintain or increase the concentration of the residual glass phase in the glass ceramic article compared to the glass ceramic preform prior to 3D forming. In conventional compositions and 3D forming processes, the ceramming is typically done at the same time or after 3D forming, during which time the crystallinity is increased to convert the nucleated precursor glass into the glass ceramic. Thus, in conventional 3D forming processes, the total concentration of the crystal phases increases and the concentration of the residual glass phase decreases. Further, due to the fact that the 3D forming temperature ranges disclosed herein overlap the crystallization temperature ranges for ceraming to convert the precursor glass to the glass ceramic, one of ordinary skill in the art would expect the concentration of the crystal phases to increase when 3D forming after ceramming. However, as shown in the Examples, the compositions and 3D forming process disclosed herein was found to produce glass ceramic articles in which the concentration of the residual glass phase was constant or increased compared to the glass ceramic preform prior to 3D forming. Therefore, it is unexpected that the compositions and 3D forming processes of the present disclosure result in constant or increased concentration of residual glass phase during 3D forming. Without being bound by theory, it is believed that the glass ceramic composition (e.g., increased concentrations of non-lithium alkali metal oxides, alkaline metal oxides, ZnO, or combinations thereof and/or greater molar ratios of these constituents to Al₂O₃ and ZrO₂) in combination with the conditions of the 3D forming may cause at least some of the constituents in the crystal phases to migrate back into the residual glass phase to increase the concentration of the residual glass phase in the glass ceramic articles.

The concentration of the residual glass phase in the glass ceramic article may be equal to or greater than the concentration of the residual glass phase in the glass ceramic preform prior to 3D forming. In embodiments, the heating and pressing of the glass ceramic preform during the 3D forming process may increase the concentration of the residual glass phase. Following 3D forming, the concentration of the residual glass phase in the glass ceramic article may be at least 1% greater than the concentration of the residual glass phase in the glass ceramic preform prior to 3D forming. In embodiments, the concentration of the residual glass phase in the glass ceramic article may be at least 3% greater, at least 5% greater, at least 7% greater, at least 10% greater, at least 15% greater, at least 20% greater, at least 25% greater, or even at least 30% greater than the concentration of the residual glass phase in the glass ceramic preform prior to 3D forming. In embodiments, following 3D forming, the difference between the concentration of the residual glass phase in the glass ceramic article and the concentration of the residual glass phase in the glass ceramic preform (i.e., [glass phase]_{article}−[glass phase]_{preform}) may be greater or equal 0%, greater than or equal to 1%, greater than or equal to 3%, greater than or equal to 5%, greater than or equal to 7%, greater than or equal of 10%, greater than or equal to 15%, greater than or equal to 20%, greater than or equal to 25%, or even greater than or equal to 30% of the concentration of the residual glass phase in the glass ceramic preform. The difference between the concentration of the residual glass phase in the glass ceramic article and the concentration of the residual glass phase in the glass ceramic preform (i.e., [glass phase]_{article}−[glass phase]_{preform}) may be less than 100%, less than 75%, or even less than 50% of the concentration of the residual glass phase in the glass ceramic preform.

In embodiments, the concentration of the residual glass phase in the glass ceramic article after 3D forming may be from 15 wt % to 55 wt % after 3D forming, such as from 15 wt % to 50 wt %, from 15 wt % to 45 wt %, from 15 wt % to 40 wt %, from 15 wt % to 35 wt %, from 15 wt % to 30 wt %, from 15 wt % to 25 wt %, from 20 wt % to 55 wt %, from 20 wt % to 50 wt %, from 20 wt % to 45 wt %, from 20 wt % to 40 wt %, from 20 wt % to 35 wt %, from 20 wt % to 30 wt %, from 20 wt % to 25 wt %, from 25 wt % to 55 wt %, from 25 wt % to 50 wt %, from 25 wt % to 45 wt %, from 25 wt % to 40 wt %, from 25 wt % to 35 wt %, from 25 wt % to 30 wt %, from 30 wt % to 55 wt %, from 30 wt % to 50 wt %, from 30 wt % to 45 wt %, from 30 wt % to 40 wt %, from 30 wt % to 35 wt %, from 35 wt % to 55 wt %, from 35 wt % to 50 wt %, from 35 wt % to 45 wt %, from 35 wt % to 40 wt %, from 40 wt % to 55 wt %, from 40 wt % to 50 wt %, from 40 wt % to 45 wt %, from 45 wt % to 55 wt %, from 45 wt % to 50 wt %, or from 50 wt % to 55 wt %, based on the total weight of the glass ceramic article. The increased concentration of the residual glass phase in the glass ceramic article compared to the glass ceramic preform may improve ion-exchange strengthening of the glass ceramic article to produce a strengthened glass ceramic article, as will be further discussed herein.

The processes of 3D forming the glass ceramic preform after ceramming to produce the glass ceramic articles can also reduce shrinking of the glass ceramic article during the 3D forming process. In embodiments, a total volume change of the glass ceramic article compared to the volume of the glass ceramic preform prior to 3D forming is less than 1% of the volume of the glass ceramic preform prior to 3D forming, such as less than 0.5%, less than 0.3%, or even less than or equal to 0.1% of the volume of the glass ceramic preform prior to 3D forming. Without being bound by any particular, it is believed that by ceramming the precursor glass to produce the glass ceramic preform prior to 3D shaping, the glass ceramic preform has already been densified to form the various crystal phases prior to the 3D forming. Therefore, very little further densification occurs during the 3D forming, thereby reducing the amount of shrinkage of the glass ceramic articles compared to the glass ceramic preform.

The glass ceramic articles produced by the methods disclosed herein are clear and transparent. Additionally, the glass ceramic articles may exhibit less staining from mechanical interaction with the mold during pressing compared to glass ceramic articles formed by a process that includes ceramming simultaneously with or after the 3D forming, such as by a process involving only nucleating the glass precursor and then 3D forming simultaneously with crystallizing the glass precurors to produce the glass ceramic.

Cosmetically, the glass ceramic articles prepared by 3D forming the glass ceramic preforms after ceramming may exhibit much less surface defects and flaws compared to glass ceramic articles prepared by processes in which ceramming is performed simultaneously with or after the 3D forming. In particular, the glass ceramic articles prepared by 3D forming the glass ceramic preforms after ceramming may exhibit less staining compared to glass ceramic articles prepared by processes in which ceramming is performed simultaneously with or after the 3D forming. Staining refers to surface defects caused by movement of the glass ceramic relative to surface of the mold, such as movement cause by shrinkage of the glass ceramic during 3D forming. Without being bound by any particular theory, it is believed that the staining is due to glass ceramic movement or shrinkage relative to the mold during 3D forming. At the staining areas, the glass ceramic is physically moving relative to the mold, which creates friction at the interface between the glass ceramic and the mold. This friction and movement scrapes the glass ceramic against the mold surface, which distributes defects into the surface of the glass cermaic. These defects can be removed by downstream polishing processes. Due to the majority of crystallization already taking place in the ceramming step prior to 3D forming, the glass ceramic articles disclosed herein experience very little densification and shrinkage during the 3D forming process. Therefore, the glass ceramic articles produced by the methods disclosed herein may exhibit less surface defects caused by staining. As a result, the glass ceramic articles disclosed herein may require less post forming processing, such as polishing, downstream of the 3D forming process to remove surface defects to meet quality specifications.

In embodiments, the methods disclosed herein do not include any active method steps, after the 3D forming, that are intended to further increase the concentration of the crystal phases of the glass ceramic article.

Through the 3D forming process, the glass ceramic preform may be shaped into the glass ceramic article, which may have any desired 2.5D or 3D shape. In embodiments, the glass ceramic article may be 3D formed into a shape of a component of an electrical device, such as a cover glass for a personal handheld electronic device.

Ion Exchange Strengthening

In embodiments, the glass ceramic article is capable of being chemically strengthened using one or more ion exchange techniques. Following the 3D forming process, the glass ceramic articles can be strengthened through ion-exchange to produce strengthened glass ceramic articles. As previously discussed, the glass ceramic compositions and 3D forming process disclosed herein can increase the concentration of the residual glass phase in the glass ceramic articles compared to the glass ceramic preform, which can improve the ion-exchange process, such as by increasing the compression stress, central tension, and depth of compression in the strengthened glass ceramic articles compared to strengthening the glass ceramic preform without 3D forming. Without being bound by any particular theory, it is believed that these effects can be attributed to the greater concentration of the residual glass phase in the 3D formed glass ceramic articles and/or the greater availability of lithium in the residual glass phase of the 3D formed glass ceramic articles compared to the glass ceramics that were only cerammed. The improved ion-exchange may be attributable to faster diffusivity of potassium ions and sodium ions into the surface of the glass ceramic article due to the greater concentration of residual glass phase of the cerammed and 3D formed glass ceramic articles, which may allow for part size expansion to facilitate the ion exchange. The increase in the concentration of the residual glass phase after 3D forming, the smaller size and reduced total volume of the crystalline phases islands within the glass ceramic articles, and/or the concentration of alkali in the residual glass phase for the cerammed and 3D formed glass ceramic articles are believed to contribute to the increasing diffusivities of sodium (Na) and potassium (K) ions into the surface of the glass ceramic articles.

The processes disclosed herein can include, after the 3D forming, strengthening the glass ceramic article to produce the strengthened glass ceramic article having a compressive stress layer extending from a first surface of the glass ceramic article to a depth of compression. In embodiments, ion exchange can occur by subjecting one or more surfaces of the glass ceramic article to one or more ion exchange mediums (for example a molten salt baths), having a specific composition and temperature, for a specified time period to impart a compressive stress layer(s) to the one or more surfaces. In embodiments, the ion exchange medium is a molten bath containing an ion (for example an alkali metal ion such as Na⁺, K⁺, Rb⁺, and/or Cs⁺) that is larger than an ion (for example an alkali metal ion such as Li⁺, Na⁺, and/or K⁺) present in the glass ceramic article wherein the larger ion from the molten bath is exchanged with the smaller ion in the glass ceramic article to impart a compressive stress in the glass ceramic article, and thereby increase the strength of the glass ceramic article.

In embodiments, a one-step ion exchange process can be used and in other embodiments, a multi-step ion exchange process can be used. In embodiments, for both one-step and multi-step ion exchange processes, the ion exchange mediums (for example, molten baths) can include 100 wt % of a sodium-containing salt (for example, NaNO₃) or can include a mixed salt bath, for example a combination of a sodium-containing salt (for example, NaNO₃) and a potassium-containing salt (for example KNO₃). In embodiments, the ion exchange medium may include a small amount of lithium-containing salt (for example LiNO₃). In embodiments, the molten salt bath may contain a sodium-containing salt (for example, NaNO₃) in a range from 3 wt % to 100 wt %, 3 wt % to 95 wt %, 3 wt % to 90 wt %, 3 wt % to 85 wt %, 3 wt % to 80 wt %, 3 wt % to 75 wt %, 3 wt % to 70 wt. %, 3 wt % to 60 wt %, 3 wt % to 50 wt %, 3 wt % to 40 wt %, 5 wt % to 100 wt %, 5 wt % to 95 wt %, 5 wt % to 90 wt %, 5 wt % to 85 wt %, 5 wt % to 80 wt %, 5 wt % to 75 wt %, 5 wt % to 70 wt %, 5 wt % to 60 wt %, 5 wt % to 50 wt %, 5 wt % to 40 wt %, 10 wt % to 100 wt %, 10 wt % to 95 wt %, 10 wt % to 90 wt %, 10 wt % to 85 wt %, 10 wt % to 80 wt %, 10 wt % to 75 wt %, 10 wt % to 70 wt %, 10 wt % to 60 wt %, 10 wt % to 50 wt %, 10 wt % to 40 wt %, 15 wt % to 100 wt %, 15 wt % to 95 wt %, 15 wt % to 90 wt %, 15 wt % to 85 wt %, 15 wt % to 80 wt %, 15 wt % to 75 wt %, 15 wt % to 70 wt %, 15 wt % to 60 wt %, 15 wt % to 50 wt %, 15 wt % to 40 wt %, 10 wt % to 100 wt %, 10 wt % to 95 wt %, 10 wt % to 90 wt %, 10 wt % to 85 wt %, 10 wt % to 80 wt %, 10 wt % to 75 wt %, 10 wt % to 70 wt %, 10 wt % to 60 wt %, 10 wt % to 50 wt %, 10 wt % to 40 wt %, 25 wt % to 100 wt %, 25 wt % to 95 wt %, 25 wt % to 90 wt %, 25 wt % to 85 wt %, 25 wt % to 80 wt %, 25 wt % to 75 wt %, 25 wt % to 70 wt %, 25 wt % to 60 wt %, 25 wt % to 50 wt %, 25 wt % to 40 wt %, 30 wt % to 100 wt %, 30 wt % to 95 wt %, 30 wt % to 90 wt %, 30 wt % to 85 wt %, 30 wt % to 80 wt %, 30 wt % to 75 wt %, 30 wt % to 70 wt %, 30 wt % to 60 wt %, 30 wt % to 50 wt %, 30 wt % to 40 wt %, and all ranges and subranges there between, based on the total weight of the molten salt bath.

In embodiments, the molten salt bath may contain a potassium-containing salt (for example, KNO₃) in a range from 3 wt % to 100 wt %, 3 wt % to 95 wt %, 3 wt % to 90 wt %, 3 wt % to 85 wt %, 3 wt % to 80 wt %, 3 wt % to 75 wt %, 3 wt % to 70 wt. %, 3 wt % to 60 wt %, 10 wt % to 100 wt %, 10 wt % to 95 wt %, 10 wt % to 90 wt %, 10 wt % to 85 wt %, 10 wt % to 80 wt %, 10 wt % to 75 wt %, 10 wt % to 70 wt. %, 10 wt % to 60 wt %, 20 wt % to 100 wt %, 20 wt % to 95 wt %, 20 wt % to 90 wt %, 20 wt % to 85 wt %, 20 wt % to 80 wt %, 20 wt % to 75 wt %, 20 wt % to 70 wt. %, 3 wt % to 60 wt %, 30 wt % to 100 wt %, 30 wt % to 95 wt %, 30 wt % to 90 wt %, 30 wt % to 85 wt %, 30 wt % to 80 wt %, 30 wt % to 75 wt %, 30 wt % to 70 wt. %, 30 wt % to 60 wt %, 40 wt % to 100 wt %, 40 wt % to 95 wt %, 40 wt % to 90 wt %, 40 wt % to 85 wt %, 40 wt % to 80 wt %, 40 wt % to 75 wt %, 40 wt % to 70 wt. %, 40 wt % to 60 wt %, 50 wt % to 100 wt %, 50 wt % to 95 wt %, 50 wt % to 90 wt %, 50 wt % to 85 wt %, 50 wt % to 80 wt %, 50 wt % to 75 wt %, 50 wt % to 70 wt. %, 50 wt % to 60 wt %, 60 wt % to 100 wt %, 60 wt % to 95 wt %, 60 wt % to 90 wt %, 60 wt % to 85 wt %, 60 wt % to 80 wt %, 60 wt % to 75 wt %, 60 wt % to 70 wt. %, 70 wt % to 100 wt %, 70 wt % to 95 wt %, 70 wt % to 90 wt %, 70 wt % to 85 wt %, 70 wt % to 80 wt %, 70 wt % to 75 wt %, 75 wt % to 100 wt. %, 75 wt % to 90 wt %, from 80 wt % to 100 wt %, from 80 wt % to 95 wt %, or from 80 wt % to 90 wt % based on the total weight of the molten salt bath. In embodiments, other sodium and potassium salts may be used in the ion exchange solution, such as, for example sodium or potassium nitrites, phosphates, or sulfates. In embodiments, the molten salt bath may include a lithium-containing salt (e.g., LiNO₃). When present, a concentration of the lithium-containing salt in the molten salt bath may be less than 5 wt %, less than 1 wt %, or less than or equal to 0.5 wt % based on the total weight of the molten salt bath.

Strengthening the glass ceramic articles through ion exchange may comprise contacting the glass ceramic articles with a molten salt bath at an ion-exchange temperature for an ion-exchange time sufficient to produce the strengthened glass ceramic articles. The ion-exchange temperature may be from about 335° C. to about 600° C., such as from about 335° C. to about 550° C., from about 335° C. to about 500° C., from about 350° C. to about 600° C., from about 350° C. to about 550° C., from about 350° C. to about 500° C., from about 400° C. to about 600° C., from about 400° C. to about 550° C., from about 400° C. to about 500° C., from about 450° C. to about 600° C., from about 450° C. to about 550° C., from about 450° C. to about 500° C., or from about 500° C. to about 600° C. In embodiments, the ion-exchange temperature may be about 500° C. In embodiments, the ion-exchange time may be from 0.5 hours to 5 hours, from 0.5 hours to 4.5 hours, from 0.5 hour to 4 hours, from 0.5 hours to 3.5 hours, from 1 hours to 5 hours, from 1 hours to 4.5 hours, from 1 hour to 4 hours, from 1 hours to 3.5 hours, from 1.5 hours to 5 hours, from 1.5 hours to 4.5 hours, from 1.5 hour to 4 hours, from 1.5 hours to 3.5 hours, from 1.75 hours to 5 hours, from 1.75 hours to 4.5 hours, from 1.75 hour to 4 hours, or from 1.75 hours to 3.5 hours. Following ion exchange, the strengthened glass articles may be washed to remove reagents from the surfaces of the strengthened glass articles.

After an ion exchange process is performed, it should be understood that a composition at the surface of the glass ceramic article may be different than the composition of the as-formed glass ceramic article (i.e., the glass ceramic article before it undergoes the ion exchange process). This results from one type of alkali metal ion in the as-formed glass ceramic article, such as, for example Li⁺ or Na⁺, being replaced with larger alkali metal ions, such as, for example Na⁺ or K⁺, respectively. However, the composition of the glass ceramic article at or near the center of the depth of the glass ceramic article will, in embodiments, still have the composition of the as-formed glass ceramic article after 3D forming and before ion-exchange.

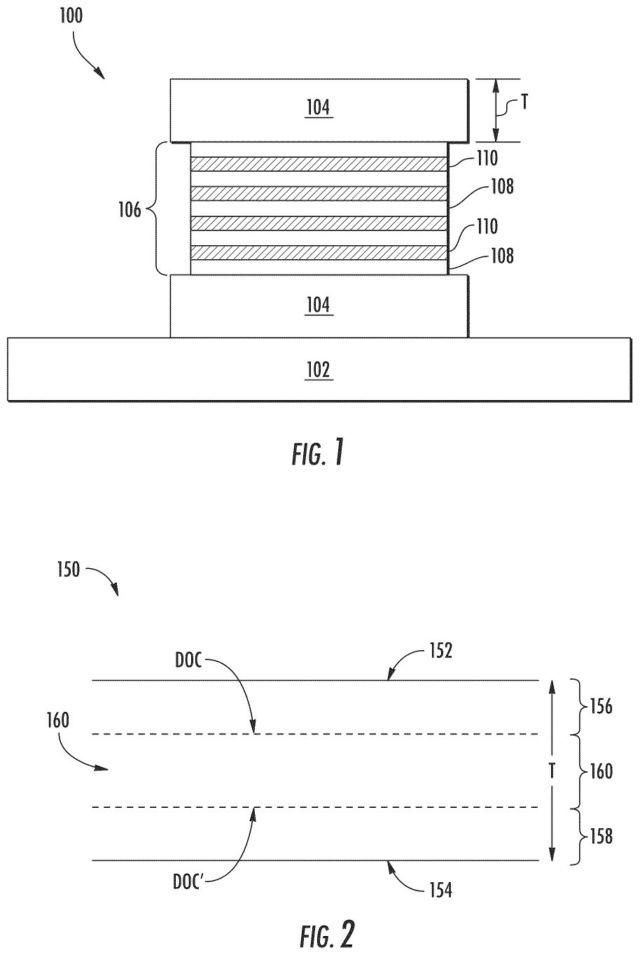

In embodiments, the glass ceramic articles may be strengthened to have a compressive stress layer on one or more surfaces thereof. With reference now to FIG. 2, an exemplary cross-sectional side view of a strengthened glass ceramic article 150 is schematically depicted having a first surface 152 and an opposing second surface 154 separated by a thickness (t). In embodiments, strengthened glass ceramic article 150 has been ion exchanged and has a compressive stress (CS) layer 156 (or first region) extending from first surface 152 to a depth of compression (DOC). In embodiments, as shown in FIG. 2, the glass ceramic article 150 may also have a compressive stress (CS) layer 158 extending from second surface 154 to a depth of compression DOC′. There is also a central tension region 160 under tensile stress in between DOC and DOC′.

In some embodiments, DOC, DOC′, or both may be in a range from greater than 0*t to 0.3*t, 0*t to 0.25*t, 0*t to 0.2*t, 0*t to 0.15*t, 0*t to 0.1*t, 0*t to 0.05*t, 0.05*t to 0.3*t, 0.05*t to 0.25*t, 0.05*t to 0.2*t, 0.05*t to 0.15*t, 0.05*t to 0.1*t, 0.1*t to 0.3*t, 0.1*t to 0.25*t, 0.1*t to 0.2*t, 0.1*t to 0.15*t, and all ranges and subranges there between, wherein t is the thickness of the glass ceramic article 150. In embodiments, the depth of a compressive stress layer (DOC, DOC′, or both) can be greater than 0.05*t, greater than 0.06*t, greater than 0.07*t, greater than 0.08*t, greater than 0.09*t, greater than 0.1*t, greater than 0.11*t, greater than 0.12*t, greater than 0.13*t, greater than 0.14*t, greater than 0.15*t, greater than 0.16*t, greater than 0.17*t, greater than 0.18*t, greater than 0.19*t, greater than 0.2*t, greater than 0.21*t, greater than 0.22*t, greater than 0.23*t, greater than 0.24*t, greater than 0.25*t, greater than 0.26*t, greater than 0.27*t, greater than 0.28*t, greater than 0.29*t, or greater than 0.3*t. In embodiments, the depth of a compressive stress layer (DOC, DOC′) may be in a range from 0.01 mm to 0.6 mm, 0.01 mm to 0.5 mm, 0.01 mm to 0.4 mm, 0.01 mm to 0.3 mm, 0.01 mm to 0.2 mm, 0.01 mm to 0.1 mm, 0.05 mm to 0.6 mm, 0.05 mm to 0.5 mm, 0.05 mm to 0.4 mm, 0.05 mm to 0.3 mm, 0.05 mm to 0.2 mm, 0.05 mm to 0.1 mm, 0.1 mm to 0.6 mm, 0.1 mm to 0.5 mm, 0.1 mm to 0.4 mm, 0.1 mm to 0.3 mm, 0.2 mm to 0.6 mm, 0.2 mm to 0.5 mm, 0.2 mm to 0.4 mm, and all ranges and subranges there between. In embodiments, the depth of the compressive stress layer (DOC, DOC′) is greater than or equal to 0.01 mm, greater than or equal to 0.05 mm, greater than or equal to 0.06 mm, greater than or equal to 0.07 mm, greater than or equal to 0.08 mm, greater than or equal to 0.09 mm, greater than or equal to 0.1 mm, greater than or equal to 0.15 mm, greater than or equal to 0.2 mm, greater than or equal to 0.25 mm, greater than or equal to 0.3 mm, greater than or equal to 0.35 mm, greater than or equal to 0.4 mm, greater than or equal to 0.45 mm, greater than or equal to 0.5 mm, greater than or equal to 0.55 mm, or greater than or equal to 0.6 mm. In embodiments, the DOC may be the same as DOC′. In other embodiments, DOC may be different than DOC′.
In embodiments, the strengthened glass ceramic articles may have a compressive stress (CS) at the surface of greater than 175 MPa, such as greater than 180 MPa, greater than 185 MPa, greater than 190 MPa, greater than 195 MPa, greater than 200 MPa, greater than 205 MPa, greater than 210 MPa, greater than 215 MPa, greater than 220 MPa, greater than 225 MPa, greater than 230 MPa, greater than 235 MPa, greater than 240 MPa, greater than 245 MPa, greater than 250 MPa, or even greater than 300 MPa. In embodiments, the strengthened glass ceramic articles may have a CS at the surface of from 175 MPa to 500 MPa, from 175 MPa to 450 MPa, from 175 MPa to 400 MPa, from 175 MPa to 350 MPa, from 175 MPa to 300 MPa, from 175 MPa to 250 MPa, from 180 MPa to 500 MPa, from 180 MPa to 450 MPa, from 180 MPa to 400 MPa, from 180 MPa to 350 MPa, from 180 MPa to 300 MPa, from 180 MPa to 250 MPa, from 185 MPa to 500 MPa, from 185 MPa to 450 MPa, from 185 MPa to 400 MPa, from 185 MPa to 350 MPa, from 185 MPa to 300 MPa, from 185 MPa to 250 MPa, from 190 MPa to 500 MPa, from 190 MPa to 450 MPa, from 190 MPa to 400 MPa, from 190 MPa to 350 MPa, from 190 MPa to 300 MPa, from 190 MPa to 250 MPa, from 195 MPa to 500 MPa, from 195 MPa to 450 MPa, from 195 MPa to 400 MPa, from 195 MPa to 350 MPa, from 195 MPa to 300 MPa, from 195 MPa to 250 MPa, from 200 MPa to 500 MPa, from 200 MPa to 450 MPa, from 200 MPa to 400 MPa, from 200 MPa to 350 MPa, from 200 MPa to 300 MPa, from 200 MPa to 250 MPa, from 210 MPa to 500 MPa, from 210 MPa to 450 MPa, from 210 MPa to 400 MPa, from 210 MPa to 350 MPa, from 210 MPa to 300 MPa, from 210 MPa to 250 MPa, from 220 MPa to 500 MPa, from 220 MPa to 450 MPa, from 220 MPa to 400 MPa, from 220 MPa to 350 MPa, from 220 MPa to 300 MPa, from 220 MPa to 250 MPa, from 230 MPa to 500 MPa, from 230 MPa to 450 MPa, from 230 MPa to 400 MPa, from 230 MPa to 350 MPa, from 230 MPa to 300 MPa, from 230 MPa to 250 MPa, from 250 MPa to 500 MPa, from 250 MPa to 450 MPa, from 250 MPa to 400 MPa, from 250 MPa to 350 MPa, from 250 MPa to 300 MPa, from 300 MPa to 500 MPa, from 300 MPa to 450 MPa, from 300 MPa to 400 MPa, or from 300 MPa to 350 MPa.

In embodiments, the strengthened glass ceramic articles may have a maximum central tension (CT) in a range from greater than 30 MPa to 180 MPa. In embodiments, the maximum CT is greater than or equal to 30 MPa, greater than or equal to 35 MPa, greater than or equal to 40 MPa, greater than or equal to 45 MPa, greater than or equal to 50 MPa, greater than or equal to 55 MPa, greater than or equal to 60 MPa, greater than or equal to 70 MPa, greater than or equal to 80 MPa, or greater than or equal to 100 MPa. In some embodiments, the maximum CT can be in a range from greater than 30 MPa to 180 MPa, greater than 30 MPa to 170 MPa, greater than 30 MPa to 160 MPa, greater than 30 MPa to 150 MPa, greater than 30 MPa to 140 MPa, greater than 35 MPa to 100 MPa, greater than 35 MPa to 80 MPa, from 35 MPa to 180 MPa, from 35 MPa to 170 MPa, from 35 MPa to 160 MPa, from 35 MPa to 150 MPa, from 35 MPa to 140 MPa, from 35 MPa to 100 MPa, from 35 MPa to 80 MPa, from 40 MPa to 180 MPa, from 40 MPa to 170 MPa, from 40 MPa to 160 MPa, from 40 MPa to 150 MPa, from 40 MPa to 140 MPa, from 40 MPa to 100 MPa, from 40 MPa to 80 MPa, from 45 MPa to 180 MPa, from 45 MPa to 170 MPa, from 45 MPa to 160 MPa, from 45 MPa to 150 MPa, from 45 MPa to 140 MPa, from 45 MPa to 100 MPa, from 45 MPa to 80 MPa, from 50 MPa to 180 MPa, from 50 MPa to 170 MPa, from 50 MPa to 150 MPa, from 50 to 120, from 50 MPa to 100 MPa, from 50 MPa to 80 MPa, or any range and subranges there between.

In embodiments, the stored tensile energy of the strengthened glass ceramic article is in a range from about 5 J/m² to about 50 J/m², about 5 J/m² to about 45 J/m², about 5 J/m² to about 40 J/m², about 5 J/m² to about 35 J/m², about 5 J/m² to about 30 J/m², about 5 J/m² to about 25 J/m², about 5 J/m 2 to about 20 J/m², about 5 J/m² to about 15 J/m², about 5 J/m² to about 10 J/m², about 10 J/m² to about 50 J/m², about 10 J/m² to about 45 J/m², about 10 J/m² to about 40 J/m², about 10 J/m² to about 35 J/m², about 10 J/m² to about 30 J/m², about 10 J/m² to about 25 J/m², about 10 J/m² to about 20 J/m², about 10 J/m² to about 15 J/m², about 15 J/m² to about 50 J/m², about 15 J/m² to about 45 J/m², about 15 J/m² to about 40 J/m², about 15 J/m² to about 35 J/m², about 15 J/m² to about 30 J/m², about 15 J/m² to about 25 J/m², about 15 J/m² to about 20 J/m², about 20 J/m² to about 50 J/m², about 20 J/m² to about 45 J/m², about 20 J/m² to about 40 J/m², about 20 J/m² to about 35 J/m², about 20 J/m² to about 30 J/m², about 20 J/m² to about 25 J/m², about 25 J/m² to about 50 J/m², about 25 J/m² to about 45 J/m², about 25 J/m² to about 40 J/m², about 25 J/m² to about 35 J/m², about 25 J/m² to about 30 J/m², about 30 J/m² to about 50 J/m², about 30 J/m² to about 45 J/m², about 30 J/m² to about 40 J/m², about 30 J/m² to about 35 J/m², about 35 J/m² to about 50 J/m², about 35 J/m² to about 45 J/m², about 35 J/m² to about 40 J/m², about 40 J/m² to about 50 J/m², about 40 J/m² to about 45 J/m², about 45 J/m² to 50 J/m², and all ranges and subranges there between. In embodiments, the stored tensile energy can be greater than or equal to 5 J/m², greater than or equal to 10 J/m², greater than or equal to 15 J/m², greater than or equal to 20 J/m², greater than or equal to 25 J/m², greater than or equal to 30 J/m², greater than or equal to 35 J/m², greater than or equal to 40 J/m², or greater than or equal to 45 J/m 2.

In embodiments, the ion-exchange process may cause an increase in weight of the strengthened glass ceramic article compared to the glass ceramic article prior to the ion exchange process. In increase in weight may be a result of exchanging smaller alkali metal ions (Li+, Na+) with larger alkali metal ions having greater molecular weight (e.g., Na+, K+, Cs+, Rb+). In embodiments, the strengthened glass ceramic articles may have a change in weight of greater than or equal to 0.05%, greater than or equal to 0.1%, greater than or equal to 0.2%, greater than or equal to 0.3%, or even greater than or equal to 0.4% compared to the weight of the glass ceramic article prior to ion-exchange.

Properties of the Glass Ceramic Articles

In embodiments, the glass ceramic articles, after 3D forming, may have a thickness in a range from 0.2 mm to 4 mm, 0.2 mm to 3 mm, 0.2 mm to 2 mm, 0.2 mm to 1.5 mm, 0.2 mm to 1 mm, 0.2 mm to 0.9 mm, 0.2 mm to 0.8 mm, 0.2 mm to 0.7 mm, 0.2 mm to 0.6 mm, 0.2 mm to 0.5 mm, 0.3 mm to 4 mm, 0.3 mm to 3 mm, 0.3 mm to 2 mm, 0.3 mm to 1.5 mm, 0.3 mm to 1 mm, 0.3 mm to 0.9 mm, 0.3 mm to 0.8 mm, 0.3 mm to 0.7 mm, 0.3 mm to 0.6 mm, 0.3 mm to 0.5 mm, 0.4 mm to 4 mm, 0.4 mm to 3 mm, 0.4 mm to 2 mm, 0.4 mm to 1.5 mm, 0.4 mm to 1 mm, 0.4 mm to 0.9 mm, 0.4 mm to 0.8 mm, 0.4 mm to 0.7 mm, 0.4 mm to 0.6 mm, 0.5 mm to 4 mm, 0.5 mm to 3 mm, 0.5 mm to 2 mm, 0.5 mm to 1.5 mm, 0.5 mm to 1 mm, 0.5 mm to 0.9 mm, 0.5 mm to 0.8 mm, 0.5 mm to 0.7 mm, 0.8 mm to 4 mm, 0.8 mm to 3 mm, 0.8 mm to 2 mm, 0.8 mm to 1.5 mm, 0.8 mm to 1 mm, 1 mm to 2 mm, 1 mm to 1.5 mm, and all ranges and subranges therebetween. In some embodiments, the glass ceramic articles may be substantially planar and flat. In other embodiments, the glass ceramic article may be shaped, for example the glass ceramic article may have a 2.5D or 3D shape. In embodiments, the glass ceramic article may have a uniform thickness, and in other embodiments, the glass ceramic article may not have a uniform thickness.

In embodiments, the glass ceramic article may have a fracture toughness in a range from 1.0 MPa√m to 2.0 MPa√m, 1.1 MPa√m to 2.0 MPa√m, 1.2 MPa√m to 2.0 MPa√m, 1.3 MPa√m to 2.0 MPa√m, 1.4 MPa√m to 2.0 MPa√m, 1.5 MPa√m to 2.0 MPa√m, 1.0 MPa√m to 1.9 MPa√m, 1.1 MPa√m to 1.9 MPa√m, 1.2 MPa√m to 1.9 MPa√m, 1.3 MPa√m to 1.9 MPa√m, 1.4 MPa√m to 1.9 MPa√m, 1.5 MPa√m to 1.9 MPa√m, 1.0 MPa√m to 1.8 MPa√m, 1.1 MPa√m to 1.8 MPa√m, 1.2 MPa√m to 1.8 MPa√m, 1.3 MPa√m to 1.8 MPa√m, 1.4 MPa√m to 1.8 MPa√m, 1.5 MPa√m to 1.8 MPa√m, and all ranges and subranges there between. In embodiments, the fracture toughness of the glass-ceramic article may be greater than or equal to 1.0 MPa√m, greater than or equal to 1.1 MPa√m, greater than or equal to 1.2 MPa√m, greater than or equal to 1.3 MPa√m, greater than or equal to 1.4 MPa√m, greater than or equal to 1.5 MPa√m, greater than or equal to 1.6 MPa√m, greater than or equal to 1.7 MPa√m, greater than or equal to 1.8 MPa√m, or greater than or equal to 1.9 MPa√m.

In embodiments, the Young's modulus of the glass ceramic article may be in a range from 90 GPa to 110 GPa, 90 GPa to 105 GPa, 90 GPa to 103 GPa, 90 GPa to 100 GPa, 95 GPa to 110 GPa, 95 GPa to 105 GPa, 95 GPa to 103 GPa, 95 GPa to 100 GPa, 100 GPa to 110 GPa, 100 GPa to 105 GPa, 100 GPa to 103 GPa, 103 GPa to 110 GPa, 103 GPa to 105 GPa, or 105 GPa to 110 GPa, and all ranges and subranges there between. In embodiments, the Young's modulus of the glass-ceramic article is greater than or equal to 90 GPa, greater than or equal to 91 GPa, greater than or equal to 92 GPa, greater than or equal to 93 GPa, greater than or equal to 94 GPa, greater than or equal to 95 GPa, greater than or equal to 96 GPa, greater than or equal to 97 GPa, greater than or equal to 98 GPa, greater than or equal to 99 GPa, greater than or equal to 100 GPa, greater than or equal to 101 GPa, greater than or equal to 102 GPa, greater than or equal to 103 GPa, greater than or equal to 104 GPa, greater than or equal to 105 GPa, greater than or equal to 106 GPa, greater than or equal to 107 GPa, greater than or equal to 108 GPa, or greater than or equal to 109 GPa.

In embodiments, the glass ceramic articles may have a shear modulus in a range from 35 GPa to 50 GPa, from 35 GPa to 45 GPa, from 35 GPA to 43 GPa, from 35 GPa to 41 GPa, from 38 GPa to 50 GPa, from 38 GPa to 45 GPa, from 38 GPa to 43 GPa, from 38 GPa to 41 GPa, from 41 GPa to 50 GPa, from 41 GPa to 45 GPa, from 41 GPa to 43 GPa, from 43 GPa to 105 GPa, 90 GPa to 103 GPa, 90 GPa to 100 GPa, 95 GPa to 110 GPa, 95 GPa to 105 GPa, 43 GPa to 50 GPa, 43 GPa to 45 GPa, or from 45 GPa to 50 GPa, and all ranges and subranges therebetween. In embodiments, the glass ceramic article may have a shear modulus of greater than or equal to 35 GPa, greater than or equal to 36 GPa, greater than or equal to 37 GPa, greater than or equal to 38 GPa, greater than or equal to 39 GPa, greater than or equal to 40 GPa, greater than or equal to 41 GPa, greater than or equal to 42 GPa, greater than or equal to 43 GPa, greater than or equal to 44 GPa, greater than or equal to 45 GPa, greater than or equal to 46 GPa, greater than or equal to 47 GPa, greater than or equal to 48 GPa, or greater than or equal to 49 GPa.

In embodiments, the glass ceramic articles may have a Poisson's ratio of from about 0.19 to about 0.24, such as about 0.19, 0.20, 0.21, 0.22, 0.23, or 0.24, and all ranges and subranges therebetween.

In embodiments, upon application of the Fragment Test (based on a 50 mm by 50 mm by 0.8 mm sample) described above, the glass ceramic article may break into less than 5 fragments, less than 4 fragments, or less than 3 fragments.

In embodiments, by using the ceramming cycles, glass precursor compositions, setter configurations, stack configurations, and 3D forming processes disclosed and described herein, the glass ceramic articles formed may have stress of less than 30 nm of retardation per mm of sheet thickness, such as less than 28 nm of retardation per mm of sheet thickness, less than 26 nm of retardation per mm of sheet thickness, less than 25 nm of retardation per mm of sheet thickness, less than 24 nm of retardation per mm of sheet thickness, less than 22 nm of retardation per mm of sheet thickness, less than 20 nm of retardation per mm of sheet thickness, less than 18 nm of retardation per mm of sheet thickness, less than 16 nm of retardation per mm of sheet thickness, or less than 15 nm of retardation per mm of sheet thickness. In embodiments, the glass ceramic articles formed may have a stress from 15 nm to 30 nm of retardation per mm of sheet thickness, such as from 18 nm to 30 nm of retardation per mm of sheet thickness, from 20 nm to 30 nm of retardation per mm of sheet thickness, from 22 nm to 30 nm of retardation per mm of sheet thickness, from 24 nm to 30 nm of retardation per mm of sheet thickness, or from 28 nm to 30 nm of retardation per mm of sheet thickness. In embodiments, the glass ceramic articles formed may have a stress from 15 nm to 25 nm of retardation per mm of sheet thickness, from 18 nm to 25 nm of retardation per mm of sheet thickness, from 20 nm to 25 nm of retardation per mm of sheet thickness, or from 22 nm to 25 nm of retardation per mm of sheet thickness.

In embodiments, the glass ceramic articles exhibit transparency (i.e., the glass-ceramic is transparent) over the visible light range. In embodiments, the transparent glass ceramic article, having a thickness of 1 mm, can have a transmittance of >90% of light (including surface reflection losses) over the wavelength range from about 400 nm to about 1,000 nm, or from about 400 nm to about 600 nm. In embodiments, the average transmittance for a transparent glass ceramic article disclosed herein can be about 85% or greater, about 86% or greater, about 87% or greater, about 88% or greater, about 89% or greater, about 90% or greater, about 91% or greater, about 92% or greater, about 93% or greater (including surface reflection losses) of light over the wavelength range of about 400 nm to about 1000 nm for a glass ceramic article having a thickness of 1 mm. In embodiments, glass ceramic articles may be translucent over the visible light range. In embodiments, the average transmittance for the transparent glass ceramic article disclosed herein can be about 85% or greater, about 86% or greater, about 87% or greater, about 88% or greater, about 89% or greater, about 90% or greater, about 91% or greater, about 92% or greater, about 93% or greater (including surface reflection losses) of light over the wavelength range of about 400 nm to about 600 nm for a glass ceramic article having a thickness of 1 mm.

In embodiments, by using the ceramming cycles, glass precursor compositions, setter configurations, stack configurations, and 3D forming processes disclosed and described herein, the glass ceramic articles formed may have a haze that meets the following equation:

haze (%)<0.0994t+0.12.

In the above equation, t is the thickness (mm) of the glass ceramic article.

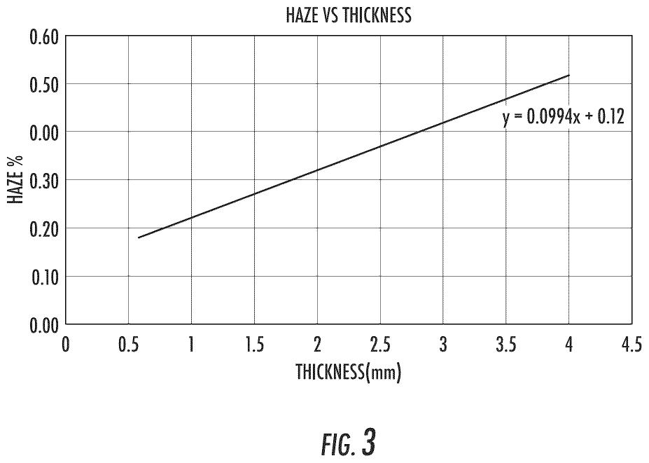

The equation above was determined experimentally as shown in FIG. 3. According to embodiments, by using the ceramming cycles, glass precursor compositions, setter configurations, stack configurations, and 3D forming processes disclosed and described herein, the glass ceramic articles formed may have a haze of less than 0.30 at 0.8 mm thickness, such as less than 0.28 at 0.8 mm thickness, less than 0.26 at 0.8 mm thickness, less than 0.24 at 0.8 mm thickness, less than 0.22 at 0.8 mm thickness, less than 0.20 at 0.8 mm thickness, less than 0.18 at 0.8 mm thickness, less than 0.16 at 0.8 mm thickness, less than 0.14 at 0.8 mm thickness, less than 0.12 at 0.8 mm thickness, or less than 0.10 at 0.8 mm thickness. In embodiments, glass ceramic articles formed may have a haze from 0.10 to 0.28 at 0.8 mm thickness, such as from 0.10 to 0.26 at 0.8 mm thickness, from 0.10 to 0.24 at 0.8 mm thickness, from 0.10 to 0.22 at 0.8 mm thickness, from 0.10 to 0.20 at 0.8 mm thickness, from 0.10 to 0.18 at 0.8 mm thickness, from 0.10 to 0.16 at 0.8 mm thickness, from 0.10 to 0.14 at 0.8 mm thickness, or from 0.10 to 0.12 at 0.8 mm thickness. In embodiments, glass ceramic articles formed may have a haze from 0.10 to 0.20 at 0.8 mm thickness. The haze of glass ceramic articles is measured on the glass ceramic article itself without coatings or other alterations.

In embodiments, by using the ceramming cycles, glass precursor compositions, setter configurations, stack configurations, and 3D forming processes disclosed and described herein, the glass ceramic articles formed may have a haze that meets the following equation:

transmission (%)>0.91×10(2−0.03t).

In the above equation, t is the thickness (in mm) of the glass ceramic article.

According to embodiments, by using the ceramming cycles, glass precursor compositions, setter configurations, stack configurations, and 3D forming processes disclosed and described herein, the glass ceramic articles formed may have an optical transmission of electromagnetic radiation wavelengths from 450 nm to 800 nm measured at a thickness of 0.8 mm of greater than 85%, greater than 88%, greater than 90%, greater than 93%, greater than 95%, or greater than 98%. In embodiments, glass ceramic articles formed may have an optical transmission of electromagnetic radiation wavelengths from 450 nm to 800 nm measured at a thickness of 0.8 mm of from greater than 75% to 95%, such as from greater than 75% to 93%, from greater than 75% to 90%, from greater than 75% to 88%, from greater than 75% to 85%, from greater than 75% to 83%, from greater than 75% to 80%, or from greater than 75% to 78%. As discussed previously herein, the transmission of glass ceramic articles is measured on the glass ceramic article itself without coatings or other alterations. In addition, the transmission percentage disclosed herein is the percent of transmission of electromagnetic radiation at each wavelength of electromagnetic radiation within the range of 450 nm to 800 nm.

In embodiments, the glass ceramic articles may have index of refraction (RI) of from about 1.5 to about 1.6, or about 1.54 to about 1.55, and all ranges and subranges therebetween, when measured according to the test methods provided herein and using light having wavelength of 589.3 nm. In embodiments, the glass ceramic articles may have an RI of about 1.50, about 1.51, about 1.52, about 1.53, about 1.54, about 1.55, about 1.56, about 1.57, about 1.58, about 1.59, or about 1.60 for light having a wavelength of 589.3 nm.

In embodiments, the glass ceramic articles may have a stress optical coefficient (SOC) of from about 2.60 nm/mm/MPa to 2.75 nm/mm/MPa, such as from about 2.60 nm/mm/MPa to about 2.74 nm/mm/MPa, from about 2.60 nm/mm/MPa to about 2.73 nm/mm/MPa, from about 2.60 nm/mm/MPa, to about 2.72 nm/mm/MPa, from about 2.60 nm/mm/MPa to about 2.71 nm/mm/MPa, from about 2.63 nm/mm/MPa, to about 2.75 nm/mm/MPa, from about 2.63 nm/mm/MPa to about 2.74 nm/mm/MPa, from about 2.63 nm/mm/MPa to about 2.73 nm/mm/MPa, from about 2.63 nm/mm/MPa, to about 2.72 nm/mm/MPa, or from about 2.63 nm/mm/MPa to about 2.71 nm/mm/MPa, and all ranges and subranges therebetween.

End Products

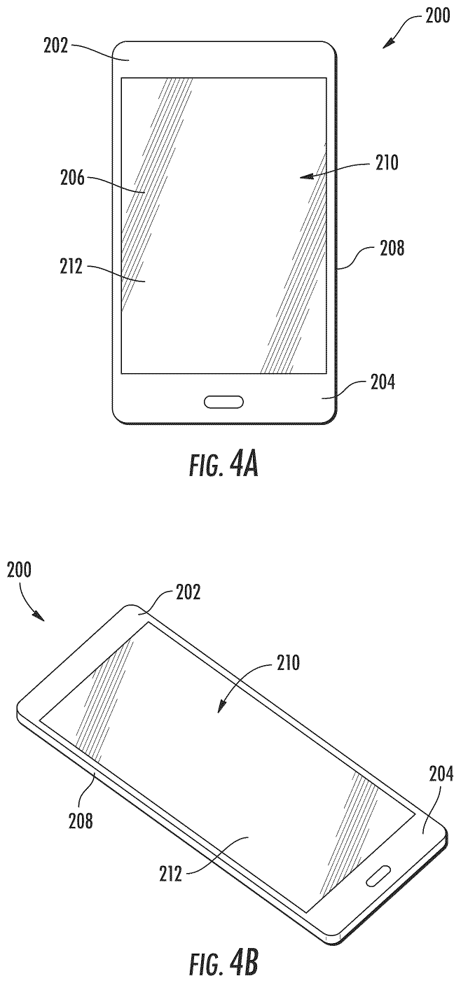

The glass ceramic articles disclosed herein may be incorporated into another article such as an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc. for example for use an interior display cover, a window, or windshield), appliance articles, or any article that requires some transparency, scratch-resistance, abrasion resistance, or a combination thereof. An exemplary article incorporating any of the strengthened glass-ceramic articles disclosed herein is shown in FIGS. 4A and 4B. Specifically, FIGS. 4A and 4B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In some embodiments, at least one of the cover substrate 212 or a portion of housing 202 may include any of the strengthened glass ceramic articles disclosed herein.

Accordingly, various embodiments described herein may be employed to produce glass ceramic articles having excellent optical quality while not adversely impacting, or even improving, stress in the glass ceramic articles as compared to glass articles cerammed according to conventional techniques. Such glass ceramic articles may be particularly well-suited for use in portable electronic devices due to their strength performance and high transmission values.

### EXAMPLES

The embodiments of the glass ceramic articles and methods for producing the glass ceramic articles of the present disclosure will be further clarified by the following examples.

### Examples 1-10 and Comparative Examples 11 and 12

Examples of the glass ceramic precursor compositions (in terms of wt %) and the ceramming conditions for achieving transparent glass ceramic articles of the present disclosure are set forth in the Table 1 and are determined in accordance with techniques conventional in the glass art. Precursor glasses were formed having the glass compositions 1-10 listed in Table 1. The precursor glasses were then subjected to a ceramming cycle having a glass homogenization hold and a crystallization hold. The homogenization hold temperature and time period and the crystallization hold temperature and time period for each of Examples 1-10 are provided in Table 1. The following nomenclature was used in Table 1 to describe the ceramming cycle: nucleation temperature−hold time/crystallization temperature−hold time.

Additionally, two comparative glass ceramic compositions were prepared. The comparative glass ceramics of Comparative Examples 11 and 12 include less than 0.5 mol % alkali metal oxides (Na₂O and K₂O), molar ratios of alkali metal oxides to alumina (Al₂O₃) of less than 0.1, and molar ratios of alkali metal oxides to zirconia (Zr₂O) of less than 0.3. Additionally, the comparative glass ceramics of Comparative Examples 11 and 12 include less than 0.1 mol % RO (ZnO, CaO, MgO, SrO, and BaO), molar ratios of RO to alumina of less than 0.05, and molar ratios of RO of less than 0.1.

TABLE 1

| Composition | 1 | 2 | 3 | 4 | 5 | 6 |
|---|---|---|---|---|---|---|
| SiO₂ (mol %) | 69.66 | 69.41 | 68.91 | 69.51 | 69.01 | 69.01 |
| Al₂O₃ (mol %) | 3.7 | 3.7 | 3.7 | 3.7 | 3.7 | 3.7 |
| Li₂O (mol %) | 20.53 | 20.53 | 20.53 | 20.53 | 21.53 | 21.53 |
| ZrO₂ (mol %) | 2.42 | 2.42 | 2.42 | 2.42 | 2.92 | 2.92 |
| P₂O₅ (mol %) | 0.97 | 0.97 | 0.97 | 0.87 | 0.87 | 0.87 |
| Na₂O (mol %) | 1.17 | 1.17 | 1.17 | 1.17 | 1.00 | 0.73 |
| K₂O (mol %) | 0.73 | 0.73 | 0.73 | 0.73 | 0.9 | 1.17 |
| CaO (mol %) | 0.02 | 0.02 | 0.02 | 0.02 | 0.02 | 0.02 |
| Fe₂O₃ (mol %) | 0.02 | 0.02 | 0.02 | 0.02 | 0.02 | 0.02 |
| HfO₂ (mol %) | 0.03 | 0.03 | 0.03 | 0.03 | 0.03 | 0.03 |
| SnO₂(mol %) | 0 | 0 | 0 | 0 | 0 | 0 |
| TiO₂ (mol %) | 0.75 | 1.00 | 1.50 | 1.00 | 0 | 0 |
| Total | 100 | 100 | 100 | 100 | 100 | 100 |
| [Na₂O + K₂O]/[Al₂O₃] | 0.514 | 0.514 | 0.514 | 0.514 | 0.514 | 0.514 |
| [Na₂O + K₂O]/[ZrO₂] | 0.785 | 0.785 | 0.785 | 0.785 | 0.651 | 0.651 |
| [RO]/[Al₂O₃]* | 0.005 | 0.005 | 0.005 | 0.005 | 0.005 | 0.005 |
| [RO]/[ZrO₂]* | 0.008 | 0.008 | 0.008 | 0.008 | 0.007 | 0.007 |
| Ceramming Cycle | 580-4/ | 580-4/ | 580-4/ | 580-4/ | 580-4/ | 580-4/ |
| | 750-2 | 750-3 | 750-4 | 750-5 | 750-6 | 750-7 |
| Phase assemblage | Lithium | Lithium | Lithium | Lithium | Lithium | Lithium |
| | disilicate/ | disilicate/ | disilicate/ | disilicate/ | disilicate/ | disilicate/ |
| | petalite | petalite | petalite | petalite | petalite | petalite |
| Appearance | Clear, | Clear, | Clear, | Clear, | Clear, | Clear, |
| | transparent | transparent | transparent | transparent | transparent | transparent |
| Density (g/cm³) | 2.435 | 2.441 | 2.449 | 2.440 | 2.443 | 2.443 |
| Elastic Modulus (GPa) | 100.9 | 100.3 | 100.7 | 100.6 | 101.4 | 100.8 |
| Shear Modulus (GPa) | 42.0 | 41.9 | 42.0 | 42.0 | 42.2 | 41.9 |
| Poisson's Ratio | 0.200 | 0.198 | 0.199 | 0.198 | 0.202 | 0.202 |
| K1c (MPa*m^{0.5}) | 1.13 | 1.22 | 1.17 | 1.14 | 1.18 | 1.12 |
| SOC (nm/mm/MPa) | 2.670 | 2.685 | 2.704 | 2.684 | 2.641 | 2.674 |
| RI at 589.3 nm | 1.5440 | 1.5457 | 1.5490 | 1.5454 | 1.5438 | 1.5431 |
| | | | | | Comparative | Comparative |
| Composition | 7 | 8 | 9 | 10 | 11 | 12 |
| SiO₂ (mol %) | 70.34 | 68.57 | 68.29 | 68.63 | 70.6 | 68.98 |
| Al₂O₃ (mol %) | 4.2 | 3.70 | 3.64 | 3.63 | 4.2 | 4.03 |
| Li₂O (mol %) | 21.36 | 22.22 | 22.33 | 21.62 | 22.1 | 22.3 |
| ZrO₂ (mol %) | 1.69 | 2.78 | 2.66 | 2.40 | 2 | 2.78 |
| P₂O₅ (mol %) | 0.87 | 0.84 | 0.84 | 0.85 | 0.9 | 1.01 |
| Na₂O (mol %) | 1.47 | 0.71 | 0.70 | 1.04 | 0 | 0.06 |
| K₂O (mol %) | 0 | 1.10 | 1.10 | 0.78 | 0 | 0.07 |
| CaO (mol %) | 0.02 | 0 | 0 | 0 | 0 | 0.71 |
| Fe₂O₃ (mol %) | 0.02 | 0 | 0 | 0 | 0.03 | 0.02 |
| HfO₂ (mol %) | 0.03 | 0 | 0 | 0 | 0.02 | 0.03 |
| SnO₂(mol %) | 0 | 0.09 | 0.09 | 0.09 | 0.15 | 0.01 |
| TiO₂ (mol %) | 0 | 0 | 0.36 | 0.95 | 0 | 0 |
| Total | 100 | 100 | 100 | 100 | 100 | 100 |
| [Na₂O + K₂O]/[Al₂O₃] | 0.350 | 0.525 | 0.534 | 0.447 | 0 | 0.032 |
| [Na₂O + K₂O]/[ZrO₂] | 0.870 | 0.650 | 0.677 | 0.756 | 0 | 0.047 |
| [RO]/[Al₂O₃]* | 0.005 | 0 | 0 | 0 | 0 | 0.176 |
| [RO]/[ZrO₂]* | 0.012 | 0 | 0 | 0 | 0 | 0.255 |
| Ceramming Cycle | 560-4/ | 560-4/ | 560-4/ | 560-4/ | 570-4/ | 580-4/ |
| | 720-1 | 740-1 | 740-1 | 740-1 | 740-1 | 740-1 |
| Phase assemblage | Lithium | Lithium | Lithium | Lithium | Lithium | Lithium |
| | disilicate/ | disilicate/ | disilicate/ | disilicate/ | disilicate/ | disilicate/ |
| | petalite | petalite | petalite | petalite | petalite | petalite |
| Appearance | Clear, | Clear, | Clear, | Clear, | Clear, | Clear, |
| | transparent | transparent | transparent | transparent | transparent | transparent |
| Density (g/cm³) | 2.402 | 2.443 | 2.446 | 2.445 | 2.41 | 2.41 |
| Elastic Modulus (GPa) | 102.9 | 102.4 | 101.77 | 102.6 | 102.7 | 104 |
| Shear Modulus (GPa) | 41.5 | 42.50 | 42.34 | 42.60 | 43.02 | 43 |
| Poisson's Ratio | 0.196 | 0.203 | 0.202 | 0.203 | 0.194 | 0.19 |
| K1c (MPa*m^{0.5}) | 1.13 | 1.15 | 1.18 | 1.21 | 1.141 | 1.16 |
| SOC (nm/mm/MPa) | 2.650 | 2.63 | 2.652 | 2.636 | 2.614 | 2.62 |
| RI at 589.3 nm | 1.5400 | 1.5450 | 1.547 | 1.549 | 1.541 | 1.548 |

*In Table 1, the term [RO] represents the combined molar concentration of ZnO, CaO, MgO, BaO, and SrO.

Several tests were done on the glass ceramics in Table 1 after ceramming to determine a variety of properties for the glass ceramics of Examples 1-10 and Comparative Examples 11 and 12. In particular, the glass ceramics of Examples 1-10 and Comparative Examples 11 and 12 were tested to determine the density, elastic modulus, shear modulus, Poisson's ratio, fracture toughness (Klc), SOC, and index of refraction (RI) at 589.3 nm according to the test methods described previously in this disclosure and the results are reported in Table 1.

As can be seen in Table 1, the glass ceramics of the present disclosure include contain Na₂O and K₂O in the parent glass in quantities greater than 0.5 mol % or even greater than 1.3 mol %. These alkali metal constituents, as well as the ZrO₂, did not incorporate into the crystalline phases Lithium disilicate (Li₂O₅Si₂) or petalite (LiAlSi₄O₁₀) and were, thus, remaining in the residual glassy phase after the ceram process. Na₂O and K₂O are constituents that lower the viscosity of a glass, while Al₂O₃ and ZrO₂ tend to increase the viscosity. Therefore, after ceramming, since Na₂O, K₂O, and ZrO₂ do not enter the crystalline phases in these glass-ceramics, and part of the Al₂O₃ may also remain in the residual glass phase, precursor glasses with greater concentrations of alkali metal oxides (Na₂O+K₂O[) and greater molar ratios [Na₂O+K₂O]/[Al₂O₃] and [Na₂O+K₂O]/ZrO₂] produced glass-ceramics in which the residual glass phase exhibited lower viscosity. In addition, increased amounts of Na₂O+K₂O and ZrO₂ led to formation of an increased concentration of glass phase in the transparent glass-ceramics produced in Examples 1-3.

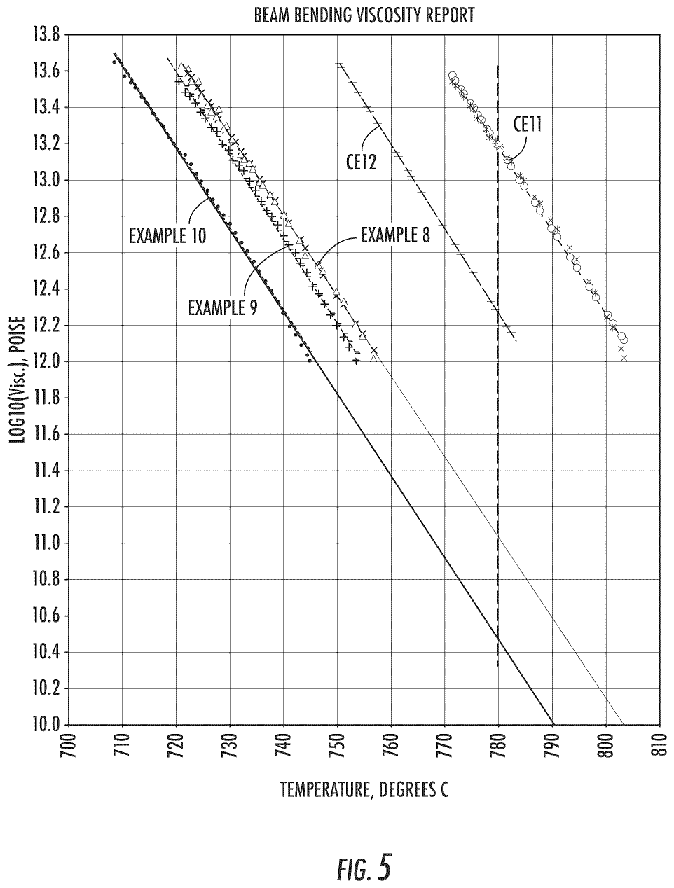

The viscosity of the glass-ceramics of Example Compositions 8-10 and the comparative glass ceramics of Comparative Examples 11 and 12 were measured in the 700° C. to 800° C. temperature range using Beam Bending Viscosimetry (BBV) according to the standard method in ASTM C598-93, which is incorporated by reference herein in its entirety. Referring to FIG. 5, the BBV viscosity results for the glass ceramics of Examples 8-10 and Comparative Examples 11 and 12 are graphically depicted. Each of the glass ceramics of Examples 8-10 and Comparative Examples 11 and 12 had different contents of Na₂O and difference molar ratios of [Na₂O+K₂O]/[Al₂O₃] and [Na₂O+K₂O]/[ZrO₂]. As shown in FIG. 5, the glass ceramics having the greatest amounts of Na₂O and greatest molar ratios of [Na₂O+K₂O]/[Al₂O₃] and [Na₂O+K₂O]/[ZrO₂] show the lowest viscosities. The glass ceramics of Examples 8-10, after ceramming, exhibited a viscosity at 780° C. (˜10⁻¹¹) that was up to 2 orders of magnitude lower than the viscosity of the glass ceramic of Comparative Example 11 (˜10^{13.2}), which had no Na₂O or K₂O. The glass ceramic of Comparative Example 12 had small amounts of Na₂O (0.06 mol %) and K₂O (0.07 mol %), and these small amounts of the Na₂O and K₂O enabled the glass ceramic of Comparative Example 12 to exhibit a viscosity at 780° C. (˜10^{12.2}) of about 1 order of magnitude lower than the glass ceramic of Comparative Example 11.

Additionally, the crystalline phase assemblage of the glass ceramics of Examples 1-10 and (before ion exchange) and weight percentage of the crystalline phases and residual glass phase were determined through x-ray diffraction (XRD) using a Rietveld analysis, according the methods described herein. The results of the phase assemblage and weight percentages of the primary crystalline phases and the residual glass phase are provided in Table 2.

TABLE 2

| | | | Residual | Lithium | |
|---|---|---|---|---|---|
| | | | Glass | Disilicate | Petalite |
| | Ceramming | | Phase | Phase | Phase |
| Example | Conditions | Appearance | (wt. %) | (wt. %) | (wt. %) |
| 1 | 580-4/750-1 | Light purple, | 28 | 40 | 31 |
| | | transparent | | | |
| 2 | 580-4/750-1 | Light purple, | 28 | 39 | 32 |
| | | transparent | | | |
| 3 | 580-4/750-1 | purple, transparent | 26 | 40 | 33 |
| 4 | 580-4/750-1 | Clear, transparent | 25 | 43 | 31 |
| 5 | 580-4/750-1 | Clear, transparent | 31 | 41 | 28 |
| 6 | 580-4/750-1 | Clear, transparent | 32 | 42 | 26 |
| 7 | 560-4/720-1 | Clear, transparent | 15 | 47 | 38 |
| Comparative | 570-4/740-1 | Clear, transparent | 12 | 44 | 44 |
| Example 11 | | | | | |

Forming Process

Certain glass ceramics of Examples 7 and 8 and Comparative Examples 11 and 12 were subjected to a post-ceraming 3D forming process to convert the glass ceramic sheets to glass ceramic articles having a shape different from the glass ceramic sheet. The 3D forming process included a high temperature thermal forming press developed to make repeatable and production-quality glass ceramic articles. The thermal forming press used in the Examples was a Model DTK-DGP-3D12S cover glass forming press produced by Daeho Technology Korea Co. Ltd. of Gyeongsangnam-do, Korea. The multi-zone thermal forming press operates in an inert atmosphere and makes use of preformed molds, such as graphite molds. The multi-zone thermal forming press sequentially heats the glass ceramic, presses the glass ceramic into a graphite mold, and then cools the glass ceramic article. The 9-zone thermal forming process included 1° C. temperature control, a maximum mold size of 120 mm×180 mm×from 25 mm to 50 mm in thickness, a maximum forming temperature of 850° C., a positive pressing pressure range of from 0.001 MPa to 0.9 MPa.

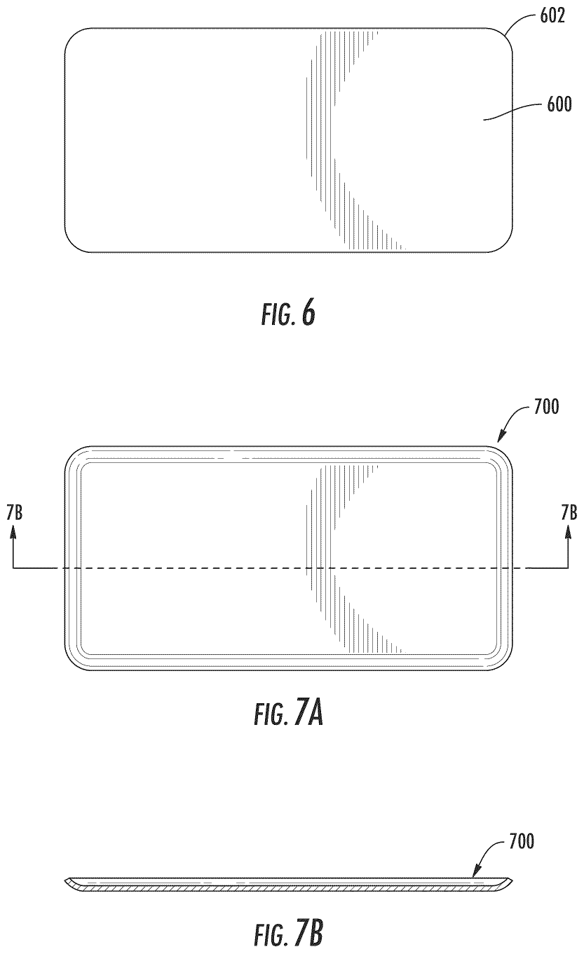

Referring now to FIG. 6, the glass ceramics, after ceramming and before 3D forming, had a pre-form shape 600 comprising a rectangle with rounded corners 602. The graphite mold was shaped to 3D form the glass ceramic preform into a glass ceramic article having a general shape of a cover glass for a personal electronic device. Referring now to FIGS. 7A and 7B, the glass ceramic articles 700 having a 3D shape of a general cover glass is schematically depicted.

The sample glass ceramic articles were made using a two-mold, 14-zone sequential press forming process with each zone having a set temperature, time spent per sample, and an applied pressure. The first 4 zones were dedicated to heating the glass ceramic pre-form sheet to the appropriate temperature that would enable shaping (e.g., ˜780° C.). The subsequent 3 zones were used for forming by applying a pressure to the heated glass ceramic pre-form to conform the glass ceramic to the mold, taking on the prescribed three-dimensional shape. The subsequent zones are used to cool the glass ceramic article and reduce the forming pressure. The total process time for 3D forming was about 40 minutes.

### Examples 13 and 14

For Examples 13 and 14, glass ceramic articles were prepared from the composition of the glass ceramics of Examples 7 and 8. The glass ceramic articles of Examples 13 and 14 were prepared by producing a glass composition comprising the compositions in Table 1 for Examples 7 and 8. The glass was then cerammed according to the ceramming temperatures and durations in Table 1 for Examples 7 and 8 to produce glass ceramic sheets in which most of the crystalline phases are formed. The glass ceramic sheets were then cut into the shape schematically depicted in FIG. 6 to produce the cerammed glass ceramic preform. The cerammed glass ceramic preforms were then subjected to 3D forming according to the forming processes previously described in these examples to produce the glass ceramic articles of Examples 13 and 14.

### Comparative Example 15

For Comparative Example 15, a glass ceramic article was prepared from the composition of Example 8 by nucleating the crystalline phase and then 3D forming the glass ceramic article. In Comparative Example 15, the glass composition was only nucleated to start the formation of crystallization phases, but was not cerammed to form the primary crystalline phases prior to 3D forming. Thus, prior to 3D forming, the nucleated glass preform was primarily glass phase with very little crystalline phase. For Comparative Example 15, crystallization occurred during 3D forming, specifically during heating and pressing the glass-preform to produce the glass ceramic article of Comparative Example 15. The 3D forming was conducted according to the method previously discussed in these examples.

### Comparative Example 16

In Comparative Example 16, a glass ceramic article was prepared from the composition of Comparative Example 12 by ceramming a glass composition comprising the constituents listed in Table 1 for Comparative Example 12 to produce a glass ceramic preform, and then 3D forming the glass ceramic preform to produce a glass ceramic article. The composition of Comparative Example 12 included Na₂O and K₂O, but the total concentration of Na₂O and K₂O was less than 0.5 mol %, the molar ratio of [Na₂O+K₂O]/[Al₂O₃] was less than 0.1, and the molar ratio of [Na₂O+K₂O]/[ZrO₂] was less than 0.1. As with Examples 13 and 14, the glass ceramic preform in Comparative Example 16 was cerammed to form the primary crystalling phases before 3D forming so that most of the crystalline phases were formed before the 3D forming.

### Comparative Example 17

For Comparative Example 17, the composition of Comparative Example 11 was cerammed and then subjected to the temperature and pressure conditions of the 3D forming process to evaluate changes in phase assemblage at the process conditions. The composition of Comparative Example 11 did not have any alkali metal oxides, alkaline metal oxides, or B₂O₅. Thus, the composition of Comparative Example 11 did not have a low enough viscosity at the forming temperature to be able to be 3D formed according to the method previously described in these examples. As a result, in place of the 3D forming, for Comparative Example 17, a flat sheet of glass ceramic having the composition of Comparative Example 11 was subjected to temperature and pressure conditions, without a mold, to investigate the changes in phase assemblage.

### Comparison of Examples 13 and 14 and Comparative Examples 15-17

The phase assemblage for each of the glass ceramic articles of Examples 13 and 14 and Comparative Examples 15-17 were evaluated based on x-ray diffraction (XRD) using a Rietveld analysis, as discussed in the present disclosure. The phase assemblage for Examples 13 and 14 and Comparative Example 16 were assessed after the ceramming step (2D ceram) and again after the 3D forming step (2D ceram+3D forming). For Comparative Example 15, the phase assemblage was assessed only after the 3D forming and crystallization step. As previously discussed, Comparative Example 17 was not 3D formable, so the phase assemblage was assessed after the ceraming step (2D ceram) and again after subjecting the glass ceramic sheet to the forming temperature and pressure (2D ceram+forming temperature and pressure). The weight percentages of the residual glass phase and each of the crystalline phases for the glass ceramic articles of Examples 13 and 14 and Comparative Examples 15-17 are provided in the following Table 3.

TABLE 3

| | Glass | Glass | | | | | |
|---|---|---|---|---|---|---|---|
| | Comp. | Phase | Li2SiO5 | Petalite | Li2SiO3 | Virgilite | Cristobalite |
| Example | Table 1 | (wt. %) | (wt. %) | (wt. %) | (wt. %) | (wt. %) | (wt. %) |
| Ex. 13 | 7 | 14 | 42 | 44 | 0.0 | 0.0 | 0.0 |
| (2D ceram only) | | | | | | | |
| Ex. 13 | 7 | 21 | 40 | 39 | 0.0 | 0.0 | 0.0 |
| (2D ceram + 3D form) | | | | | | | |
| Ex. 14 | 8 | 20 | 52 | 28 | 0.0 | 0.0 | 0.0 |
| (2D ceram only) | | | | | | | |
| Ex. 14 | 8 | 27 | 48 | 25 | 0.0 | 0.0 | 0.0 |
| (2D ceram + 3D form) | | | | | | | |
| Comp. Ex. 15 | 8 | 37 | 44 | 19 | 0.0 | 0.0 | 0.0 |
| (2D nucleate + | | | | | | | |
| 3D forming/crystallization) | | | | | | | |
| Com. Ex. 16 | 12 | 13 | 45 | 42 | 0.0 | 0.0 | 0.4 |
| (2D ceram only) | | | | | | | |
| Com. Ex. 16 | 12 | 12 | 39 | 46 | 0.0 | 1.0 | 1.9 |
| (2D ceram + 3D forming) | | | | | | | |
| Com. Ex. 17 | 11 | 12 | 45 | 43 | 0.0 | 0.0 | 0.0 |
| (2D ceram only) | | | | | | | |
| Com. Ex. 17 | 11 | 12 | 38 | 49 | 0.0 | 0.0 | 1.3 |
| (2D ceram + forming | | | | | | | |
| temperature and pressure) | | | | | | | |

As shown in Table 3, for each of the glass ceramic articles of Examples 13 and 14, the concentration of the residual glass phase increased and the crystalline phases decreased during the 3D forming step, which was conducted after the glass composition was cerammed to produce the glass ceramic pre-form. The glass ceramic article of Comparative Example 15 has a greater concentration of the residual glass phase. However, the glass ceramic article of Comparative Example 15 exhibited other defects not exhibited by the glass ceramic articles of Examples 13 and 14, as will be discussed in further detail herein. For the glass ceramic articles of Comparative Examples 16 and 17, the concentrations of the residual glass phase stayed the same or decreased and the crystalline phases changed during 3D forming, which is the opposite of the effect demonstrated in the glass ceramic articles of Examples 13 and 14. Thus, when the total concentration of Na₂O and K₂O is greater than or equal to 0.5, the molar ratio of [Na₂O+K₂O]/[Al₂O₃] is greater than or equal to 0.1, and/or the molar ratio of [Na₂O+K₂O]/[ZrO₂] is greater than or equal to 0.3, the concentration of the residual glass phase increases when exposed to the temperature and pressure of the 3D forming process. This effect is not shown in the glass ceramic articles of Comparative Examples 16 and 17, for which the concentration of residual glass phase stayed the same or decreased during 3D forming. The increase in the concentration of the residual glass phase, as in Examples 13 and 14, can provide additional benefits during subsequent ion-exchange of the 3D formed glass ceramic articles, as will be further investigated in these examples.

Physical measurements of the glass ceramic articles of Example 14 and comparative Example 15 were obtained after the 3D forming process and compared against the CAD specification for the articles made. The glass ceramic article of Example 14 formed well in the 2-mold pressing process at a forming temperature of 780° C. and a hold time in the molds of 180 seconds at a pressure of 0.9 MPa. The glass ceramic article of Example 14 exhibited a range of deviation to the CAD specification of about 0.08 mm. The glass ceramic article of Comparative Example 15 also formed well in the 2-mold pressing process at the same conditions and exhibited a range of deviation to the CAD specification of about 0.08 mm.

TABLE 4

| | Example | |
|---|---|---|
| | | Comparative |
| | Example 14 | Example 15 |
| Process | 2D ceram + 3D | 2D nucleation + 3D |
| | forming | forming/crystallize |
| Minimum Shape deviation | −0.05 | −0.05 |
| to CAD (mm) | | |
| Maximum shape deviation | 0.03 | 0.03 |
| to CAD (mm) | | |
| Range of shape deviation | 0.08 | 0.08 |
| to CAD (mm) | | |
| Flatness | 0.08 | 0.08 |
| Long axis bow | 0.03 | 0.03 |
| Short axis bow | −0.02 | −0.02 |
| Center to corner bow | 0.05 | 0.05 |

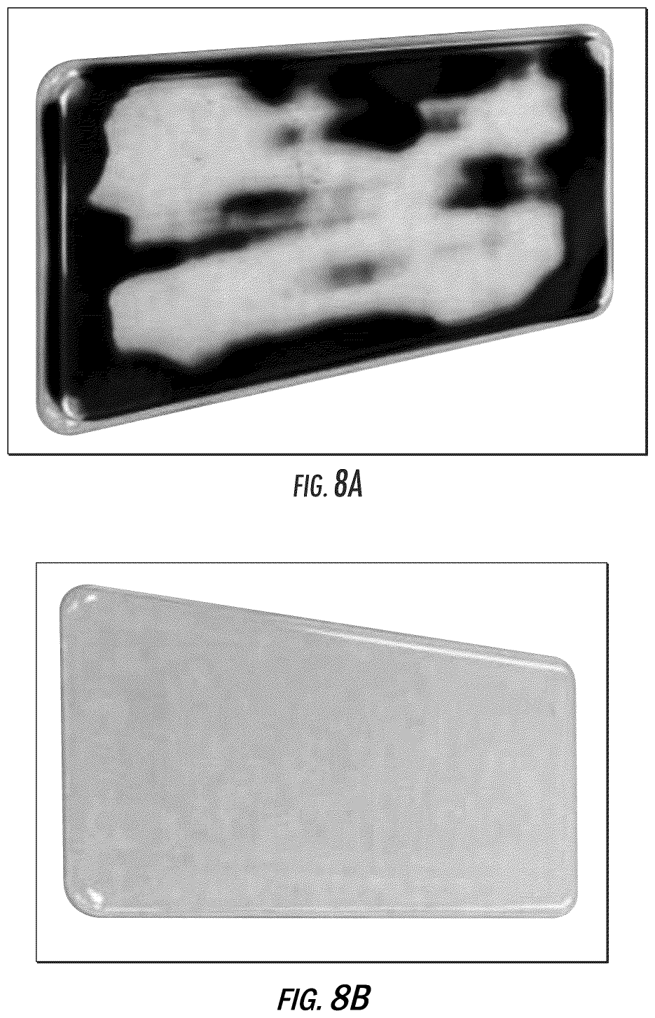

The glass ceramic articles of Example 14 (2D ceram+3D forming) and Comparative Example 15 (2D nucleation+3D forming/crystallization) were evaluated for cosmetic defects. Cosmetically, the glass ceramic article of Example 14, which were prepared by 2D full ceram followed by 3D forming, exhibited much lower surface defects and flaws compared to the glass ceramic article of Comparative Example 15, which was prepared by 2D nucleation followed by simultaneous 3D forming and ceramming. Referring now to FIGS. 8A and 8B, the glass ceramic article of Comparative Example 15 (FIG. 8A) shows more staining compared to the glass ceramic article of Example 14 (FIG. 8B), which is barely visible in FIG. 8B due to the transparency of the glass ceramic article. The dark areas in FIG. 8A are staining areas created during the simultaneous 3D forming and ceramming process. Without being bound by any particular theory, it is believed that the staining is due to glass ceramic movement or shrinkage during the simultaneous 3D forming and ceramming step of Comparative Example 15. At the staining areas, the glass ceramic is physically moving relative to the mold, which creates friction at the interface between the glass ceramic and the graphite mold. This friction and movement scrapes the glass ceramic against the mold surface, which distributes defects into the surface of the glass cermaic. These defects can be removed by downstream polishing processes. The staining further indicates some shrinkage of the glass ceramic article of Comparative Example 15.

Referring to FIG. 8B, the glass ceramic article of Example 14, which was made by ceramming the glass ceramic preform first and then 3D forming, exhibited very little staining. This indicates that during 3D forming of the glass ceramic article of Example 14, there was less shrinkage or physical movement of the glass ceramic article relative to the mold, which resulted in less lower friction between the glass ceramic and mold surface. Thus, the process of ceramming the glass composition to produce a cerammed glass ceramic preform followed by 3D forming the glass ceramic pre-form to produce the glass ceramic article can reduce shrinkage and staining during the 3D forming process compared to only nucleating and accomplishing the ceramming during the 3D forming process. The 2D ceram'd 3D shaped glass ceramic article of Example 14 contained some staining, but the staining was much cleaner and required much less downstream polishing to meet quality specifications.

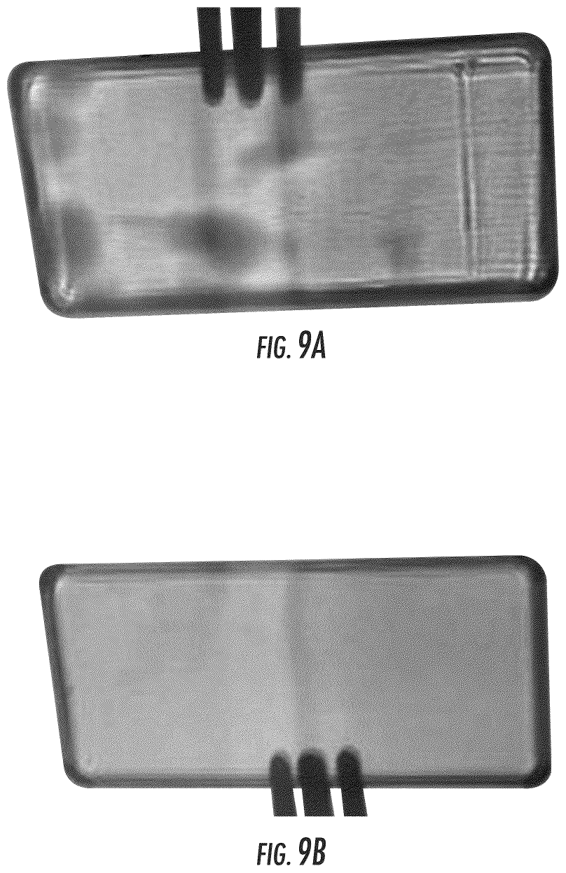

The quality of the surfaces of the glass ceramic articles Example 14 and Comparative Example 16 were further evaluated by using a xenon light to cast a shadow of the glass ceramic surfaces and any deformations through the bulk glass ceramic. FIG. 9A is an image of the shadows produced by passing the xenon light through the glass ceramic article of Comparative Example 15. As shown in FIG. 9A, the shadows produced by passing the xenon light through the glass ceramic article of Comparative Example 16 indicates a significant amount of surface defects in the glass ceramic article. Referring now to FIG. 9B, in contrast, passing the xenon light through the glass ceramic article of Example 14 resulted in very little shadowing, indicating less quality defects on the surface of the glass ceramic article of Example 14 compared to Comparative Example 16.

The difficulty in post-3D-forming finishing of the glass ceramic articles of Example 14 and Comparative Example 15 were evaluated. Post-3D-forming finishing processes can include polishing to remove surface defects. Referring now to FIG. 10, a qualitative assessment of the post-3D-forming finishing of the glass ceramic articles of Examples 14 and Comparative Example 15 are shown in comparison to post-3D-forming finishing of a glass article subjected to 3D forming without nucleation or ceraming. As shown in FIG. 10, the glass ceramic article of Example 14 required less effort to finish the glass ceramic article after the 3D forming process, such as through downstream polishing, compared to the glass ceramic article of Comparative Example 15 and compared to the 3D formed glass article.

As previously discussed in reference to FIGS. 8A and 8B, pre-nucleated glass will move or shrink a considerable amount during the final ceraming crystal growth stage as compared to the glass ceramic that has already been cerammed prior to 3D forming. For glass ceramic articles produced through pre-nucleation followed by the 3D forming and crystallization, as in Comparative Example 15, the crystal growth and shrinking affect occurs simultaneously with the 3D forming process. In this case, the glass is constrained, and thus, increased friction between the glass and the mold occurs. This increased friction along with the natural shrinkage that occurs during crystallization, induces a scraping-like affect creating multiple defects that are imbedding in the glass ceramic surface. This stain can be removed with downstream polishing processes, but this scraping affect will also reduce mold quality life-expectancy.

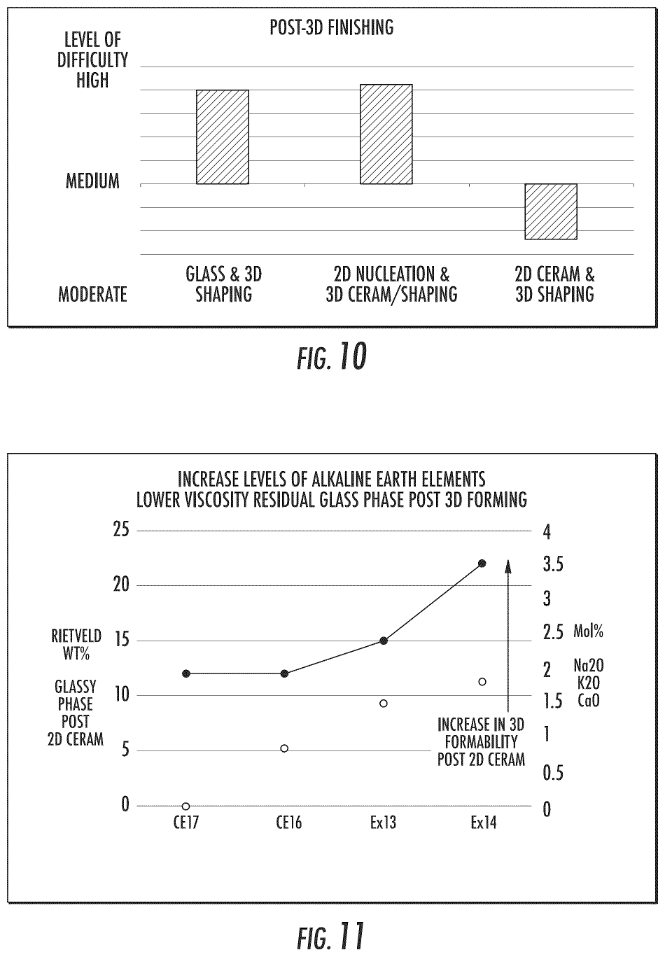

Referring now to FIG. 11, the concentration of residual glass phase after 3D forming (left y-axis) and mol % of non-lithium alkali metal oxides (e.g., Na₂O, K₂O) and alkaline earth metal oxides (e.g., CaO, MgO, BaO, SrO) in the glass compositions (right y-axis) for the glass ceramic articles of Examples 13 and 14 and Comparative Examples 16 and 17 are graphically depicted. As shown in FIG. 11, the weight percentage of the residual glass phase after 3D forming increases with increasing concentration of non-lithium alkali metal oxides, alkaline metal oxides, or both.

The increasing residual glass phase and increasing the concentration of non-lithium alkali metal oxides in the glass ceramic article can increase 3D formability of the glass ceramic following full ceramming the glass ceramic. In particular, increasing the concentration of residual glass phase can reduce the viscosity of the glass ceramic, which improves the 3D formability of the glass ceramics. For the glass ceramic articles of Example 13, which included only around 14 wt. % residual glass phase in the glass ceramic pre-form, the maximum 3D forming temperature was 800° C., and the maximum 3D forming temperature for the glass ceramic article of Example 14, which included around 20 wt. % residual glass phase in the glass ceramic pre-form, was about 780° C. Thus, increasing the concentration of the residual glass phase in the glass ceramic preform can enable reducing the 3D forming temperature. Further, the glass ceramic article of Comparative Example 16 required greater 3D forming temperature of 815° C., compared to the maximum 3D forming temperature of 800° C. for the glass ceramic articles of Examples 13 and 14. As previously discussed, the glass ceramic pre-form of Comparative Example 17, which did not include any non-lithium alkali metal oxides or alkaline metal oxides, was not 3D formable without breaking the glass ceramic pre-form. Without being bound by any particular theory, it is believed that the 0.71 mol % CaO in the composition of the glass ceramic article of Comparative Example 16 was enough to help reduce the viscosity in the residual glass phase to allow the glass ceramic pre-form of Comparative Example 16 to be 3D formed, as compared to the glass ceramic of Comparative Example 17, which was not 3D formable and only included about 0.03 mol % CaO mostly from impurities.

Without being bound by any particular theory, it is believed that the greater concentration of non-lithium alkali metal oxides (i.e., [Na₂O+K₂O]), greater molar ratios of [Na₂O+K₂O]/[Al₂O₃] and [Na₂O+K₂O]/[ZrO₂], and/or greater concentration of alkaline earth metal oxides lower the viscosity of the residual glass phase and of the glass ceramic overall in the 3D forming temperature ranges, which enables 3D forming of the cerammed glass ceramic preforms. Glass ceramics with little or no non-lithium alkali metal oxides or alkaline metal oxide and/or lower or zero molar ratios of [Na₂O+K₂O]/[Al₂O₃] and [Na₂O+K₂O]/[ZrO₂], such as with the glass ceramic of Comparative Example 17, do not enable the 3D forming of the glass ceramics after ceramming the glass to produce the majority of the crystalline phases. Without the non-lithium alkali metal oxides and/or alkaline earth metal oxides, the viscosities of the residual glass phase and of the glass ceramic overall are too high, and the pre-forms cannot be thermally formed into the desired shape without breaking.

### Example 18—Ion Exchange of Glass Ceramic Articles of Example 14

In Example 18, the glass ceramic articles of Example 14, before and after 3D forming, were ion-exchanged to investigate the effects of increasing the concentration of the residual glass phase during 3D forming on the ion-exchange process and the resulting properties of the strengthened glass articles made therefrom. In Example 18, the glass ceramic articles of Example 14, which had the composition of Example 8, were subjected to an ion-exchange process, before and after 3D forming, wherein the glass ceramic article was placed in a molten salt bath comprising NaNO₃, LiNO₃, and KNO₃. The concentration of each constituent of the molten salt bath is provided in Table 5. The samples had a thickness of 0.5 mm or 0.6 mm, as indicated in Table 5. The glass ceramic articles, before and after 3D forming, were ion-exchanged at an ion-exchange temperature of 500° C. for the period of time specified in Table 5. Following ion-exchange, the strengthened glass articles were evaluated for FSM compression stress (CS), FSM depth of compression (DOC), direct CS, count, weight gain, SCALP midpoint central tension (CT), and SCALP maximum CT, the values of which are provided below in Table 5.

TABLE 5

| | 18A | 18B | 18C | 18D |
|---|---|---|---|---|
| Composition | Example 8 | Example 8 | Example 8 | Example 8 |
| Process Stage | Cerammed | Cerammed and | Cerammed | Cerammed and |
| | Only | 3D Formed | Only | 3D formed |
| Residual glass phase (wt. %) | 20 | 27 | 20 | 27 |
| Sample Thickness (mm) | 0.5 | 0.5 | 0.5 | 0.5 |
| NaNO₃ (wt. % in bath) | 40 | 40 | 25 | 25 |
| LiNO₃ (wt. % in bath) | 0.5 | 0.5 | 0.5 | 0.5 |
| KNO₃ (wt. % in bath) | 59.5 | 59.5 | 74.5 | 74.5 |
| IOX temperature (° C.) | 500 | 500 | 500 | 500 |
| IOX time (hours) | 2.43 | 2.43 | 2.43 | 2.43 |
| FSM LED (nm) | 365 | 365 | 365 | 365 |
| FSM CS (MPa) | 181 | 213 | 212 | 239 |
| FSM DOC (μm) | 10.13 | 13.02 | 12.20 | 14.88 |
| Direct CS (MPa) | 135 | 82 | 55 | 68 |
| Weight gain (%) | 0.3948 | 0.5539 | 0.3619 | 0.4632 |
| SCALP midpoint CT (MPa) | 66.4 | 74.9 | 61.3 | 65.2 |
| SCALP maximum CT (MPa) | 71.9 | 78.7 | 66.4 | 68.7 |

| | 18E | 18F | 18G |
|---|---|---|---|
| Composition | Example 8 | Example 8 | Example 8 |
| Process Stage | Glass Pre- | Cerammed | Cerammed and |
| | Ceram | Only | 3D Formed |
| Residual glass phase (wt. %) | 100 | 20 | 27 |
| Sample Thickness (mm) | 0.6 | 0.6 | 0.6 |
| NaNO₃ (wt. % in bath) | 25 | 25 | 25 |
| LiNO₃ (wt. % in bath) | 0.5 | 0.5 | 0.5 |
| KNO₃ (wt. % in bath) | 74.5 | 74.5 | 74.5 |
| IOX temperature (° C.) | 500 | 500 | 500 |
| IOX time (hours) | 3.5 | 3.5 | 3.5 |
| FSM LED (MPa) | 365 | 365 | 365 |
| FSM CS (MPa) | 238 | 236 | 257 |
| FSM DOC (μm) | 12.72 | 12.70 | 15.7 |
| Direct CS (MPa) | 130 | 122 | 83 |
| Weight gain (%) | 0.4414 | 0.4041 | 0.5528 |
| SCALP midpoint CT (MPa) | 64.37 | 60.9 | 66.4 |
| SCALP maximum CT (MPa) | 69.65 | 65.7 | 70.3 |

As shown in Table 5, for both thickness of 0.5 mm and 0.6 mm, the glass ceramic articles that were cerammed and then 3D formed (e.g., Examples 18B, 18D, and 18G) had greater weight gain and greater central tension (CT) compared to the glass ceramics that were only cerammed and not 3D formed (Examples 18A, 18C, 18F) ion exchanged under the same conditions. Without being bound by any particular theory, it is believed that these effects can be attributed to the greater concentration of the residual glass phase in the 3D formed glass ceramic articles and/or the greater availability of lithium in the residual glass phase of the 3D formed glass ceramic articles compared to the glass ceramics that were only cerammed.

### Example 19—Ion Exchange of Glass Ceramic Articles of Example 13

In Example 19, the glass ceramic articles of Example 13, before and after 3D forming, were ion-exchanged to investigate the effects of increasing the concentration of the residual glass phase during 3D forming on the ion-exchange process and the resulting properties of the strengthened glass articles made therefrom. In Example 19, the glass ceramic articles of Example 13, which had the composition of Example 7, were subjected to an ion-exchange process, before and after 3D forming, wherein the glass ceramic article was placed in a molten salt bath comprising NaNO₃, LiNO₃, and KNO₃. The concentrations of each constituent of the molten salt bath are provided in Table 6. The samples had a thickness of 0.4 mm, as indicated in Table 6. The glass ceramic articles, before and after 3D forming, were ion-exchanged at an ion-exchange temperature of 500° C. for 1.75 hours. Following ion-exchange, the strengthened glass articles were evaluated for FSM compression stress (CS), FSM depth of compression (DOC), direct CS, weight gain, SCALP midpoint central tension (CT), and SCALP maximum CT, the values of which are provided below in Table 6.

TABLE 6

| | 19A | 19B | 19C | 19D | 19E | 19F |
|---|---|---|---|---|---|---|
| Composition | Example 7 | Example 7 | Example 7 | Example 7 | Example 7 | Example 7 |
| Process Stage | Cerammed | Cerammed | Cerammed | Cerammed | Cerammed | Cerammed |
| | Only | Only | Only | and 3D | and 3D | and 3D |
| | | | | formed | formed | formed |
| Residual glass phase | 14 | 14 | 14 | 21 | 21 | 21 |
| (wt. %) | | | | | | |
| Sample Thickness (mm) | 0.4 | 0.4 | 0.4 | 0.4 | 0.4 | 0.4 |
| NaNO₃ (wt. % in bath) | 20 | 15 | 40 | 20 | 15 | 40 |
| LiNO₃ (wt. % in bath) | 0.1 | 0.1 | 0.1 | 0.1 | 0.1 | 0.1 |
| KNO₃ (wt. % in bath) | 79.9 | 84.9 | 59.9 | 79.9 | 84.9 | 59.9 |
| IOX temperature (° C.) | 500 | 500 | 500 | 500 | 500 | 500 |
| IOX time (hours) | 1.75 | 1.75 | 1.75 | 1.75 | 1.75 | 1.75 |
| FSM LED (nm) | 365 | 365 | 365 | 365 | 365 | 365 |
| FSM CS (MPa) | 125 | 124 | 77.93 | 216 | 329 | 223 |
| FSM CT (MPa) | 44.33 | 38.38 | 50.03 | 44.08 | 41.75 | 50.53 |
| FSM DOC (μm) | 87.85 | 85.45 | 92.68 | 90.90 | 90 | 98 |
| Weight gain (%) | 0.4730 | 0.4839 | 0.5386 | 0.6620 | — | 0.7478 |
| SCALP midpoint CT (MPa) | 41.19 | 39.27 | 48.77 | 44.90 | 42.38 | 46.60 |
| SCALP maximum CT (MPa) | 51.58 | 51.93 | 57.03 | 51.14 | 48.83 | 63.25 |

As shown in Table 6, the glass ceramic articles that were cerammed and then 3D formed (e.g., Examples 19D, 19E, and 19F) had greater CS, greater weight gain, and greater depth of compression compared to the glass ceramics that were only cerammed and not 3D formed (Examples 19A, 19B, and 19C) ion exchanged under the same conditions. Without being bound by any particular theory, it is believed that these effects can be attributed to the greater concentration of the residual glass phase in the 3D formed glass ceramic articles and/or the greater availability of lithium in the residual glass phase of the 3D formed glass ceramic articles compared to the glass ceramics that were only cerammed. As shown in Sample 19E of Example 19, the glass ceramic articles can be ion-exchanged to produce a CS of greater than 300 MPa, or even greater than or equal to 325 MPa.

While embodiments and examples have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

What is claimed is:

1. A method of forming a glass ceramic article, the method comprising three dimensional (3D) forming a glass ceramic pre-form to produce the glass ceramic article having a lithium disilicate crystalline phase, a petalite crystalline phase, and a residual glass phase, wherein:
prior to 3D forming, the glass ceramic pre-form comprises the lithium disilicate crystalline phase, the petalite crystalline phase, and the residual glass phase; and
after 3D forming, the glass ceramic article comprises a concentration of the residual glass phase greater than a concentration of the residual glass phase in the glass ceramic pre-form.

2. The method of claim 1, wherein, prior to 3D forming, a concentration of the residual glass phase in the glass ceramic pre-form is from 10 wt. % to 50 wt. % and the glass ceramic article has a residual glass phase of from 15 wt. % to 50 wt. % after 3D forming.

3. The method of claim 1, wherein the glass ceramic article comprises Na₂O, K₂O, or both, wherein a molar concentration of Na₂O and K₂O in the glass ceramic article is from 0.5 mol % to 9 mol %.

4. The method of claim 3, wherein the glass ceramic article has a molar ratio [Na₂O+K₂O]/[Al₂O₃] of from 0.1 to 5, a molar ratio [Na₂O+K₂O]/[ZrO₂] of from 0.3 to 5, or both.

5. The method of claim 1, wherein:
the glass ceramic article comprises one or more metal oxides selected from the group consisting of ZnO, MgO, CaO, BaO, SrO, and combinations of these; and
the glass ceramic article has a molar ratio [MgO+CaO+BaO+SrO+ZnO]/[Al₂O₃] of from 0.05 to 5, a molar ratio [MgO+CaO+BaO+SrO+ZnO]/[ZrO₂] of from 0.1 to 5, or both.

6. The method of claim 1, wherein the glass ceramic article comprises from 0 mol % to 10 mol % B₂O₃.

7. The method of claim 1, wherein the composition of the glass ceramic article comprises from 55 mol % to 80 mol % SiO₂; from 1 mol % to 15 mol % Al₂O₃; from 10 mol % to 40 mol % Li₂O; from 0.2 mol % to 4 mol % P₂O₅; and from 0.1 mol % to 10 mol % ZrO₂.

8. The method of claim 1, wherein the glass ceramic preform is ceramed prior to 3D forming the glass ceramic preform to produce the glass ceramic article.

9. The method of claim 1, further comprising preparing the glass ceramic preform prior to 3D forming the glass ceramic preform to produce the glass ceramic article, wherein preparing the glass ceramic preform comprises ceraming a precursor glass to produce the glass ceramic preform comprising the lithium disilicate crystalline phase, the petalite crystalline phase, and the residual glass phase, wherein a concentration of the residual glass phase in the glass ceramic preform is from 10 wt. % to 50 wt. %, and the glass ceramic preform has a total concentration of crystal phases that is within 50% of a total concentration of crystal phases in the glass ceramic article after 3D forming.

10. The method of claim 9, wherein the ceraming the precursor glass to produce the glass ceramic preform comprises:
heating the precursor glass to a nucleation temperature of from 500° C. to 650° C.;
maintaining the precursor glass at the nucleation temperature for a first time period of from 1 min to 600 min;
increasing the temperature of the precursor glass to a crystallization temperature of from 680° C. to 800° C.; and
maintaining the precursor glass at the crystallization temperature for a second time of from 1 sec to 600 min to produce the glass ceramic preform.

11. The method of claim 1, wherein 3D forming the glass ceramic preform comprises:
heating the glass ceramic preform to a forming temperature;
after heating, pressing the glass ceramic preform into a mold for a time period to produce the glass ceramic article; and
cooling the glass ceramic article.

12. The method of claim 1, further comprising strengthening the glass ceramic article after the 3D forming to produce a strengthened glass ceramic article having a compressive stress layer extending from a first surface of the glass ceramic article to a depth of compression, wherein:
the strengthened glass ceramic article has a compressive stress of the compressive stress layer of greater than or equal to 200 MPa;
the strengthened glass article has a depth of compression of from 0*t to 0.3*t, where t is thickness of the strengthened glass ceramic article, or has a depth of compression of greater than or equal to 10% of a thickness of the strengthened glass ceramic article; and
a central tension of greater than or equal to 40 MPa.

13. The method of claim 1, wherein a total volume change of the glass ceramic article during forming is less than 1% of the glass ceramic preform before the 3D forming.

14. A glass ceramic article prepared by the method of claim 1, wherein the glass ceramic article is clear and transparent and has one or more of the following properties:
an index of refraction of from 1.5 to 1.6 for light having wavelength of 589.3 nm;
a haze measured at 0.8 mm thickness of less than 0.20;
an optical transmission of electromagnetic radiation wavelengths from 450 nm to 800 nm measured at 0.8 mm thickness of greater than 85%; or
combinations of these properties.

15. An electronic device comprising a transparent surface, the transparent surface comprising the glass ceramic article of claim 14, wherein the glass ceramic article has a thickness of from 0.3 mm to 1 mm.

16. A glass ceramic article comprising:
a lithium disilicate crystalline phase;
a petalite crystalline phase; and
a residual glass phase, wherein:
a concentration of the residual glass phase is from 15 wt. % to 50 wt. %; and
the glass ceramic article has one or more of the following:
a molar ratio [Na₂O+K₂O]/[Al₂O₃] of from 0.1 to 5;
a molar ratio [Na₂O+K₂O]/[ZrO₂] of from 0.3 to 5;
a molar ratio [MGO+CaO+BaO+SrO+ZnO]/[Al₂O₃] of from 0.05 to 5;
a molar ratio [MgO+CaO+BaO+SrO+ZnO]/[ZrO₂] of from 0.1 to 5; or
combinations thereof.

17. The glass ceramic article of claim 16, wherein the composition of the glass ceramic article comprises from 55 mol % to 80 mol % SiO₂; from 1 mol % to 15 mol % Al₂O₃; from 10 mol % to 40 mol % Li₂O; from 0.2 mol % to 4 mol % P₂O₅; and from 0.1 mol % to 10 mol % ZrO₂.

18. The glass ceramic article of claim 17, wherein:
the glass ceramic article comprises from 0.5 mol % to 9 mol % Na₂O, K₂O, or both; and
the glass ceramic article has a molar ratio [Na₂O+K₂O]/[Al₂O₃] of from 0.1 to 5, a molar ratio [Na₂O+K₂O]/[ZrO₂] of from 0.3 to 5, or both.

19. The glass ceramic article of claim 17, wherein:
the glass ceramic article comprises one or more metal oxides selected from the group consisting of ZnO, MgO, CaO, BaO, SrO, and combinations of these; and
the glass ceramic article has a molar ratio [MgO+CaO+BaO+SrO+ZnO]/[Al₂O₃] of from 0.05 to 5, a molar ratio [Mg+CaO+BaO+SrO+ZnO]/[ZrO₂] of from 0.1 to 5, or both.

20. The glass ceramic article of claim 16, wherein the glass ceramic article has one or more of the following properties:
a Young's modulus of from 90 GPa to 110 GPa;
a shear modulus of from 35 GPa to 50 GPa; a Poisson's ratio of from 0.19 to 0.24;
a fracture toughness of from 1.0 MPa/m^{0.5} to 2.0 MPa/m^{0.5};
a stress optical coefficient (SOC) of from 2.60 nm/mm/MPa to 2.75 nm/mm/MPa;
an index of refraction of from 1.5 to 1.6 for light having wavelength of 589.3 nm;
a stress of less than 30 nm of retardation per mm of glass ceramic article thickness;
a stress of less than 25 nm of retardation per mm of glass ceramic article thickness;
a haze in units of percent (%) of less than 0.0994t+0.12, where t is the thickness of the glass ceramic article in mm;
an optical transmission in units of percent (%) of greater than 0.91×10^{(2-0.03t)} of electromagnetic radiation having wavelengths from 450 nm to 800 nm, where t is the thickness of the glass ceramic article in mm;
a haze measured at 0.8 mm thickness of less than 0.20;
an optical transmission of electromagnetic radiation wavelengths from 450 nm to 800 nm measured at 0.8 mm thickness of greater than 85%; or
combinations of these properties.
